(19) United States
(12) Patent Application Publication
(10) Pub. No.: US 2026/0236445 A1
(43) Pub. Date: Aug. 13, 2026

(54) AGENTIC DATA FABRIC WITH DATA PROFILER AGENTS

(71) Applicant: Reltio, Inc., Redwood Shores, CA (US)

(72) Inventors: Dmitry Blinov, Redwood Shores, CA (US); Sudipto Chakraborty, Hyderabad (IN); Michael Frasca, Durham, NC (US); Sri Charan Gontla, Markapur (IN); Alexander Huitric, Goleta, CA (US); Anshuman Kanwar, Cambridge, MA (US); Jacques Lateo, Orlando, FL (US); Karthik Narayan, Boston, MA (US); Sushant Rai, Bengaluru (IN); Sriraj Rajaram, Seattle, WA (US); Gustavo Santos, Vila Nova de Gaia (PT); Abhradeep Sengupta, Bengaluru (IN); Robin Sylvester, San Francisco, CA (US); Karthik Thomas, Bengaluru (IN); Sergio Javier Abraham, Barcelona (ES); Kishor Kumar Pushparaj, Coimbatore (IN); Shashank Prabhakara, Bengaluru (IN); Carina Alabanza, Lathrop, CA (US); Suchen Chodankar, Redwood City, CA (US); Rafael Bosse Brinhosa, Lisbon (ES)

(21) Appl. No.: 19/540,554

(22) Filed: Feb. 13, 2026

Related U.S. Application Data
(60) Provisional application No. 63/758,309, filed on Feb. 13, 2025.
(60) Provisional application No. 63/758,320, filed on Feb. 13, 2025.
(60) Provisional application No. 63/802,370, filed on May 8, 2025.
(60) Provisional application No. 63/858,271, filed on Aug. 5, 2025.
(60) Provisional application No. 63/943,336, filed on Dec. 17, 2025.

(51) Int. Cl. G06F 16/215; G06F 16/23; G06F 16/25; G06F 16/3329

(52) U.S. Cl. CPC G06F 16/215; G06F 16/2365; G06F 16/254; G06F 16/3329

(57) ABSTRACT

Profiling, by a data profiler agent, an external dataset intended for integration into a multi-tenant platform. Determining data quality metrics for the dataset. Identifying data quality issues in the dataset that are predicted to adversely impact entity resolution operations of the multi-tenant platform. Identifying at least a portion of the dataset that is predicted not to adversely impact entity resolution operations of the multi-tenant platform. Generating recommended data improvement actions, wherein the data improvement actions include corrections or enrichments for the dataset. Generating and storing data profiling results. Ingesting the portion of the dataset that is predicted not to adversely impact the entity resolution operations of the multi-tenant platform into the multi-tenant platform. Executing a first data improvement action on the portion of the dataset associated with the first data improvement action, thereby generating a first improved portion of the dataset. Ingesting the first improved portion of the dataset.

### CROSS-REFERENCE TO RELATED APPLICATIONS

The present application claims priority to U.S. Provisional patent application Ser. No. 63/758,320 filed Feb. 13, 2025, U.S. Provisional patent application Ser. No. 63/758,309 filed Feb. 13, 2025, U.S. Provisional patent application Ser. No. 63/802,370 filed May 8, 2025, U.S. Provisional patent application Ser. No. 63/858,271 filed Aug. 5, 2025, and U.S. Provisional patent application Ser. No. 63/943,336 filed Dec. 17, 2025, each of which is incorporated by reference herein.

### BRIEF DESCRIPTION OF THE DRAWINGS

FIG. 1 depicts a diagram of an example connected data platform.

FIG. 2 depicts a diagram of an example environment for an integration hub system.

FIG. 3 depicts a diagram of an example three-layer model.

FIG. 4 depicts a diagram of some examples of entity type, relationship type and event metadata.

FIG. 5 depicts a flowchart of an example of a method of dynamic matching facilitation.

FIG. 6 depicts a diagram of an example environment for agentic orchestration on unified trusted data operations.

FIG. 7 depicts a diagram of an example agentic orchestration system.

FIG. 8A depicts a diagram of an example knowledge graph.

FIG. 8B depicts a diagram of an example intelligent data graph.

FIG. 8C depicts a diagram of an example intelligent data graph with a metadata dimension.

FIG. 8D depicts a diagram of an example intelligent data graph with a metadata dimension and just-in-time agent information.

FIG. 9 depicts a flowchart of an example method of agentic AI orchestration using an intelligent data graph.

FIG. 10 depicts a flowchart of an example method of knowledge graph generation.

FIG. 11 depicts a flowchart of an example method of enriching a knowledge graph with unstructured-content promotion to generate an intelligent data graph.

FIG. 12 depicts a flowchart of an example method of enriching a knowledge graph with signal integration to generate an intelligent data graph.

FIG. 13 depicts a flowchart of an example method of enriching a knowledge graph with governance surfacing to generate an intelligent data graph.

FIG. 14 depicts a flowchart of an example method of agentic AI orchestration.

FIG. 15 depicts a dynamic matching facilitation flowchart.

FIG. 16 depicts a dynamic matching flowchart.

FIG. 17 depicts a high-level flowchart for MatchIQ.

FIG. 18 depicts a flowchart for configuring survivorship within an example User Interface (UI).

FIG. 19 depicts a flowchart of an example of a method of cross-tenant matching and lineage EID promotion.

FIGS. 20A-20C depict a flowchart of an example method of agentic data profiling.

FIG. 21 depicts a flowchart of an example of data profiling by a data profiler agent.

FIG. 22 depicts a flowchart of an example method of interactive agentic data profiling.

### DETAILED DESCRIPTION

A claimed solution rooted in computer technology overcomes problems specifically arising in the realm of computer technology. In various embodiments, a computing system (e.g., a multi-tenant platform and/or an agentic AI orchestration system) integrates and automates data profiling (e.g., via a data profiler agent) with a master data management ingestion process of the computing system and can proactively intervene before data enters the computing system. Unlike conventional data profiling tools that often operate as standalone post-processing or reporting utilities (or require manual queries by data engineers), the data profiler agent is embedded in the data pipeline to perform “pre-ingest quality profiling” on incoming data. It not only computes statistical profiles but also uses knowledge of the multi-tenant platform's matching and merging systems (e.g., rules-based systems and/or machine learning-based systems) and data model to flag match-impacting issues in the data (e.g., missing keys or inconsistent identifiers that would impede entity resolution), which is a capability not found in generic profiling solutions. Moreover, the data profiler agent can uniquely stage attribute values for approval and correction prior to ingestion, effectively creating a human-in-the-loop checkpoint within an automated pipeline. This combination of features (e.g., an autonomous data profiler agent that assesses data quality in real-time, identifies issues relevant to data consolidation, and facilitates immediate remediation through a governed approval mechanism) provides a technological improvement over traditional computing systems.

Moreover, the computing system addresses a longstanding challenge in data management, namely, ensuring data quality at the point of entry into a master data management hub, thereby preventing bad data from ever polluting the system. The computing system uses context-aware intelligence (e.g., considering enterprise data relationships and match rules) and an operational feedback loop (e.g., staging and steward approval) in the profiling process.

Furthermore, the claimed solution is rooted in concrete data processing technology and offers a technical solution to a technical problem, namely, improving the quality of data ingested into a computer-based master data management system. The computing system provides a specific technological process executed by the computing system and the data profiler agent. By improving the functionality of the computer system itself (e.g., ensuring that the multi-tenant platform is populated only with high-quality, consistent data, thereby avoiding downstream errors and processing inefficiencies), the computing system provides a technological solution to a technical problem. Here, the solution (e.g., pre-ingest profiling with automated issue remediation) enhances the data processing capabilities of the multi-tenant platform. More specifically, the multi-tenant platform becomes more reliable and efficient and does not need later clean-up cycles for bad data. Thus, the computing system transforms how data ingestion is ordinarily done (e.g., from passive acceptance of data to an active, intelligent gatekeeping process), thereby improving data quality management.

In various embodiments, a multi-tenant master data management platform (e.g., platform 102) generates a plurality of profiles that consolidate (or, “unify”) tenant data (e.g., customer data and/or customer-related data) of the multi-tenant master data management platform with interaction and transaction records from heterogeneous data sources in real time. The plurality of profiles can include at least a portion of a knowledge graph generated and maintained by the multi-tenant platform, and the knowledge graph can include a governed, graph-structured unification of entities and relationships resolved across the heterogeneous data sources and preserved with lineage metadata.

A computing system (e.g., an agentic AI orchestration system of the multi-tenant master data management platform) can execute a plurality of different artificial intelligence (AI) agents. An orchestration agent can orchestrate the other AI agents, and each agent can include a respective large language model (and/or multimodal model). The agentic AI orchestration system can further provide a model interface layer (e.g., MCP via a secure communication layer) associated with the multi-tenant platform that securely connects to an external machine learning model of a third-party AI agent while enforcing data governance rules. The external ML model can then securely access customer data from the profiles of the multi-tenant platform under context-aware policies.

The agentic AI orchestration system can further provide secure access to a curated set of customer data from the plurality of profiles to the external ML model through the model interface layer, without exporting the curated set of customer data into a separate repository, such that the ML model processes live enterprise data in place. The agentic AI orchestration system can then receive, via the interface layer, a predictive output from the external ML model derived from the curated set of customer data. The predictive output can include an insight or recommendation associated with at least one profile of the plurality of profiles.

The agentic AI orchestration system can then update (e.g., by another AI agent) at least one of the plurality of profiles by writing the predictive output as a new attribute of the at least one profile, thereby enriching the profile with machine-generated insight in real time to create an enriched profile. Notably, the enriched profile can be immediately available for consumption by one or more of the other AI agents of the plurality of AI agents. In response to the update, the agentic AI orchestration system can automatically execute (e.g., by another AI agent) one or more data stewardship operations (e.g., merge) using the enriched profile.

Accordingly, the multi-tenant master data management platform and the computing system include architectures and methods that improve computer-centric operations (e.g., data governance enforcement, in-place computation on live enterprise data, and real-time profile updates). These are technical features that solve technical problems (e.g., data synchronization overhead, security of AI in enterprise data, and/or the like) and thus are rooted in a technological improvement to a data management platform. Thus, the multi-tenant master data management platform and the computing system provide a specific approach to achieving predictive data intelligence that improves the functioning of the computer-based platform itself (e.g., by eliminating the need for separate analytical databases or by enabling autonomous data stewardship via AI). The result is a technological solution that leverages machine learning in an integrated manner to enhance enterprise data management and provides a fusion of MDM and predictive AI within a single, governed, real-time platform.

In various embodiments, a computing system (e.g., an agentic AI orchestration system of a multi-tenant master data management platform) is configured to deliver a comprehensive view of a tenant (e.g., customer) of the computing systems, enabling enterprises to develop customer-centric strategies and drive growth. The computing system can transform data into actionable insights, enabling enterprises to make and execute data-driven decisions (e.g., automatically). The computing system enables users to quickly adopt proactive strategies to enhance customer satisfaction, loyalty, and overall business performance. In some embodiments, the computing system can efficiently integrate specific “out-of-the-box” predictive models quickly and easily, with minimal development effort.

The computing system solves many technical problems. For example, users may have to manage comprehensive customer demographic data and their interactions with organizations (e.g., enterprises), brands, and services across various touchpoints. While these data points may offer valuable insights into customer behavior, presenting significant opportunities for businesses to drive revenue growth, traditional systems lack a streamlined solution for generating predictive insights from this data. The computing system provides such a streamlined solution for generating predictive insights from such data and/or other data.

More specifically, the computing system can achieve faster time to value and reduce computational resources. Traditionally, users must export customer data from a data platform to their machine learning platform to generate predictive insights. This process is both computationally complex and time-consuming for business users.

In some embodiments, users can leverage machine learning (ML) models or algorithms built within the computing system to generate predictive insights derived from customer data managed by the computing system. These insights enhance customer profiles managed within the multi-computing systems enabling users to make informed decisions more quickly and accurately. In some embodiments, the computing system can build and provide machine learning models within the computing system.

In various embodiments, a computing system (e.g., agentic orchestration system and/or multi-tenant platform) constructs a knowledge graph. The knowledge graph can include a governed, graph-structured unification of entities and relationships resolved across heterogeneous data sources and preserved with lineage metadata. The computing system can enrich the knowledge graph to construct an intelligent data graph by incorporating, as machine-consumable context, information extracted from unstructured data, operational signals associated with entities or relationships, and governing metadata specifying policies or data quality attributes. The computing system can execute a plurality of AI agents and expose the intelligent data graph via a governed access interface, such that a plurality of artificial intelligence (AI) agents can obtain real-time, policy-compliant knowledge for actions or recommendations. At least one of the plurality of AI agents can include a large language model (LLM) or a multi-modal model. The computing system can predict, by a particular AI agent of a plurality of third-party agents based on the intelligent data graph, the actions or recommendations. The actions or recommendations can be associated with one or more data stewardship operations. The computing system can execute, in response to the prediction, the one or more actions or recommendations.

In various embodiments, a computing system (e.g., an agentic orchestration system and/or multi-tenant platform) deploys, executes, and/or accesses (e.g., via streaming) artificial intelligence (AI) agents within a secure environment (e.g., an enterprise environment). The AI agents can include an AI orchestrator agent that is configured to instruct one or more other AI agents to perform various data stewardship tasks or operations (e.g., retrieval operations, analytics operations). For example, the AI orchestration agent can instruct multiple AI agents to cooperate with each other to perform the various tasks or operations. In some embodiments, each of the AI agents and the AI orchestrator agent can include, execute, and/or access (e.g., stream) one or more machine learning models, such as a generative artificial intelligence model (e.g., large language model).

In some embodiments, the computing system can receive, through a conversational graphical user interface of the computing system, a data stewardship query (e.g., entity resolution query, merge request, data verification and validation, etc.) associated with a single tenant and/or multiple tenants of a multi-tenant platform. The computing system can obtain, by the AI orchestrator agent, a context associated with the data stewardship query. For example, the context can include historical data, such as a history of conservations received through the conversational graphical user interface during a current session and/or one or more previous sessions. The computing system can select, by the AI orchestrator agent based on the data stewardship query and the context associated with the data stewardship query, one or more other AI agents (e.g., first-party AI agents, third-party AI agents, AI sub-agents of one or more of the AI agents) to handle (e.g., execute data stewardship operations and/or related operations, such as retrieval operations) the data stewardship query.

In some embodiments, the computing system can generate one or more prompts (e.g., generative artificial intelligence prompts, such as LLM prompts) based on the data stewardship query, the context associated with the data stewardship query, and/or the selected AI agents. The computing system can provide the one or more prompts to the selected AI agents which can then retrieve, based on the prompts, context-specific and/or domain-specific (e.g., specific to particular tenant or tenants, a particular industry, etc.) information from first-party datastores (e.g., datastores controlled and/or owned by the computing system) and/or third-party datastores (e.g., enterprise systems that are not controlled or owned by the computing system) via a secure communication layer (e.g., implementing and/or accessing a model context protocol server). The computing system can predict (e.g., by the AI orchestrator agent and/or other AI agents) one or more data stewardship operations based on the retrieved context-specific and/or domain-specific information. The computing system (e.g., via the agent orchestration agent and/or other AI agents) can then execute (and/or facilitate execution) those data stewardship operations. For example, the computing system can execute the data stewardship operations automatically in response to receiving the prediction.

In various embodiments, the computing system is configured to identify matching data records within a set of data records and merge the matching data records. Using the entity resolution request, the computing system can identify attributes in a data model. The computing system can then identify other attributes in the data model and/or other data models.

In various embodiments, a unique architecture enables efficient modelling of entities, relationships, and interactions that typically form the basis of a business. These models enable insights, scalability, and management not previously available in the prior art. It will be appreciated that with the information model discussed herein, there is no need to consider tables, foreign keys, or any of the low-level physicality of how the data is stored.

An information model may be utilized as a part of a multi-tenant platform. In a specific implementation, a configuration sits in a layer on top of the RELTIO™ platform and natively enjoys capabilities provided by the platform such as matching, merging, cleansing, standardization, workflow, and so on. Entities established in a tenant may be associated with custom and/or standard interactions of the platform. The ability to hold and link three kinds of data (i.e., entities, relationships, and interactions) in the platform and leverage the confluence of them in one place provides unlimited power to model and understanding to a business.

In various embodiments, the metadata configuration is based on an n-layer model. One example is a 3-layer model (e.g., which is the default arrangement). In some embodiments, each layer is represented by a JSON file (although it will be appreciated that many different file structures may be utilized such as BSON or YAML).

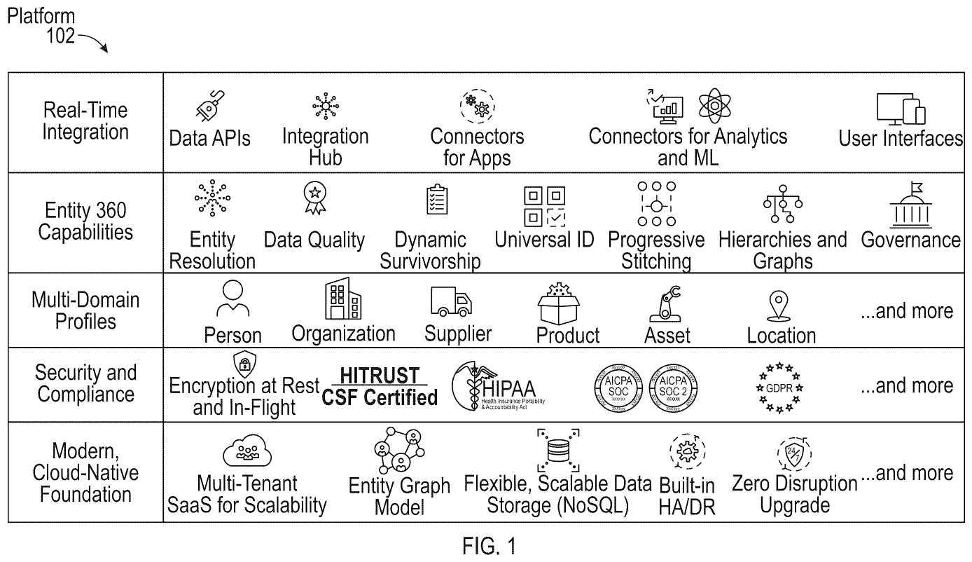

The information models may be utilized as a part of a connected, multi-tenant system. FIG. 1 depicts a platform 102. The platform 102 enables seamless scaling in many operational or analytical use case. The platform 102 may be the foundation of master data management (MDM). Various integration options, including a low-code/no-code solution, allow rapid deployment and time to value.

FIG. 1 is an example of functions of the platform 102 in some embodiments. The platform 102 may support best in class MDM capabilities, including identity resolution, data quality, dynamic survivorship for contextual profiles, universal ID across all your operational applications and hierarchies, knowledge graph to manage relationships, progressive stitching to create richer profiles, and governance capabilities. Further, the platform 102 may support high volume transactions, high volume API calls, sophisticated analytics, and back-end jobs for any workload in an auto-scaling cloud environment. As follows, the platform 102 may support high redundancy, fault tolerance, and availability with built-in NoSQL database, Elasticsearch, Spark, and other AWS and GCP services across multiple zones.

In various embodiments, the platform 102 is multi-domain and enables seamless integration of many types of data and from many sources to create master profiles of any data entity—person, organization, product, location. Users can create master profiles for consumers, B2B customers, products, assets, sites, and connect them to see the complete picture.

The platform 102 may enable API-first approach to data integration and orchestration. Users (e.g., tenants) can use APIs, and various application-specific connectors to ease integration. Additionally, in some embodiments, users can stream data to analytics or data science platforms for immediate insights.

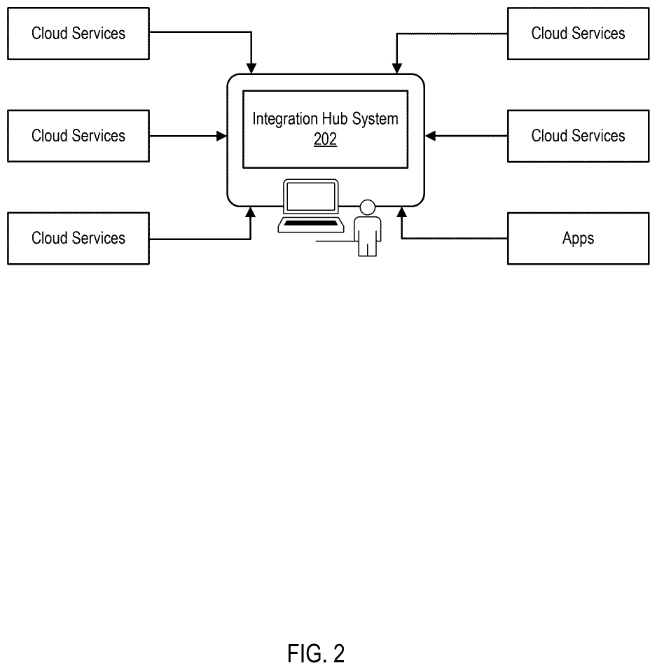

FIG. 2 depicts an environment for an integration hub system 202. The integration hub system 202 may connect various data sources and downstream consumers. In some embodiments, the integration hub system 202 comes with over 1,000 connectors to build data pipelines right. The integration hub system 202 may include an intuitive drag-and-drop graphical interface to create simple replication pipelines to complex data extraction and transformation tasks. With pre-built community recipes for common use cases, users can set up integration workflows in just a few clicks.

Along with the built-in data loader, event streaming capabilities, data APIs, and partner connectors, the integration hub system 202 enables rapid links to user systems using the platform 102. The integration hub system 202 may enable users to build automated workflows to get data to and from the platform 102 with any number of SaaS applications in just hours or days. Faster integration enables faster access to unified, trusted data to drive real-time business operations.

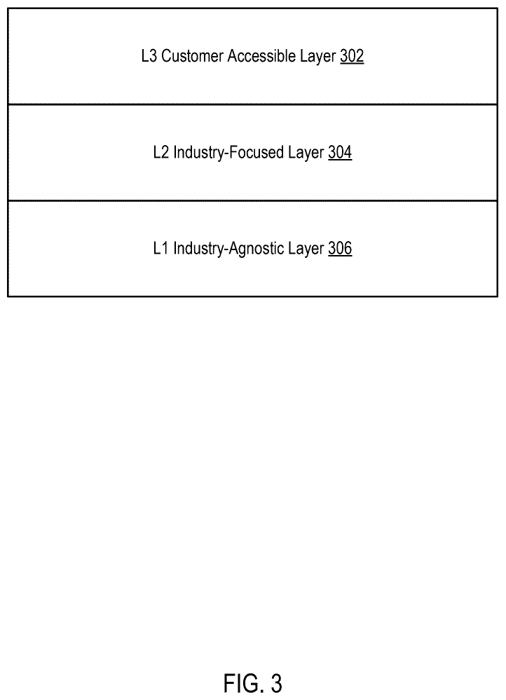

FIG. 3 depicts a three-layer model in some embodiments. Of the three layers, only layer 3 (e.g., the top layer of the n-layer model) 302, known as the “L3” is accessible by the customer. It is the layer that is a part of a tenant. The information associated with the L3 layer 302 may be retrieved from the tenant, edited, and applied back to the tenant using Configuration API.

The L3 302 layer typically inherits from the L2 layer 304 (an industry-focused layer) which in turn inherits from the L1 layer 306 (An industry-agnostic layer). Usually, the L3 layer 302 refers to an L2 304 container and inherits all data items (or “objects”) from the L2 304 container. However, it is not required that the L3 302 refer to the L2 304 container, it can standalone.

The L2 layer 304 may inherit the objects from the L1 layer. Whereas there is only a single L1 306 set of objects, the objects at the L2 layer 304 may be grouped into industry-specific containers. Like the L1 layer 306, the containers at the L2 layer 304 may be controlled by product management and may not be accessible by customers.

Life sciences is a good example of an L2 layer 304 container. The L2 layer 304 container 304 may inherit the Organization entity type (discussed further herein) from L1 layer 306 and extends it to the Health Care Organization (HCO) type needed in life sciences. As such, the HCO type enjoys all of the attribution and other properties of the Organization type, but defines additional attributes and properties needed by an HCO.

The L1 layer 306 may contain entities such as Party (an abstract type) and Location. In some embodiments, the L1 layer 306 contains a fundamental relationship type called HasAddress that links the Party type to the Location type. The L1 layer 306 also extends the Party type to Organization and Individual (both are non-abstract types).

There may be only one L1 layer 306, and its role is to define industry-agnostic objects that can be inherited and utilized by industry specific layers that sit at the L2 layer 304. This enables enhancement of the objects in the L1 layer 306, potentially affecting all customers. For example, if an additional attribute was added into the HasAddress relationship type, it typically would be available for immediate use by any customer of the platform.

Any object can be defined in any layer. It is the consolidated configuration resulting from the inheritance between the three layers that is commonly referred to as the tenant configuration or metadata configuration. In a specific implementation, metadata configuration consolidates simple, nested, and reference attributes from all the related layers. Values described in the higher layer overrides the values from the lower layers. The number of layers does not affect the inheritance.

In a specific implementation, metadata configuration consolidates simple, nested, and reference attributes from all the related layers. Values described in the higher layer overrides the values from the lower layers. The number of layers does not affect the inheritance.

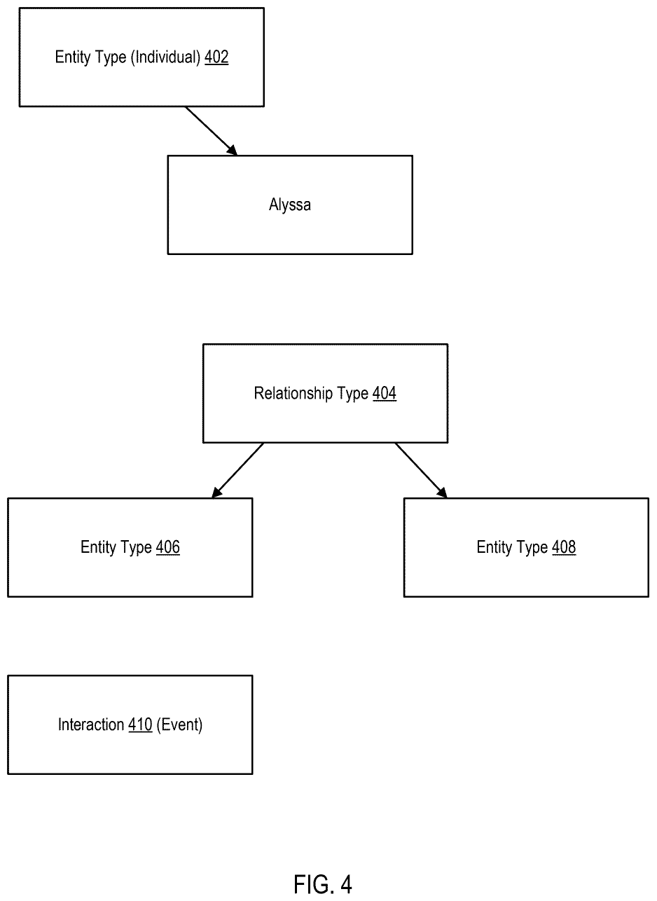

FIG. 4 is a box diagram of some examples of entity type, relationship type and event metadata. The platform 102 enables object types entities, relationships, and interactions. The entity type 402 may be a class of entity. For example, “Individual” is an entity type 402, and “Alyssa” represents a specific instance of that entity type. Other common examples of entity types include “Organization,” “Location,” and “Product.”

Often, entity types can materialize in single instances, such as the “Alyssa” example above. In another example, the L1 layer may define the abstract “Party” entity type with a small collection of attributes. The L1 layer may then be configured to define the “Individual” entity type and the “Organization” entity type, both of which inherit from “Party,” both of which are non-abstract and both of which add additional attributes specific to their type and business function. Continuing with the concept of inheritance, in the L2 Life Sciences container, the HCP entity may be defined (to represent physicians) which inherits from the “Individual” type but also defines a small collection of attributes unique to the HCP concept. Thus, there is an entity taxonomy “Party,” “Individual,” or “HCP,” and the resulting HCP entity type provides the developer and user with the aggregate attribution of “Party,” “Individual,” and “HCP.”

Once the entity types are defined, the user can link entities together in a data model by using the relationship type. Once the user defines entity types, they can be linked by defining relationships between them. For example, a user can post a relationship independently to link two entities together, or the client can mention a relationship in a JSON, which then posts the relationship and the two entities all at once.

A relationship type 404 describes the links or connections between two specific entities (e.g., entities 406 and 408). A relationship type 404 and the entities 406 and 408 described together form a graph. Some common relationship types are Organization to Organization, Subsidiary Of, Partner Of, Individual to Individual, Parent of/Child Of, Reports To, Individual to Organization/Organization to Individual, Affiliated With, Employee Of/Contractor Of.

Once the user defines entity types, they can be linked by defining relationships between them. For example, a user can post a relationship independently to link two entities together, or the client can mention a relationship in a JSON, which then posts the relationship and the two entities all at once.

The platform 102 may enable the user to define metadata properties and attributes for relationship types. The user can define up to any number metadata properties. The user can also define several attributes for a relationship type, such as name, description, direction (undirected, directed, bi-directional), start and end entities, and more. Attributes of one relationship type can inherit attributes from other relationship types.

Hierarchies may be defined through the definition of relationship subtypes. For example, if a user defines “Family” as a relationship type, the user can define “Parent” as a subtype. One hierarchy contains one or many relationship types; all the entities connected by these relationships form a hierarchy. Entity A>HasChild (Entity B)>HasChild (Entity C). Then A, B, and C form a hierarchy. In the same hierarchy, the user can add Subsidiary as a relationship and if Entity D is subsidiary of Entity C, then A, B, C, and D all become part of a single hierarchy.

Interactions 410 are lightweight objects that represent any kind of interaction or transaction. As a broad term, interaction 410 stands for an event that occurs at a particular moment such as a retail purchase or a measurement. It can also represent a fact in a period of time such as a sales figure for the month of June.

Interactions 410 may have multiple actors (entities), and can have varying record lengths, columns, and formats. The data model may be defined using attribute types. As a result, the user can build a logical data model rather than relying on physical tables and foreign keys; define entities, relationships, and interactions in granular detail; make detailed data available to content and interaction designers; provide business users with rich, yet streamlined, search and navigation experiences.

In various embodiments, four manifestations of the attribute type include Simple, Nested, Reference, and Analytic. The simple attribute type represents a single characteristic of an entity, relationship, or interaction. The nested, reference and analytic attribute types represent combinations or collections of simple sub-attribute types.

The nested attribute type is used to create collections of simple attributes. For example, a phone number is a nested attribute. The sub-attributes of a phone number typically include Number, Type, Area code, Extension. In the example of a phone number, the sub-attributes are only meaningful when held together as a collection. When posted as a nested attribute, the entire collection represents a single instance, or value, of the nested attribute. Posts of additional collections are also valid and serve to accumulate additional nested attributes within the entity, relationship or interaction data type.

The reference attribute type facilitates easy definition of relationships between entity types in a data model.

A user may utilize the reference attribute type when they need one entity to make use of the attributes of another entity without natively defining the attributes of both. For example, the L1 layer in the information model defines a relationship that links an Organization and an Individual using the affiliated with relationship type. The affiliated with relationship type defines the Organization entity type to be a reference attribute of the Individual entity type. This approach to data modeling enables easier navigation between entities and easier refined search.

Easier navigation between entities: In the example of the Organization and Individual entities that are related using the affiliatedwith relationship type, specifying an attribute of previous employer for the Individual entity type enables this attribute to be presented as a hyperlink on the individual's profile facet. From there, the user can navigate easily to the individual's previous employer.

Easily refined search: When attributes of a referenced entity and relationship type are available to be indexed as though they were native to the referencing entity, business users can more easily refine search queries. For example, in a search of a data set that contains 100 John Smith records, entering John Smith in the search box will return 100 John Smith records. Adding Acme to the search criteria will return only those records with John Smith that have a reference, and thus an attribute, that contains the word Acme.

The analytic attribute type is lightweight. In various embodiments, it is not managed in the same way that other attributes are managed when records come together during a merge operation. The analytic attribute type may be used to receive and hold values delivered by an analytics solution.

The user may utilize the analytic attribute type when they want to make a value from your analytics solution, such as Reltio Insights, available to a business user or to other applications using the Reltio Rest API. For example, if an analytics implementation calculates a customer's lifetime value and the user needs that value to be available to the user while they are looking at the customer's profile, the user may define an analytic attribute to hold this value and provide instructions to deliver the result of the calculation to this attribute.

In a specific implementation, the platform 102 assigns entity IDs (EIDs) to each item of data that enters the platform. As such, the platform can appropriately be characterized as including an EID assignment engine. Importantly, a lineage-persistent relational database management system (RDBMS) retains the EIDs for each piece of data, even if the data is merged and/or assigned a new EID. As such, the platform can appropriately be characterized as including a legacy EID retention engine, which has the task of ensuring when new EIDs are assigned, legacy EIDs are retained in a legacy EID datastore. The legacy EID retention engine can at least conceptually be divided into a legacy EID survivorship subengine responsible for retaining all EIDs that are not promoted to primary EID as legacy EIDs and a lineage EID promotion subengine responsible for promoting an EID of a first data item merged with a second data item to primary EID of the merged data item. An engine responsible for changing data items, including merging and unmerging (previously merged) data items can be characterized as a data item update engine. Cross-tenant durability also becomes possible when legacy EIDs are retained. In a specific implementation, a cross-tenant durable EID lineage-persistent RDBMS has an n-Layer architecture, such as a 3-Layer architecture.

Data may come from multiple sources. The process of receiving data items can be referred to as “onboarding” and, as such, the platform 102 can be characterized as including a new dataset onboarding engine. Each data source is registered and, in a specific implementation, all data that is ultimately loaded into a tenant will be associated with a data source. If no source is specified when creating a data item (or “object”), the source may have a default value. As such, the platform can be characterized as including an object registration engine that registers data items in association with their source.

A crosswalk can represent a data provider or a non-data provider. Data providers supply attribute values for an object and the attributes are associated with the crosswalk. Non-data providers are associated with an overall entity (or relationship); it may be used to link an L1 (or L2) object with an object in another system. Crosswalks do not necessarily just apply to the entity level; each supplied attribute can be associated with data provider crosswalks. Crosswalks are analogous to the Primary Key or Unique Identifier in the RDBMS industry.

The engines and datastores of the platform 102 can be connected using a computer-readable medium (CRM). A CRM is intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g., “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented as cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations, while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

Matching is a powerful area of functionality and can be leveraged in various ways to support different needs. The classic scenario is that of matching and merging entities (Profiles). Within the architecture discussed herein, relationships that link entities can also and often do match and merge into a single relationship. This may occur automatically and is discussed herein.

Matching can be used on profiles within a tenant to deduplicate them. It can be used externally from the tenant on records in a file to identify records within that file that match to profiles within a tenant. Matching may also be used to match profiles stored within a Data Tenant to those within a tenant.

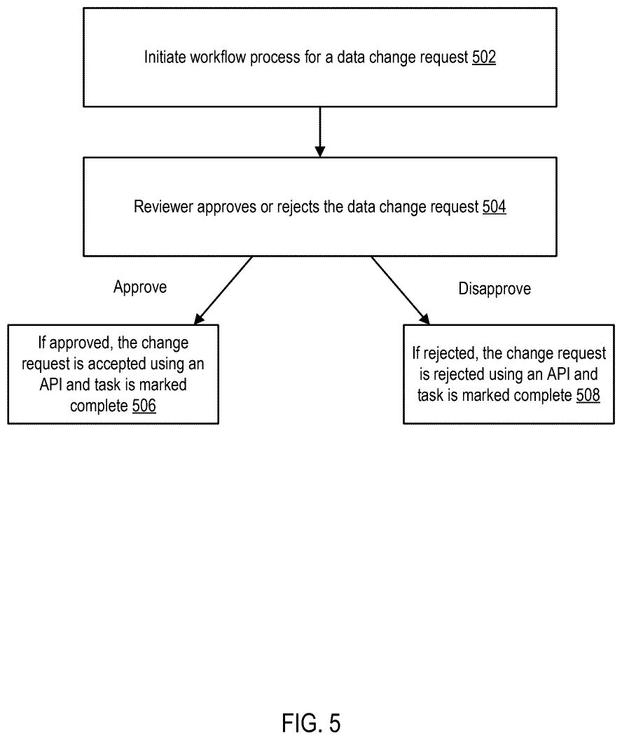

FIG. 5 depicts a flowchart of an example of a method of a dynamic matching facilitation. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In some embodiments, a workflow is a series of sequential steps or tasks that are carried out based on user-defined rules or conditions to execute a business process. The Workflow may allow a user to manage complex business processes through a series of predetermined steps or tasks. The platform 102 may utilize the workflow to enable processes and tasks management, including the assignment and tracking of the tasks. A workflow process may support a creator, a create date, a due date, an assignee, steps, and comments. In various embodiments, workflow business processes are configurable. In some embodiments, the various actors and triggers in a workflow are Actors: The people and processes that participate in the workflow are the actors, e.g., Reviewer, Workflow Engine, Hub, and API; Reviewer: The user will be assigned with the role ROLE REVIEWER; Trigger: It is a scheduled process that scans activity logs to initiate a review workflow, e.g., from the UI, you can start a Data Change Request workflow to review the updates or the changes to the entities or the profiles data in your tenant. The workflow feature may allow a user to manage business processes through a series of predetermined steps or tasks which enables you to plan and coordinate user tasks, validations, reviews, and approvals for multiple records.

Data Change Request (DCR) is a collection of suggested data changes. Users who do not have rights to update objects, such as the customer sales representatives, can suggest changes. These suggested changes will be accumulated in Data Change Requests queued for review and approval by people with approval privileges, such as the data stewards. Examples of suggested data changes include adding a new attribute value, updating an attribute value, deleting an attribute value, and creating a new object along with referenced objects. Data Change Requests can be initiated using web browser-based user interface for Desktop or Mobile. An example of a step can be a user task assigned to users for Review and Approval of the data change request. In this example, a Workflow for a Data Change Request (DCR) includes the following sequence of steps in the flowchart of FIG. 5.

In module 502, on the profile page in Hub, users can initiate the DCR workflow process in the Suggesting mode.

In module 504, the Reviewer can Approve or Reject the DCR. In the Data Change Request Review pane of the UI, sub-attributes within the nested, reference, or complex attributes, and parent-nested attributes, have a label of the attribute value.

In module 506, if the Reviewer approves the DCR, the change request is accepted using the API and the task is marked complete.

In alternative module 508, if the Reviewer rejects the DCR, the change request is rejected using the API and the task is marked complete. In the Inbox, you have the option of partially rejecting changes from a DCR. In various embodiments, a reviewer may selectively reject attributes and approve a DCR partially.

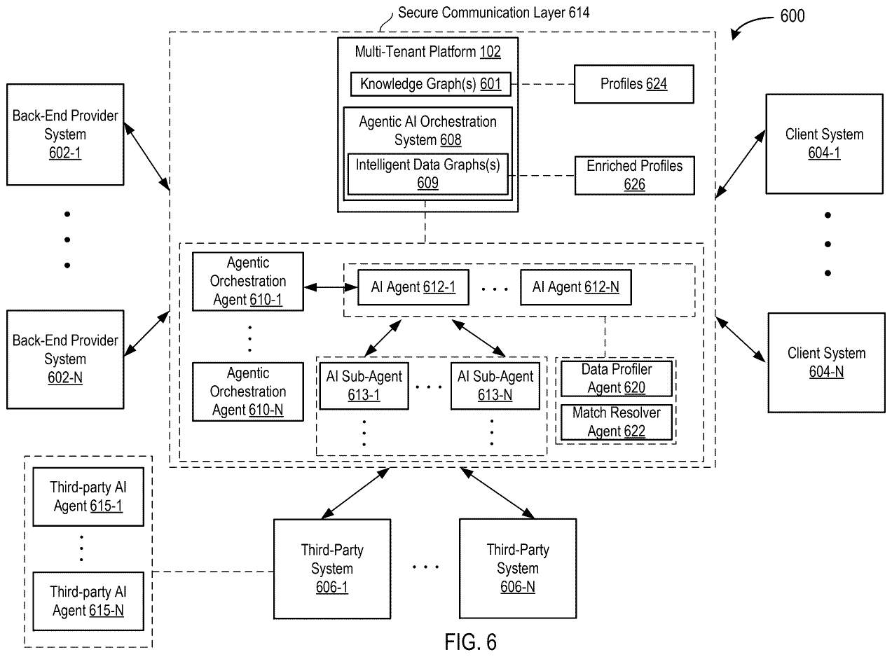

FIG. 6 depicts a diagram 600 of an example environment for agentic orchestration on unified trusted data operations. In the example of FIG. 6, the diagram 600 includes a multi-tenant platform 102 (or, simply, platform 102), back-end provider systems 602-1 to 602-N (individually, the back-end provider system 602, collectively, the back-end provider systems 602), client systems 604-1 to 604-N (individually, the client system 604, collectively, the client systems 604), third-party systems 606, an agentic AI orchestration system 608, agentic orchestration agents 610-1 to 610-N (individually, the agentic orchestration agent 610, collectively, the agentic orchestration agents 610), AI agents 612-1 to 612-N (individually, the AI agents 612, collectively, the AI agents 612), AI sub-agents 613-1 to 613-N (individually, the AI sub-agents 613, collectively, the AI sub-agents 613), third-party AI agents 615-1 to 615-N (individually, the third-party AI agent 615, collectively, the third-party AI agents 615), a data profiler agent 620 (which is a particular type of AI agent 612), and a match resolver AI agent 622 (which is a particular type of AI agent 612).

In the example of FIG. 6, the multi-tenant platform 102 is a multi-domain and/or multi-tenant computing platform that enables seamless integration of many types of data from many sources. The platform 102 may include a variety of different data structures having different formats, structures, data, and/or the like. The multi-tenant platform 102 may include some or all functionality and components as the platform 102 described elsewhere herein. In some embodiments, the multi-tenant platform 102 efficiently provides secure data management without unnecessarily exposing sensitive data.

In the example of FIG. 6, the platform 102 stores and/or represents data in knowledge graph(s) 601. In some embodiments, the knowledge graph(s) 601 provide and/or are represented by unified customer profiles (or, simply, profiles) 620. For example, a profile can be a subset of a knowledge graph 601. The knowledge graphs(s) 601 can provide a graph-structured, real-time data foundation maintained by the platform 102 in which entities (e.g., persons, organizations, products) and their relationships (e.g., belongs-to, located-at, parent/child) are represented as nodes and edges to provide a 360-degree, unified view of key enterprise objects. Accordingly, references to profiles can include the underlying knowledge graph(s) 601 (and/or a subset of the underlying knowledge graph(s) 601). The knowledge graph 601 (and, accordingly, the profiles) can resolve identities across heterogeneous sources (e.g., match and/or merge) and connect data from multiple heterogeneous systems to support governed operations and analytics.

In some embodiments, the knowledge graph 601 is populated and governed using knowledge graph constructs (e.g., entities, relationships, attributes, ontology/schema), and is persisted using graph technology.

In some embodiments, for lineage and source traceability, the platform 102 can embed crosswalk metadata within entity/relationship objects of the knowledge graph 601. For example, crosswalks can tie each consolidated value back to its contributing source record(s). This provenance is part of how the knowledge graph 601 reconciles and audits multi-source data.

In the example of FIG. 6, the back-end provider systems 602 include different back-end service provider systems. The back-end provider systems can include cloud-native service providers (e.g., AWS, Azure), hosted-service providers, and the like. The back-end service provider systems 602 can provide storage services and/or other back-end services for the multi-tenant platform 102 and the clients (e.g., tenants) thereof.

In the example of FIG. 6, the client systems 604 include clients of the multi-tenant platform 102. The client systems 604 may be clients of the multi-tenant platform 102 and may be associated with one or more tenants and/or domains of the multi-tenant platform 102.

In the example of FIG. 6, the third-party systems 606 include different third-party systems, applications, data sources, and/or the like. The third-party systems 606 can store machine learning models (e.g., LLMs). For example, the third-party system 606 can store “out-of-the-box” LLMs and/or other machine learning models. The third-party systems 606 can include Salesforce systems, Atlassian systems, generative artificial intelligence systems, and/or the like.

In the example of FIG. 6, the agentic AI orchestration system 608 provides a scalable, secure conversational interface (e.g., graphical user interface) that allows users to interact with artificial intelligence agents in a streamlined manner. This conversational graphical user interface is robust enough to handle a growing user base (e.g., hundreds, thousands, millions, or more users) and a diverse range of interactions (e.g., data stewardship interactions or operations) while ensuring a secure exchange of information. The conversational nature of the interface makes data interaction more intuitive and accessible to a wider audience than traditional systems.

In some embodiments, the agentic AI orchestration system 608 is part of the platform 102. Although in the example of FIG. 6 the agentic AI orchestration system 608 is shown as being a part of the multi-tenant platform 102, it will be appreciated that other examples may have the agentic AI orchestration system 608 distinct (or at least partially distinct) from the multi-tenant platform 102 (e.g., and in communication with the multi-tenant platform 102 over a communication network).

In some embodiments, the agentic AI orchestration system 608 enables task automation through both first-party AI agents and third-party AI agents, which can reduce manual effort and improve efficiency (e.g., technical and/or computations efficiency). This intelligent automation can extend across various data-governance tasks, such as data enrichment, verification, and report generation, and business-operations tasks, such as product recommendations, fraud prevention. Accordingly, there can be one or more AI agents for each task which can be managed by an agent orchestration agent 610. The agent orchestration agent 610 can deploy, execute, and/or access (e.g., via real-time streaming) the agent orchestration agents 610, AI agents 612, and AI sub-agents 613. AI agents can also be executed, accessed, and/or otherwise associated with the third-party systems 606, which can include third-party AI agents, and which can be controlled by one or more agent orchestration agents 610.

More specifically, agent orchestration agents 610 can instruct, control, and/or otherwise manage other AI agents 612, 613. In some embodiments, an agent orchestration agent 610 is a particular type of AI agent. Agent orchestration agents 610 can include one or more machine learning models (e.g., generative artificial intelligence models) and can execute a variety of different functions. For example, an agent orchestration agent 610 can intelligently parse and/or route data stewardship queries to selected AI agents 612, 613 to accomplish various data stewardship tasks or operations (e.g., retrieval requests instructed by the agent orchestration agent 610 to resolve a data stewardship query). As used herein, machine learning models can include some or all of the different types or models described herein. In some implementations, agent orchestration agents 610, AI agents 612, and/or AI sub-agents 613 can include one or more generative artificial intelligence models (e.g., large language models) to execute the data stewardship tasks and operations. Different AI agents 610, 612, 613 can process different types of data (e.g., unstructured data, structured data) and requests (e.g., retrieval requests, predictions, data stewardship operations, MCP calls (e.g., for accessing third-party AI agents). Accordingly, the AI agents 610, 612, 613 can include various functions and/or machine learning models to accomplish one or more given tasks (e.g., instructed by an agent orchestration agent 610) and/or sub-tasks.

In some embodiments, the AI agents 610, 612, 613 are first-party artificial intelligence agents, but it will be appreciated that AI agents 610, 612, 613 can also include third-party artificial intelligence agents (e.g., AI agents 610, 612, 613) that are controlled, owned, executed, and/or operated by one or more third-party systems 606. Third-party agents can include custom-developed artificial intelligence agents (e.g., custom-developed by a third-party system 606). Accordingly, as used herein, reference to AI agents 610, 612, 613 can refer to first-party agents (e.g., AI agents 610, 612, 613 that are controlled, owned, executed, and/or operated by the agentic AI orchestration system 608 and/or multi-tenant platform 102) and/or third-party artificial intelligence agents. Example third-party AI agents are depicted as elements 615-1 to 615-N, and can include AI agents that are external (e.g., outside the compute boundaries) of the multi-tenant platform 102 and/or agentic AI orchestration system.

In some embodiments, some or all of the AI agents 610, 612, 613 are purpose-built, context-aware, autonomous agents. The artificial intelligence agents 610, 612, 613 can be powered by trusted, context-rich data and accessible via an intuitive conversational graphical user interface, and the artificial intelligence agents 610, 612, 613 can be designed to operate with real-time data.

In some embodiments, the artificial intelligence agents are designed based on extensive domain expertise in data unification and directly map to your jobs-to-be-done, whether it is resolving matches, tracking data quality for a particular project or function, validating data or more. Unlike generic AI copilots and agents that are little more than prompts with a UI wrapper, the artificial intelligence agents of the agentic AI orchestration system 608 combine focus on outcomes with an intuitive user interface, orchestration of sub-agents, long-term and short-term memory, seamless tool and model integrations, and more out-of-the-box.

In some embodiments, some or all of the artificial intelligence agents can be purpose-built, autonomous, auditable AI agents that automate both data governance and enterprise workflows (e.g., handling tasks like match resolution, data quality, data validation and more with minimal manual effort). There may be one or more specific artificial intelligence agents for each task (e.g., data profile agent 620, match resolver agent 622). Some or all of the artificial intelligence agents can natively operate on real-time, unified, context-rich data (e.g., governed by the multi-tenant platform 102).

The data profiler agent 620, in some embodiments, is an autonomous software AI agent that performs pre-ingestion data quality profiling in the multi-tenant platform 102 and/or the agentic AI orchestration system 608. The data profiler agent 620 can provide insights into key data quality metrics (e.g., completeness, consistency, and/or uniqueness of data), flags potential issues that could affect entity matching, and stages certain attribute values for review before data is ingested. By doing so, the data profiler agent 620 ensures that only clean, high-quality data (e.g., above a threshold for the data quality metrics, such as 90%) enters the multi-tenant platform 102, thereby preventing costly reloads or rework after ingestion.

In one implementation, the data profiler agent 620 analyzes (or “profiles”) incoming datasets (e.g., batches of records to be loaded into the multi-tenant platform 102 and/or agentic AI orchestration system 608) and computes various metrics and quality indicators. The datasets can be external to the multi-tenant platform 102 (e.g., outside its compute boundaries). If the data profiler agent 620 detects anomalies or deficiencies (e.g., missing values in mandatory fields, inconsistent formats, or potential duplicates) it can flag these “match-impact” issues for attention and/or correction (e.g., based on user input and/or automatically without requiring user input). Additionally, the data profiler agent 620 can isolate and “stage” certain attribute values that require correction or confirmation. Those staged attributes can be reviewed and approved (or adjusted) by a data steward prior to final ingestion, ensuring that the master data load incorporates the steward's approved values. This proactive workflow (e.g., performing data profiling before the data is committed) catches data quality problems early and can use governed human-in-the-loop approval and/or automatic processes to fix issues upfront.

In some embodiments, the data profiler agent 620 leverages the context-rich data foundation of the multi-tenant platform 102. More specifically, the data profiler agent 620 can cross-verify incoming data against existing records and reference data in the IDG intelligent data graph 609, providing context-aware quality checks. For example, the data profiler agent may detect if a record's key identifiers duplicate an existing record or if an attribute value falls outside expected norms or reference lists (e.g., conditions that could disrupt the entity resolution processes downstream. By flagging such issues (e.g., an incomplete address that would prevent a match, or an inconsistent code value that violates a reference standard) as “match-impacting,” the data profiler agent helps maintain the integrity of entity matching and merging operations within the multi-tenant platform 102 and/or agentic AI orchestration system 608.

In some embodiments, all actions taken by the data profiler agent 620 are fully governed and auditable. The data profiler agent 620 can leverage the enterprise-grade security and compliance controls of the multi-tenant platform 102. For example, each profiling action or recommended change can be logged, and role-based access controls can ensure that only authorized users (e.g., data stewards) can approve or override changes. Accordingly, the actions of the data profiler agent 620 is explainable and transparent, which is a critical requirement in regulated environments. The output of the data profiler agent 602 (e.g., the data quality metrics and identified “data signals”) can also be surfaced in dashboards and/or fed into other AI systems (e.g., other AI agents 610-615, third-party systems 606) to inform decision-making. Accordingly, the data profiler agent 620 can function as an intelligent gatekeeper for data quality, combining automated analytics (e.g., AI) with human oversight to accelerate AI readiness by ensuring that incoming data is accurate, complete, and match-ready.

In some embodiments, some or all of the artificial intelligence agents can natively integrate with an MCP server and automatically inherit policies from the multi-tenant platform 102 to enable context-aware, governed decisions at scale. The MCP server can also provide trusted, rich data to custom LLMs to power agentic business workflows.

In some embodiments, some or all of the artificial intelligence agent decisions are grounded in real-time, unified data and shaped by inherited governance policies, thereby ensuring safe, consistent outcomes that align with business rules.

In some embodiments, the agentic AI orchestration system 608 is an enterprise-grade, secure platform that provides a semantic layer that unifies and governs data across sources and domains in real time. This can include cloud-native foundation enabling every artificial intelligence agent to inherit deep context and built-in policy controls from a single, trusted source, thereby enabling safe, scalable automation across both data and business workflows.

In some embodiments, the agentic AI orchestration system 608 support proactive suggestions, facilitating more efficient and informed decision-making. The agentic AI orchestration system 608 can anticipate user and system needs and offer relevant suggestions, predictions, and/or recommendations based on the current context of a conversation, and guiding users toward optimal actions (e.g., data stewardship actions/operations).

In some embodiments, the agentic AI orchestration system 608 maintains strict tenant isolation and permission enforcement to ensure data privacy and security for all users and/or systems. For example, each tenant's data of the multi-tenant platform 102 can be completely isolated from other tenants, thereby preventing unauthorized access and data breaches. The agentic AI orchestration system 608 can create, define, and/or update permissions that are granular and strictly enforced, thereby ensuring that users and/or systems can only access the data and functionality they are authorized to use or access.

The agentic AI orchestration system 608 solves a variety of different technical problems, such as complexity and volume of data operations. The agentic AI orchestration system 608 addresses the increasing intricacy involved in managing and manipulating big volumes of data (e.g., thousands, millions, billions, or more data records or entities). As data environments grow in scale and sophistication, users and systems face challenges in efficiently performing data management tasks, understanding data relationships, and extracting meaningful insights. This agentic AI orchestration system 608 simplifies these interactions by providing a natural language interface that abstracts away the underlying complexity, allowing users and systems to focus on their objectives rather than struggling with technical details which are solved by the agentic AI orchestration system 608.

The agentic AI orchestration system 608 also addresses the technical challenges posed by the growing user preference for interacting with systems through natural language. Traditional user interfaces often require users to navigate complex menus, write specific queries, or learn proprietary commands. The agentic AI orchestration system 608 eliminates this burden by allowing users and/or systems to communicate with the agentic AI orchestration system 608 and multi-tenant platform 102 using plain language, making it more accessible and intuitive for a wider range of users, regardless of their technical expertise.

In some embodiments, the agentic AI orchestration system 608 is designed and implemented to enhance user and system productivity by intelligently streamlining workflows and intelligently automating repetitive tasks. By leveraging AI agents 610, 612, 613, the agentic AI orchestration system 608 can proactively suggest actions, execute commands, and generate reports, thereby freeing users and/or other systems from time-consuming manual processes and/or computationally inefficient processes (e.g., because the other systems rely on outdated protocols, inefficient APIs, etc.). This intelligent automation enables users and/or systems to accomplish more in less time, improving overall efficiency and reducing operational and computational costs.

In some embodiments, the agentic AI orchestration system 608 provides contextual automation through agent-driven recommendations and/or actions. More specifically, the agentic AI orchestration system 608 addresses the challenge of providing relevant and timely assistance to users and/or systems based on their current context. This agentic AI orchestration system 608 leverages agent-driven recommendations provided by the AI agents 610, 612, 613, 615 to offer proactive suggestions and guidance, ensuring that users and systems have the information and tools they need at the moment they need them. This contextual automation helps users and systems make better decisions, avoid errors, and optimize their workflows for maximum efficiency.

In some embodiments, the agentic AI orchestration system 608 also addresses the lack of integration with enterprise systems. The agentic AI orchestration system 608 tackles the need for seamless integration with other enterprise systems (e.g., third-party system 606), such as Salesforce, ServiceNow, Atlassian and other enterprise applications. Many organizations rely on a variety of disparate applications to manage their data and business processes. The agentic AI orchestration system 608 bridges these silos by providing a consistent artificial intelligence agent framework that enables users and/or systems to interact with different systems through a single, unified interface. This integration simplifies data access, facilitates collaboration, and improves overall operational and computational efficiency.

The agentic AI orchestration system 608 also addresses other technical challenges, which are solved by the agentic AI orchestration system 608 and systems and methods described herein:
Enterprises struggle to operationalize both data governance and business workflows at scale.
Siloed, inconsistent data and manual processes burden teams—from data stewards battling governance backlogs to business users juggling disjointed systems—leading to slowed innovation, elevated risk from autonomous AI actions with poor quality data, and wasted resources.
DIY attempts at agents for business workflows stall in production, are too light in capabilities, thus fail to deliver business value, and increase risks—due to lack of easy access to trusted, unified, context-rich data.
DIY attempts at data governance agents often underperform and stall in production as they require an enterprise-grade data platform. Maintaining custom-built agents on a robust data or analytics platform also requires ongoing resources and skills.
Other third party “agents” are more like copilots—generic in training, lacking in focus, and unable to accomplish tasks and drive outcomes without significant manual effort
Adoption of AI agents creates risk unless they are governed, audited and under tight guardrails.

As discussed elsewhere herein, the agentic AI orchestration system 608 provides a variety of technical advantages over traditional computing systems. For example, the agentic AI orchestration system 608 simplifies complex data operations by providing a conversational user interface, making it easier for users to interact with data than traditional methods. This approach reduces the learning curve and allows users to focus on their tasks rather than navigating complicated systems.

The agentic AI orchestration system 608 also boosts productivity and computational efficiency through agent-driven recommendations and task automation, which reduces the time and effort required to complete common tasks. By proactively suggesting actions based on context, the agentic AI orchestration system 608 can streamline workflows and accelerate decision-making. The agentic AI orchestration system 608 can also enable integration with third-party enterprise systems (e.g., third-party systems 606) through the Model Context Protocol (MCP) and a consistent artificial intelligence agent framework, providing a more seamless experience. This can eliminate data and application silos and improve collaboration across different platforms. The agentic AI orchestration system 608 also supports proactive suggestions and Agent-to-Agent (A2A) collaboration, which allows artificial intelligence agents 610, 612, 613 to work together to solve complex problems. This fosters innovation and enables the development of more sophisticated solutions.

The agentic AI orchestration system 608 can also maintain strict tenant isolation and permission enforcement, ensuring that data is secure and accessible only to authorized users. This is particularly important for organizations that handle sensitive data.

In some embodiments, the agentic AI orchestration system 608 provides multi-agent orchestration (A2A Expansion). Instead of a single artificial intelligence agent per conversation, the agentic AI orchestration system 608 can support dynamic routing between multiple agents in one session (and/or across multiple sessions). For example, a profiler AI agent 612-1 can trigger a downstream enricher artificial intelligence agent 612-N based on profiling results.

In some embodiments, the agentic AI orchestration system 608 provides a plug-and-play agent SDK. For example, third-party developers and/or systems (e.g., third-party system 606) can use an SDK to build and register artificial intelligence agents with custom interfaces and tools, abstracting away backend complexity and enabling a full agent marketplace.

In some embodiments, the agentic AI orchestration system 608 provides a voice-activated conversational interface that extend the frontend to support voice input/output, allowing hands-free interaction, which can be particularly valuable in environments such as healthcare or field services.

In some embodiments, the agentic AI orchestration system 608 provides autonomous agent-driven workflows. For example, artificial intelligence agents 610, 612, 613 can operate asynchronously in the background to monitor data conditions and proactively initiate conversations or tasks with users (e.g., “Data freshness threshold exceeded—shall I re-ingest?”).

In some embodiments, the agentic AI orchestration system 608 provides an offline and/or edge-compatible mode. For example, the agentic AI orchestration system 608 can provide a lightweight, local version of the artificial intelligence agents 610, 612, 613 running on edge devices or in offline environments, syncing with the cloud once connectivity is restored.

In some embodiments, the agentic AI orchestration system 608 provides multi-tenant global agent routing. For example, the agentic AI orchestration system 608 can include a global agent registry that routes requests across multiple tenants with shared services, enabling federated data actions or enterprise-wide intelligence.

In some embodiments, the agentic AI orchestration system 608 provides a conversational analytics layer that integrates an insights layer where artificial intelligence agents 610, 612, 613 not only respond but also visualize trends, anomalies, and audit logs directly in the conversational graphical user interface.

In some embodiments, the agentic AI orchestration system 608 provides agent behavior customization via a prompt engineering user interface (UI). For example, users or admins can configure artificial intelligence agent behavior through a low-code interface that adjusts prompt templates or conversational tone without needing code changes.

In some embodiments, the agentic AI orchestration system 608 provides Bring Your Own Model (BYOM) support. For example, enterprises can select different LLMs (e.g., OpenAI, Gemini) per artificial intelligence agent or per tenant, with configurable routing logic and fallback models.

In some embodiments, the agentic AI orchestration system 608 provides Bring Your Own MCP (BYOMCP) support. For example, enterprises can select any MCP server to interface the agentic AI orchestration system 608 with third-party systems 606 (e.g., third-party data providers, applications, resources, APIs, etc.).

In some embodiments, the agentic AI orchestration system 608 provides entity resolution utilizing large language models (LLMs). The agentic AI orchestration system 608 can leverage the advanced natural language processing capabilities of LLMs to interpret, link, and resolve entities across diverse data sets with higher accuracy and efficiency than traditional systems and methods.

In some embodiments, the agentic AI orchestration system 608 provides an agentic conversational experience though the conversational graphical user interface for interacting with the AI agents 610, 612, 613, enabling users to interact with the artificial intelligence agents (which may also include data agents in some embodiments) through natural language inputs (e.g., natural language queries). This can facilitate a more intuitive and efficient way to manage and utilize data. The agentic AI orchestration system 608 offers a streamlined experience by supporting task automation, proactive suggestions, and agent-to-agent collaboration, improving user and system productivity and data operation efficiency.

In some embodiments, the agentic AI orchestration system 608 provides foundational and domain-specific artificial intelligence agents, such as data enricher AI agents, verifier AI agents, profiler AI agents, integrator AI agents, and/or classifier AI agents, providing specialized functionalities. These artificial intelligence agents can be connected to a MCP (Model Context Protocol) server (e.g., of the secure communication layer 614), which can be crucial for accessing and manipulating data within various systems, including the multi-tenant platform 102 and third-party systems 606, such as Salesforce, ServiceNow, Atlassian, etc. The agentic AI orchestration system 608 can also support the generation of dynamic reports/artifacts in markdown or code generated formats, offering users customizable and dynamic ways to visualize and analyze their data.

In some embodiments, the agentic AI orchestration system 608 includes an agent registry and routing layer that manages the available artificial intelligence agents and directs user requests to the appropriate agent based on the context of the conversation, ensuring efficient task execution. The agentic AI orchestration system 608 can also include a comprehensive permission-based access control system and tenant isolation, ensuring that data and tool access are strictly governed by user roles and tenant scopes, as well as protecting sensitive information with data masking for users with READ MASKED permissions.

In some embodiments, the agentic AI orchestration system 608 can utilize Anthropic 4.0 Sonnet (e.g., initially through AWS Bedrock) as its large language model (LLM) and can offer a streaming capability for returning responses, improving the user experience by providing real-time feedback as the artificial intelligence agents process requests. However, the agentic AI orchestration system 608 can also be configured to change models from other providers (e.g., third-party systems 606) and it can support additional models in a Bring Your Own Model approach.

In some embodiments, the agentic AI orchestration system 608 supports JSON debug view availability via status pills, which allows users to examine the underlying data and processes involved in task execution for better transparency and troubleshooting.

In some embodiments, the integration of the agentic AI orchestration system 608 and the MCP server (e.g., via the secure communication layer 614) facilitates seamless data operations and access to various tools for resolving data issues, enriching records, and generating data quality reports; this integration is designed to extend to 3rd party enterprise systems in future releases, creating a unified agent framework. Additionally, the agentic AI orchestration system 608 can incorporate logging and monitoring of user actions, tool calls, and streaming events, with centralized error logging for debugging and troubleshooting.

In some embodiments, the agentic AI orchestration system 608 provides automated data stewardship in which users and/or systems can interact with artificial intelligence agents 610, 612, 613 to identify, validate, enrich, or resolve data issues (e.g., duplicates, missing fields) through natural language, thereby streamlining data quality management.

In some embodiments, the agentic AI orchestration system 608 provides self-service reporting and profiling. For example, users (e.g., business analysts) can generate on-demand data quality reports or profiling summaries using chat prompts, without needing to understand technical query languages.

In some embodiments, the agentic AI orchestration system 608 provides domain-specific Data intelligence. For example, vertical-specific artificial intelligence agents (e.g., healthcare artificial intelligence agents 612, 613, financial services AI agents 612, 613, retail AI agents 612,613) can help users and/or systems apply industry rules or classifications to their data automatically.

In some embodiments, the agentic AI orchestration system 608 provides proactive data recommendations. For example, the agentic AI orchestration system 608 can suggest next-best actions (e.g., enrich, classify, merge) based on the context of prior activity, reducing cognitive load and improving productivity.

In some embodiments, the agentic AI orchestration system 608 provides partner and third-party extensions. For example, partners or enterprise customers of the multi-tenant platform 102 can build and register their own artificial intelligence agents tailored to unique technical and/or business needs (e.g., fraud detection agent, consent validation agent).

In some embodiments, the agentic AI orchestration system 608 provides federated data operations across systems. For example, artificial intelligence agents can interact with external systems (e.g., third-party systems 606 via MCP servers of the secure communication layer 614), such as Salesforce or Atlassian, to unify workflows (e.g., validating multi-tenant platform 102 data against CRM records).

In some embodiments, the agentic AI orchestration system 608 can provide prebuilt artificial intelligence agents 610, 612, 613 (although they may not be prebuilt in some embodiments) that actually automate data governance and business workflows. Unlike generic AI copilots that lack focus and domain expertise, the agentic AI orchestration system 608, in some embodiments, combines purpose-built focus on specific jobs-to-be-done with contextual awareness of a tenant's unified, trusted data.

In some embodiments, the agentic AI orchestration system 608 delivers tailored views, recommendations, and interactions based on user roles, data domains, and task types. Artificial intelligence agents can proactively surface tasks and propose actions; agent output streams live in the UI with real-time status updates, keeping users informed and engaged. Artificial intelligence agents can also be natively powered by any LLM offered by major cloud providers (e.g., AWS Bedrock, Azure OpenAI, Google Vertex AI, etc.) and can support bring-your-own LLM functionality. The agentic AI orchestration system 608 can be designed for accessibility across desktop and mobile devices, thereby enabling users to interact with the artificial intelligence agents described herein at any time and any place.

In the example of FIG. 6, the agentic AI orchestration system 608 provides some or all of the functionality described herein using intelligent data graph(s) 609. In some embodiments, the intelligent data graph(s) 609 provide and/or are represented by enriched profile(s) 622. For example, an enriched profile may be a subset of an intelligent data graph 609. Accordingly, references to enriched profiles can include the underlying intelligent data graph(s) 609 (or, underlying subsets of the intelligent data graph(s) 609) and/or vice versa. In some embodiments, the intelligent data graph(s) 609 comprise an AI-ready evolution of the knowledge graph 601 that adds new dimensions of context and behavior specifically to power AI and agentic use cases. The intelligent data graph 609 can connect and contextualize data so it becomes usable by AI agents (e.g., AI agents 610-614) serving as a trusted, context-rich layer for enterprise AI decisions.

The intelligent data graph(s) 609 additionally goes beyond the knowledge graph 601 by incorporating unstructured data (e.g., in addition to structured data and/or semi-structured data), operational signals/events, and metadata, and is context-aware and dynamically evolving, and is built to support autonomous agents (e.g., AI agents 612-614) that operate across different domains and/or enterprises. In some embodiments, the intelligent data graph 609 includes, provides, enables, and/or facilitates AI-powered extraction of entities (e.g., people, organizations, products, and/or the like) from unstructured data (e.g., unstructured files) and automatic linking of those extracted objects into the intelligent data graph 609 (e.g., by explicitly connecting them to the intelligent data graph 609).

As used herein, structured data is data that fits a predefined schema (e.g., fixed fields, types, constraints). For example, structured data can be organized so machines can query it efficiently and unambiguously, such as SQL tables, spreadsheets, CRM records, knowledge-graph triples (subject-predicate-object), event logs with fixed fields, and telemetry metrics. Unstructured data can be data without a fixed schema. For example, unstructured data may have patterns, but no enforced data model. Examples of unstructured data include free-form text (e.g., emails, docs, chat), PDFs, images, audio, video, code, and web pages.

Semi-structured data can be in between structured data and unstructured data. For example, semi-structured data can include data with tags or keys but a flexible shape. Examples of semi-structured data include JSON, XML, HTML, YAML, and many logs. These have structure, but fields can vary and are not strictly enforced.

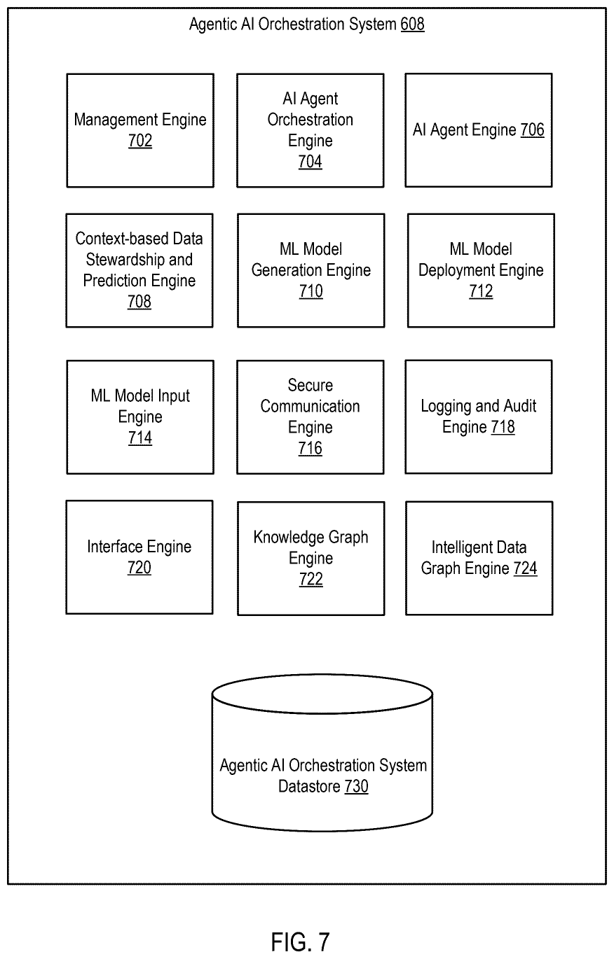

FIG. 7 depicts a diagram 700 of an example agentic AI orchestration system 608. In the example of FIG. 7, the agentic AI orchestration system 608 includes a management engine 702, an AI agent orchestration engine 704, an AI agent engine 706, a context-based data stewardship and prediction 708, a machine learning model generation engine 710, a machine learning model deployment engine 712, a machine learning model input engine 714, a secure communication layer 614, a logging and audit engine 718, an interface engine 720, a knowledge graph engine 722, an intelligent data graph engine 724, and an agentic AI orchestration system datastore 730.

The management engine 702 is intended to represent an engine that can manage (e.g., create, read, update, delete, or otherwise access) data in local (e.g., datastore 730) and/or remote systems datastores. The management engine 702 can perform any of these operations manually (e.g., by a user interacting with a GUI) and/or automatically (e.g., triggered by one or more of the engines 702-724). Like the other engines described herein, some or all the functionality of the management engine 702 can be included in and/or cooperate with one or more other engines (e.g., engines 702-724) and datastores (e.g., agentic AI orchestration system datastores 730). In some embodiments, the management engine 702 manages data stored by remote systems (e.g., back-end provider systems 602) and/or datastores of the agentic AI orchestration system 608 (e.g., agentic AI orchestration system datastore 730).

In some embodiments, the management engine 702 can access a plurality of datasets. The plurality of datasets can include personally identifiable information (PII). For example, the management engine 714 can access datasets stored on back-end-provider systems (e.g., back-end provider systems 602) and/or datasets stored on/by the multi-tenant platform 102 (e.g., MDM datastores).

The AI agent orchestration engine 704 is intended to represent an engine that generates, executes, updates, and/or otherwise manages agent orchestration agents. Orchestration agents can parse natural inputs (e.g., queries) and instruct the appropriate AI agents to process portions of the parsed natural language input (e.g., in parallel) and provide answers/responses to the inputs based on responses (e.g., predictive insights) provided by the AI agents.

The AI agent engine 706 is intended to represent an engine that generates, executes, updates, and/or otherwise manages AI agents and AI sub-agents. The AI agents can include (e.g., execute) machine learning models, such as large language models and/or multimodal models. The AI agent engine 706 can execute a variety of different agents, such as data profiler agent 620 and match resolver AI agent 622.

In some embodiments, the AI agent engine 706 executes a data profiler agent 620 that can generate and/or utilize predictive outputs that include data quality or anomaly detection insights (e.g., for external datasets to be ingested into the multi-tenant platform 102, profiles 624, enriched profiles 626, and/or the like). Data quality or anomaly detection insights can refer to alerts or observations the data profiler agent 620 generates when something about the data is unusual or potentially wrong. These insights can help maintain the reliability of the data in the profile by flagging anomalies (e.g., outliers, errors, or inconsistencies) either in incoming data or in the model's results.

In one example, a “data consistency or duplicate” insight can note inconsistencies (e.g., possible duplicate profile: two records share the same email and phone number, or conflicting data: two birthdates found for the same customer). These insights can rely on data reconciliation rules or identity resolution algorithms. An anomaly detection process could also catch a duplicate entry if, for example, the same unique identifier appears twice (e.g., a violation of uniqueness).

In another example, a “schema or format anomalies” insight can detect if an incoming customer data structure changes unexpectedly or contains a wrong format (e.g., a text string in a field that should be numeric), the system can generate an insight (e.g., “data format anomaly: Customer ID field contains non-numeric characters for 5 records”). This could, for example, be detected by a schema validation step or an automated data pipeline monitor.

In some embodiments, these insights are generated by the data profiler agent 620 through a combination of rule-based data quality checks and/or anomaly detection algorithms (e.g., machine learning algorithms). Rule-based checks can be conditions set by data engineers or analysts (e.g., “age must be between 0 and 120”, “email must contain @”, “daily purchases shouldn't exceed $X without flag”). When data violates these rules, the system logs an insight or warning. ML-based anomaly detection can involve models (e.g., large language models) that learn what “normal” data looks like and flag deviations. Techniques can be unsupervised (e.g., clustering, isolation forest, or outlier detection methods) or based on thresholds derived from statistics (e.g., standard deviation, z-scores, etc.). Effective anomaly detection often uses a mix of these methods to catch different types of issues. For example, the data profiler agent 620 can automatically monitor each profile's metrics, and if something deviates by more than a threshold amount (e.g., 3 standard deviations from the mean), it can generate an insight.

In some embodiments, the agentic AI orchestration system can detect whether a predictive output is inconsistent with past data (e.g., the model predicts something very different due to a bad input) and flag a model output anomaly.

As discussed elsewhere herein, the secure communication layer 615 can include a Model Context Protocol (MCP) server that exposes permission-aware APIs and enforces policy-aware routing and filtering based on user role, purpose, and applicable governance policies.

In some embodiments, the data profiler agent 620 receives an instruction to profile a dataset located in an external data source (e.g., third-party system 606, back-end provider system 602, client system 604). The data profiler agent can initiate a profiling operation that scans the dataset prior to ingestion to identify data quality issues including, for example, null values, invalid formats, and inconsistencies.

In some embodiments, the data profiler agent 620 further performs an intelligent mapping operation that aligns source columns to configured tenant schema attributes (e.g., entity attributes) and generates mapping confidence scores. Since profiling may involve large datasets (e.g., millions of records), the data profiler agent 620 can run a long-running job that periodically writes intermediate results to a profiling state repository. Intermediate profiling results may include, for example, partial counts and distributions computed over processed records, detected invalid-value patterns (e.g., malformed email patterns or invalid categorical codes), a current best mapping of source columns to tenant attributes with confidence scores, and/or recommended data improvement actions including transformation rules or validation logic.

In some embodiments, during execution of the profiling job, the conversational workspace remains available to receive natural language queries from a user associated with the profiling session. Upon receiving a query, the data profiler agent 620 can associate the query with the current profiling session and job state (e.g., via a session identifier or job identifier maintained in conversation context), and determine, using the current conversation context and a system prompt, one or more tool invocations required to answer the question using computed profiling results, and then execute the tool invocations through the secure communication layer such that role-based access controls and data masking policies are enforced and auditable logs are generated.

In some embodiments, the data profiler agent 620 produces a response that includes a natural language explanation and one or more structured results (e.g., tables, metrics, or representative samples of corrupted values) derived from the intermediate profiling results.

In some embodiments, the user may “probe” the data profiler agent 620 for specific corrupted values, and the data profiler agent 620 can return both the corrupted values and one or more recommended correction strategies (e.g., standardization, code normalization, or validation patterns). The data profiler agent can also support repeated querying and refinement within the same profiling session, thereby enabling a user to iteratively investigate data quality issues and mapping uncertainties as the profiling job progresses, rather than waiting for a static report. After the user reviews mapping and quality checks, the data profiler agent can initiate or trigger a data load operation (e.g., ingestion) directly from the conversational interface using the secure communication layer.

In some embodiments, some or all of the AI agents can cooperate with (e.g., communicate with) one or more of the engines 702-724 (e.g., the context-based data stewardship and prediction 708) of the agentic AI orchestration system 608 (and/or vice versa) in order for the AI agents 610-613 and 620-622 (e.g., data profiler agent 620) to provide some or all of the functionality of those engine 702-724. In some embodiments, the AI agents 610-613 and 620-622 themselves can include or provide some or all of the functionality of the engines 702-724, discussed below. For example, the some or all of the AI agents 610-613 may include a separate instance of some or all of the engines 702-724, or portions thereof, and/or the AI agents 610-613 and 620-622 may connect/communicate (e.g., via API calls) with some or all of the engines 702-724 to provide some or all of the functionality of the engines 702-724 by the AI agents 610-613.

Accordingly, for example, the data profiler agent 620 may include a separate instance of some or all of the context-based data stewardship and prediction engine 708 and/or the data profiler agent 620 may connect/communicate (e.g., via API calls) with the context-based data stewardship and prediction engine 708 to provide some or all of the functionality of the context-based data stewardship and prediction engine 708 by the data profiler agent 620.

The context-based data stewardship and prediction engine 708 is intended to represent an engine that can use machine learning models to generate predictive insights, generate recommendations, execute recommendations and/or operational actions, and/or the like. For example, the context-based data stewardship and prediction 708 can use machine learning models or algorithms built within the agentic AI orchestration system 608 and/or platform 102 to generate predictive insights derived from customer data managed by the platform 102. The context-based data stewardship and prediction 708 can use these insights to enhance customer profiles managed within the platform 102, thereby enabling business users to make informed decisions more quickly, accurately, and/or efficiently (e.g., requiring few computing resources).

In some embodiments, the context-based data stewardship and prediction 708 uses large language models (LLMs) and/or other generative artificial intelligence models (e.g., multimodal models) to predict and/or perform data stewardship operation (e.g., determine whether any data records match any other data records and then merge those data records). For example, the LLMs may include one or more LLMs that have been trained on various datasets (e.g., domain-specific datasets, enterprise-specific datasets, tenant-specific datasets, comparison database datasets, and the like) to identify matches more accurately even when data records have different structures, formats, and/or information. In one example, the context-based data stewardship and prediction 708 implements one or more similarity algorithms or models to determine matches.

In some implementations, the large language models include domain-agnostic large language models. Domain-agnostic large language models can include large language models that have not been trained on domain-specific datasets, customer-specific datasets, and/or the like, that can identify matches more accurately even when data records have different structures, formats, and/or information. In one example, the context-based data stewardship and prediction 708 and/or the large language models can implement one or more similarity algorithms or models to determine matches. In one example, the domain-agnostic large language models can create features measuring distances between two names, addresses, etc., and these features can be reused in any entity model, or even an attribute model about names, addresses, etc. This reusability pattern is different than a single model that consumes all of these representations of name features to output an entity score, because that model is retrained for different entity types, and the interpretability of the features are only local to their original models.

In some embodiments, the context-based data stewardship and prediction 708 can swap out one or more large language models for another large language model that has been fine-tuned to this specific task. More specifically, the context-based data stewardship and prediction 708 can replace the large language model with a series of neural networks that each approximate the outputs of a large language model. The context-based data stewardship and prediction 708 may swap pre-runtime, at or during runtime (e.g., on the fly), and/or post-runtime.

In some embodiments, the context-based data stewardship and prediction 708 can function to identify candidate data records for potential match identification. More specifically, the context-based data stewardship and prediction 708 may identify various data records (e.g., data records of a live multi-tenant enterprise environment). Each data record may be associated with an entity (e.g., person, organization, enterprise, product), and each data record may include various record fields (e.g., first name, last name, social security number, email address, phone number, city, state, county, zip code, area code, country, organization, and the like) and corresponding record field values (e.g., John, Doe, 555-55-5555, john.doe@domain.com, 555-555-5555, Boston, MA, Suffolk, 02109, 617, USA, Acme, and the like). The context-based data stewardship and prediction 708 may identify candidate records that have the same corresponding field values, as well as records that have different values, format, structure, and the like. The candidate records may be used by the context-based data stewardship and prediction 708 to determine matches between data records.

The context-based data stewardship and prediction 708 can function to merge and/or otherwise resolve two or more matching data records and/or perform other entity resolution operations (e.g., within a multi-tenant MDM platform 102). For example, the context-based data stewardship and prediction 708 can merge a first data record with a second data record and maintain the second data record and disregard (e.g., delete, ignore) the first data record in any subsequent operations. In another example, the context-based data stewardship and prediction 708 may create a new data record from the first and second data records and disregard the first and second data records in any subsequent operations. In some embodiments, entity resolution operations may be performed within a particular tenant and/or across multiple tenants. For example, a first data record of a first tenant may be matched and/or merged with a second data record of a second tenant.

In some embodiments, the context-based data stewardship and prediction 708 can perform entity resolution that includes merging duplicate records into one unified profile node (e.g., of a knowledge graph and/or intelligent knowledge graph). For example, rather than creating separate nodes for each source record and linking them, the context-based data stewardship and prediction 708 can merge them into a single node (e.g., while retaining source references internally). In a specific example, when multiple source records represent the same real-world entity (e.g., customer), the context-based data stewardship and prediction 708 can detect duplicates (e.g., using rules or ML models) and merge them. The unified node can accumulate all unique attributes from the duplicates and preserve any differing values under their respective crosswalks. Notably, if two records share the same unique crosswalk (e.g., an explicit ID match), the context-based data stewardship and prediction 708 can assume they represent the same entity and automatically merge them into a single profile (or, single enriched profile).

In some embodiments, after an entity resolution operation (e.g., merge), the resulting profile node contains the union of attributes (e.g., all addresses, all emails from each source) and the system applies survivorship rules to pick the primary values (the OV) for operational use. The identity resolution process thus ensures each real customer is represented by one node in the graph, creating a true single source of truth. Reltio retains the provenance: one can inspect a profile's “Sources” view to see every contributing source record and attribute origin. This approach-consolidating duplicates into one graph node-differs from a pure linkage approach and is key to how Reltio structures the “unified customer profile.” The graph is updated in real time as new data arrives: if a new record is matched to an existing customer, it will merge into that node, enriching the profile's attributes and keeping relationships intact (rather than creating a separate node). Reltio's big-data architecture and multi-model storage ensure that even as these profiles update and grow, the graph can be queried with high performance.

In some embodiments, the context-based data stewardship and prediction 708 can execute a variety of operational actions (e.g., data stewardship operations). The context-based data stewardship and prediction 708 may also cooperate (e.g., instruct) with the AI agent engine 706 and/or AI agents 612, AI sub-agents 613, agentic orchestration agents 610, third-party AI agents 615, and/or other third-party systems 606 to execute recommendations, operational actions, and/or the like. For example, any of these AI agents 610-615 and/or systems 606 may automatically execute an operational action (e.g., based at least in part on a predictive output of an enriched profile).

In one example, an AI agent can, responsive to an update to a profile with predictive output, retrieve, via a secure interface (e.g., secure communication layer 614), at least a portion of the enriched profile including the new attribute, and automatically execute an operational action based at least in part on a predictive output (e.g., generated by the context-based data stewardship and prediction 708). In some embodiments, a predictive output can be a machine-generated datum (or small data structure) produced by a machine learning model and/or AI agent, such as a score, label, ranked list, time-to-event, anomaly score, and/or recommended action. For example, a predictive output can be the likelihood that two or more records match, a recommended action (e.g., merge), and/or the like.

In some embodiments, the predictive output is a data structure (e.g., record) with fields, such as output_value (score/label/ranking), confidence (probability/uncertainty), model_id+model_version, input_context_id (or profile snapshot timestamp), generated_timestamp, and/or the like. In some embodiments, operational actions can include, for example, some or all of the following:
(1) initiating or updating an enterprise workflow record (e.g., create a CRM follow-up task, create or update a case in a service desk system when a predicted “high severity” outcome is detected, create an escalation ticket to a retention specialist queue when a churn score crosses a cutoff, and/or the like)
(2) generating and transmitting an electronic communication or notification. For example, send a retention email/SMS/push notification when the new attribute indicates churn risk above a threshold, trigger a personalized offer (e.g., discount, free shipping, concierge call) when propensity-to-purchase exceeds a threshold, generate a customer-support summary or recommended response script using the enriched profile (e.g., “high value+at risk”) and present it in an agent console
(3) routing or prioritizing a customer interaction, case, or task (e.g., route inbound chat/call to a retention queue if churn risk is high, prioritize a sales lead in a worklist if propensity score is high, escalate a service case when predicted dissatisfaction risk is high)
(4) updating a segmentation, eligibility list, or personalization configuration (e.g., add customer to a “High LTV/High Churn Risk” segment and remove from generic campaigns, update an “eligibility list” for premium support/concierge handling based on predicted lifetime value, update profile flags to change what is shown in a portal or app
(5) invoking a governed data-operation (e.g., data stewardship operation) to validate, enrich, and/or remediate the profile. For example, an AI agent can retrieve the enriched profile and initiates duplicate investigation and/or match/entity resolution operation. In another example, an AI agent can execute a governed tool to search and compare candidate duplicates and recommend a merge (e.g., with human approval if required). In another example, an AI agent can trigger a “validate record” action when a model flags a suspected anomaly (e.g., invalid address format, improbable age, conflicting IDs).

In some embodiments, a profile is a collection of all the data associated with an entity, including attributes, relationships, sources, and also the entity's interaction data. Accordingly, customer data (and/or tenant data) can refer to the customer (or Individual/Organization/tenant) entity and the attributes/relationships that describe that customer. For example, customer entity attributes can include identity/contact information (e.g., Customer Name, Address, Phone Number, Email, entity identifiers, etc.), relationship information (e.g., links to household members, accounts, locations, products owned/registered, etc.), and source/provenance information (e.g., which upstream systems contributed each value.

Transactions and interaction records can be enterprise event records capturing real-world events that occur at a particular moment that correlate all omnichannel interactions and transactions with the profiles. For example, transactions and interaction records can include opening an email, opening a support case, visiting a website, and/or the like. More specifically, interactions reflect engagement or behavioral signals (e.g., browse, click, open, call, view, search, contact), and transactions reflect operational events (e.g., claim, shipment, etc.).

The predictive output can be the result generated by a predictive model (e.g., machine learning model of an AI agent, the context-based data stewardship and prediction 708, etc.) when it processes input data. In this context, data (e.g., customer data and/or curated data) is fed into a machine learning model or analytic algorithm via the secure communication layer 614. The model can apply its learned patterns or rules to this input and produce a prediction or score as output. In simpler terms, predictive modeling takes relevant input variables and generates a predicted output variable. The input features could be things like a customer's demographics, purchase history, website interactions, etc., and the output might be a prediction such as “likelihood to churn=0.8” (an 80% chance the customer will churn) or “predicted lifetime value=$5,000”, or even a category like “segment=Frequent Buyer.”

This predictive output can be derived from the customer data through machine learning-based processing inside the model. For instance, a trained machine learning model can use the customer's data as input and determine the output using the model's parameters. In some embodiments, the model was previously trained on historical data, so it can find patterns relating inputs to desired outputs. When new customer data is transmitted to it, it can leverage those learned patterns to compute a prediction. In one implementation, the secure communication layer 614 will package the customer's data (e.g., as a feature vector or JSON payload) and call the model's API or function. The model returns a result (e.g., a probability, score, or label) that is the predictive output.

In some embodiments, when the system updates profiles (e.g., by writing the predictive output as a new attribute of that profile), it enriches the profile with the model's result. In a knowledge graph, a profile can be represented as an entity (node), and information about the customer is stored as properties or relationships of that node. Adding a “new attribute” derived from the predictive output creates a new property on the customer's node (or a new linked node) that captures that prediction. For example, imagine the knowledge graph has a node for Customer Alice. Before, Alice's node might have attributes like Name, Email, Total Purchases, etc., and relationships linking to her Transactions or Interactions. For example, the predictive model can output a match percentage/likelihood for Alice with other one or more entities/records. Updating her profile adds an attribute on Alice's node indicating that match percentage (e.g., which could be used to trigger a merge operation). This new piece of data becomes part of the knowledge graph. In graph terms, a new fact or property has been added to the graph. The knowledge graph is thereby enriched with a new predictive insight about the customer.

This update can be reflected in the knowledge graph as an expanded set of properties for that customer's entity. Knowledge graphs can be designed to be flexible in adding properties/edges to entities. Each entity can have many attributes, so writing the predictive output as a new attribute can attach another piece of information to the customer's node. For example, the knowledge graph engine 722 creates new user profile features in the knowledge graph based on user interactions, thereby augmenting the user's profile node with new attributes reflecting their interests or behavior. Similarly, once the prediction is obtained, the system writes that result into the profile in the graph. Accordingly, any application querying the knowledge graph/profile for that customer will now see the new attribute as part of the unified profile. The profile is now “enriched” because it has been transformed from just descriptive data (e.g., what we knew directly) to also predictive data (e.g., inferred insights).

Accordingly, updating a profile and/or knowledge graph can add the model's prediction as a new data point linked to the customer's node. The knowledge graph now contains that predictive output, which can be used like any other property of the customer for search, reasoning, or personalization. This process is how the system learns new things about the customer and immediately makes that knowledge available in the profile. The same can also be true for enriched profiles (e.g., an enriched profile/intelligent data graph can be iteratively updated). For example, a profile can be enriched to become an enriched profile, and that enriched profile can be subsequently updated any number of times.

The machine learning model generation engine 710 is intended to represent an engine that generates, executes, updates, deletes, and/or otherwise modifies machine learning models. Machine learning models can include, for example, neural network models, transformer-based models, generative artificial intelligence models, large language models (LLMs), omnimodal models, convolutional neural network (CNN) models, graph neural network (GNN) models, deep learning models, supervised learning models, unsupervised learning models, random forest models, Bayesian models, and/or the like.

The machine learning model deployment engine 712 is intended to represent an engine that manage, access, obtain, and/or deploy machine learning models. In some embodiments, machine learning model deployment engine 712 can function to obtain and/or deploy different machine learning models based on context and/or specification (e.g., an on-demand deployment to swap out a machine learning model for a different machine learning model based on context. Machine learning models can be stored by the agentic AI orchestration system 608, platform 102, and/or other systems (e.g., third-party systems).

The machine learning model input engine 714 is intended to represent an engine that generates inputs for one or more machine learning models. The machine learning model input engine 1406 may generate the machine learning input data based on (e.g., using) some or all of the data and attributes described herein. For example, machine learning model input engine 714 may generate machine learning input data based on user inputs, system inputs/outputs, segment queries, dynamic attributes, static attributes, and/or the like. More specifically, the machine learning model input engine 714 can identify features from the data and generate feature vectors from that data and the feature vectors can be the inputs for the machine learning models.

In some embodiments, the machine learning model input engine 714 generates prompts (e.g., large language model prompts) for machine learning models (e.g., large language models).

In some embodiments, the machine learning model input engine 714 may normalize data to a standard format (e.g., normalized data format). The standard format may be the data format used by the machine learning models. This can allow the dynamic segmentation system 1012 to obtain data from many different data sources regardless of the original format, allowing the agentic AI orchestration system 608 to operate on the data regardless of any original format.

The secure communication engine 716 is intended to represent an engine that that can generate, execute, update, and/or otherwise manage secure communication layers, access protocols (e.g., role-based access protocols), various protocols and/or servers, such as a Model Context Protocol (MCP) server, and/or the like.

The logging and audit engine 718 is intended to represent an engine that can log and audit some or all actions of AI agents, agent orchestration agents, AI sub-agents, and/or other actions of the multi-tenant platform 102 or agentic AI orchestration system 608. For example, the logging and audit engine 718 can log conversations conducted through the conversational graphical user interface over one or more multiple conversation sessions and across one or multiple tenants of the multi-tenant platform 102.

In some embodiments, the logging and audit engine 718 can function to provide audit logging to protect sensitive data and enable full compliance, thereby reducing the risk of adopting agentic AI at scale.

In some embodiments, the logging and audit engine 718 provides built-in data masking, RBAC, and audit logging protect sensitive data and enable full compliance, thereby reducing the risk of adopting agentic AI at scale.

The interface engine 720 is intended to represent an engine that presents visual, audio, and/or haptic information. In some implementations, the interface engine 720 generates graphical user interface components (e.g., server-side graphical user interface components) that can be rendered as complete graphical user interfaces on various systems (e.g., client systems). The interface engine 720 can function to present an interactive graphical user interface for display and receiving information.

In some embodiments, the interface engine 720 can function to generate and/or otherwise manage a conversational graphical user interface. The conversational graphical user interface can receive, process, output, and transmit natural language inputs (e.g., data stewardship queries) and/or outputs (e.g., LLM responses).

In some embodiments, the interface engine 720 can generate and/or otherwise manage a conversational analytics layer that can integrate an insights layer where agents not only respond but also visualize trends, anomalies, and audit logs directly in the chat interface

In some embodiments, the interface engine 720 may function to send requests, transmit and receive communications, and/or otherwise provide communication with one or more of the systems, engines, devices and/or datastores described herein. In a specific implementation, the interface engine 720 may function to encrypt and decrypt communications. The interface engine 720 may function to send requests to and receive data from one or more systems through a network or a portion of a network. In a specific implementation, the interface engine 720 may send requests and receive data through a connection, all or a portion of which can be a wireless connection. The interface engine 720 may request and receive messages, and/or other communications from associated systems and/or engines. Communications may be stored in the agentic orchestration system AI datastore 730.

The knowledge graph engine 722 is intended to represent an engine that generates, manages (e.g., creates, reads, updates, deletes), deploys, executes, stores, and/or otherwise accesses (e.g., traverses, consumes) knowledge graphs (e.g., knowledge graph 601, 800) and profiles 624. In some embodiments, the platform 102 can represent profiles (e.g., customer profiles) within a knowledge graph (e.g., a single enterprise-wide knowledge graph). For example, a profile can represent, and/or be represented by, as a subset of a knowledge graph. Accordingly, in some embodiments, the knowledge graph engine 722 can generate, manage, and/or access profiles. As used herein, in some embodiments, reference to a knowledge graph may refer to a profile and/or vice versa.

In some embodiments, each profile corresponds to a single unified entity node in the knowledge graph. This node carries all the consolidated attributes about that customer. Reference to an entity node, customer node, and/or node, as used herein, may refer to a unified entity node. An entity's attributes can have multiple contributed values from different sources (e.g., different spellings of a name or multiple phone numbers). The profile can store all these values along with their source identifiers and determines an operational value (OV) for each attribute via survivorship rules. In one implementation, the entity node is stored as a JSON-based object with an attributes section containing all attribute values (e.g., simple text, numbers, dates, and/or, as well as complex nested structures or references). Each attribute may appear as a list of instances (e.g., one per source or occurrence), and the survivorship logic selects the current golden value. Attributes can be of different types, such as simple (e.g., atomic values), nested (e.g., grouped sub-attributes), or reference attributes that link to other entities. For example, a customer's profile might have simple attributes like FirstName/String, and a reference attribute like “PrimaryAddress” that references a Location entity node. The reference attribute can create a relationship to that other entity (and the knowledge graph engine 722 can manage the linkage via an object URI). All attributes can be defined in a schema (e.g., an ontology) for the entity type, which can help ensure consistency across tenants of the multi-tenant platform 102.

In some embodiments, profiles and/or enriched profiles support multi-source lineage. More specifically, every attribute value can be tagged with its source via a crosswalk (e.g., an internal unique identifier tying the data back to the originating system). Profiles can associate each incoming source record with a crosswalk ID. Accordingly, for example, if two records from different systems refer to the same real entity (e.g., the same email or an explicit shared ID), they can share a common crosswalk or be matched as duplicates. The crosswalk system preserves lineage for each attribute value on the profile (e.g., so users can see which source provided which phone number). This can provide a basis for the complex identity resolution and/or entity resolution described herein and can help ensure that the unified profile node contains a full audit of source contributions.

The intelligent data graph engine 724 is intended to represent an engine that generates, manages (e.g., creates, reads, updates, deletes), deploys, executes, stores, and/or otherwise accesses (e.g., traverses, consumes) intelligent data graphs (e.g., intelligent data graph 609, 830, 850, 870) and enriched profiles 626. In some embodiments, the intelligent data graph engine 724 generates intelligent data graphs from one or more knowledge graphs. For example, the intelligent data graph engine 724 can transform a knowledge graph into an intelligent data with a set of additive, governed enrichments (e.g., predictive insights). Accordingly, in some embodiments, the intelligent data graph engine 724 can generate enriched profiles from profiles.

In some embodiments, more specifically, the intelligent data graph engine 724 can start with a unified, governed graph of record (e.g., knowledge graph and/or profile). The base layer can be the identity-resolved, relationship-rich graph that consolidates source data, applies match/merge and survivorship, and retains lineage via crosswalks. This delivers the 360-degree view on which further intelligence can be layered.

More specifically, each real-world entity (e.g., a person, organization, product, and/or the like) can be stored as an entity node in a knowledge graph. A profile can be a 360-degree view of one entity node and its surrounding connections. In other words, a profile can be realized as one node in the larger graph, plus all the directly linked nodes (e.g., related entities like accounts, addresses, family members, transactions, and/or the like) and associated interaction records. Accordingly, in some embodiments, profiles exist in a knowledge graph (and/or enriched profiles exist in an intelligent data graph) where any entity can be connected to any other via relationships. The intelligent data graph engine 724 can scalably manage an infinite number of attributes and relationships among people, organizations, products and places. In some embodiments, each profile node participates in this knowledge graph (and/or intelligent data graph), enabling enterprise-wide queries and insights across all customers and other domains.

The intelligent data graph engine 724 can add unstructured content as first-class, linked objects. In some embodiments, a first-class object is an object in the data model that the system treats as an independent, addressable resource. First-class objects typically (i) possess a globally unique identifier, (ii) have a declared type (e.g., schema), (iii) carry attributes/metadata of their own, (iv) have an independent lifecycle (e.g., they can be created, updated, versioned, or deleted without necessarily creating/updating another object), (v) are subject to governance controls (RBAC, masking, retention), (vi) participate in audit/lineage, and (vii) can be referenced by, and linked to, other objects. In contrast, a non-first-class elements can include an inline field (e.g., an attribute inside another object), a derived view, or a transient value (e.g., a just-in-time score) that lacks an independent identifier/lifecycle and is not directly governed or auditable as its own resource.

Using AI-powered extraction, the intelligent data graph engine 724 can identify entities and relationships from data records (e.g., documents) in various repositories (e.g., S3, Google Drive), then links those extracted elements to existing graph entities, thereby promoting unstructured content into governed graph knowledge. This can, for example, expand the graph's coverage and recency without manual data entry.

The intelligent data graph engine 724 can further incorporate operational signals. For example, beyond static master data, the intelligent data graph engine 724 integrates signals from operational systems (e.g., events, interactions, and/or telemetry pertinent to entities and/or relationships) into the intelligent data graph. These signals can provide temporal and/or behavioral context that a traditional knowledge graph may not capture, thereby enabling time-aware, action-oriented AI.

The intelligent data graph engine 724 can further surface and apply governing metadata as part of the intelligent data graph's context. More specifically, the intelligent data graph engine 724 can surface and apply governing metadata as part of the graph's context. The intelligent data graph can explicitly include metadata (e.g., policy, lineage, quality, and other governance annotations), thereby making that context machine-consumable so AI agents and applications can act within constraints (e.g., masking constraints, role-based access controls (RBAC) constraints, and/or audit constraints) and reason over trust and/or quality signals. Such a metadata dimension of the intelligent data graph can improve computational security, efficiency, performance, accuracy, and predictive capabilities relative to traditional knowledge graphs.

In some embodiments, governing metadata is metadata that controls or conditions access and use of data, such as RBAC roles, attribute-level masking, purpose limitations, retention, allowed uses, and quality descriptors (e.g., completeness, validity, freshness). For example, a masking rule that hides the local part of all email addresses for users without the “Steward” role and/or a data quality (DQ) rule that postal codes must match a particular value or condition.

For example, a DQ rule can be a machine-executable constraint that evaluates one or more data elements (e.g., attributes, entities, relationships, or datasets) against a quality dimension (e.g., validity, completeness, consistency, uniqueness, referential integrity, or timeliness) and returns an enforceable decision (e.g., pass/fail), a severity level, optional fix suggestions, and lineage/audit of the evaluation. In some embodiments, DQ rules are a type of governing metadata surfaced through a governed access interface (e.g., provided by the interface engine 720 and/or intelligent data graph engine 724) and may be applied on read (e.g., mask/filter/warn), on write (e.g., block/route to steward), or during batch/stream processing to contribute to data quality scores.

In some embodiments, the governed access interface is a programmatic interface (e.g., API, gateway, and/or agent server) that enforces governing metadata at request time by authenticating the caller, authorizing by role or purpose, applying masking/filters, and recording audit logs, thereby preventing bypass of policies. For example, requests to read Company X can pass through an API that redacts personally identifiable information (PII) for non-stewards and logs the request/response with policy decisions.

Rule metadata can include, for example, rule ID, version, scope (attribute/entity/edge), condition (when to apply), assertion (what must hold true), dimension, severity, remediation strategy, effective/expiry dates, and lineage (who authored/approved).

The intelligent data graph engine 724 can further enable real-time access patterns that can be used by the AI agents (e.g., as context). More specifically, with a focus on intelligent data operations and zero-copy integrations, the intelligent data graph engine 724 facilitates low-latency, in-place use by downstream AI agents, thereby reducing replication (e.g., reducing computational requirements) while keeping context and governance intact. This operational stance is part of what makes the graph “intelligent” rather than merely descriptive.

The intelligent data graph engine 724 can further expose the intelligent data graph as “knowledge context” for AI agents. More specifically, the intelligent data graph engine 724 (e.g., via a MCP Server) consumes the intelligent data graph as the knowledge context so that autonomous or conversational agents (e.g., the AI agents) take context-aware actions on governed, real-time data, which is one of the defining purposes of the intelligent data graph.

In some embodiments, a knowledge graph is a governed, graph-structured unification of entities and links/relationships that resolves identities across heterogeneous sources and preserves lineage via crosswalk metadata, thereby providing a 360-degree view. In some embodiments, an intelligent data graph is an AI-ready extension of that graph that incorporates (i) objects extracted from unstructured content, (ii) operational signals associated with entities and relationships, and (iii) governing metadata made machine-consumable for policy-compliant reasoning, such that the resulting graph is context-aware, dynamically evolving, and consumable by AI agents (e.g., autonomous/LLM-driven agents) in real-time.

In some embodiments, a knowledge-graph link or knowledge-graph relationship is a persisted, governed, typed edge connecting two entities (e.g., organization, person, address, building). The relationship can be a first-class object with a type drawn from the tenant's model (e.g., contact_of, associated_site, division_of, address_of, related_org), directionality/cardinality (e.g., Organization→Address one-to-one, Organization↔Person one-to-many), edge attributes (e.g., role, status), and governance and lineage (e.g., RBAC scope, masking flags, crosswalk lineage to contributing sources, audit IDs). These relationships are part of the authoritative graph of record and are returned (or updated) only through a governed access interface that enforces policy.

In some embodiments, an IDG link or IDG relationship encompasses all knowledge-graph links above, plus additional contextual and operational edges that make the graph AI-ready. In one embodiment, the intelligent data graph introduces new classes of links, such as document-derived links (e.g., objects promoted from unstructured content into the graph, with confidence/evidence), signal/event links (operational signals attached to entities/relationships with timestamps and payload), metadata/governance links (e.g., explicit bindings of policy, reference data, lineage, and quality to graph elements), and agentic JIT links (e.g., directed, ephemeral outputs from AI agents, such as scores/recommendations, that are not persisted by default and may be committed only after policy checks or human approval). Each IDG link can be typed, may carry direction, edge attributes (e.g., confidence, timestamp, policyDecision, evidenceOffsets), and includes machine-readable provenance for audit/explainability.

In some embodiments, enriched profiles are nodes and/or connections of an intelligent data graph (e.g., a subset of an intelligent data graph). Accordingly, in some embodiments, the intelligent data graph engine 724 can generate, manage, and/or otherwise access enriched profiles. In some embodiments, reference to an intelligent data graph may refer to an enriched profile and/or vice versa.

In addition to entity data and relationships, profiles can incorporate interaction and transaction data as part of the profile and/or associated profile context. Interactions (e.g., purchases, calls, clicks, and/or the like) can be high-volume records, so they can store them while also still linking them to the relevant profile. Each interaction can be modeled as a separate object (e.g., an “interaction” or “activity” entity type) that carries attributes (e.g., date, type, details) and references the involved entities (e.g., customer and product). In the graph, a node may thus be connected to many interaction nodes. Accordingly, a profile's graph neighborhood is not limited to static master data, but can also include time-series events and transactions tied to that customer. This multi-model design allows these interaction records to be stored in a cost-efficient way and “linked in” when needed, providing a holistic view. For example, a profile could pull in their purchase history or support tickets as part of the 360° profile, enabling analytics like calculating recency/frequency or triggering updates to the profile (e.g., such as status changes based on recent activity).

This unified model enables queries and analytics that traverse profile data and interactions together. The graph can answer questions like “find customers who bought Product X in the last month and are connected to at least two other customers in their household.” The engines 722 and/or 724 can dynamically build graphs from entities, relationships, attributes, and interactions on demand, meaning you get the benefits of graph analysis (e.g., shortest paths, influencer detection, etc.) on top of a mastered, clean data foundation. The graph is not a separate copy of the data but an integrated view. For example, the entities provide the nodes, and the stored relationships (and reference attributes) provide the edges.

In some embodiments, the intelligent data graph engine 724 incorporates predictive insights and annotations to augment and/or enrich profiles (e.g., with analytics) to create enriched profiles. The intelligent data graph engine 724 can enrich the profiles with predictive scores and insights (e.g., either by storing the results as additional data on the graph or by calculating them on the fly). Predictive insights (e.g., whether a user will interact with a product, churn scores, lifetime value, product affinities, and/or the like, and/or the like) are often stored as attributes on the profile entity. For example, if a data science model and/or machine learning model predicts a churn risk of 0.8 for a customer, the profile can be updated with a custom attribute like ChurnPropensity=0.8 in the enriched profile. The intelligent data graph engine 724 cam seamlessly add aggregate closed-loop insights back profiles to enrich the profiles in order to power downstream applications. Accordingly, after analytics are executed, the results (e.g., propensity scores, segment codes, recommended next-best action, and/or the like) become part of the node's attribute set, just like any other profile data. Those insight attributes can then be used in queries, segmentation, or displayed to end-users for decision-making (e.g., by querying the intelligent data graph/enriched profile). For instance, a lifetime value score might be stored as a numeric attribute on the node and updated periodically as new transactions arrive.

In some embodiments, insights may be stored as edges or attributes of an intelligent data graph. For example, when an insight pertains to a relationship between entities, it may be modeled differently. If the insight is a property of a customer alone (e.g., churn risk, credit score), an attribute on the profile node is appropriate. However, if an insight connects a customer to another entity (e.g., a product recommendation linking a customer to a product), there are different options. In one approach, the intelligent data graph engine 724 can store recommendations as a list attribute on the profile (e.g., an attribute that holds a list of product IDs or names that are recommended). Another, more graph-oriented approach, is to create a new relationship edge type such as “RecommendedProduct” linking the customer node to product nodes, possibly with a score or rank attribute on that edge to indicate confidence. The data model is flexible enough to support custom relationship types with attributes, so an organization could represent “Customer A is predicted to buy Product B (with probability 90%)” as an edge from A to B with a property score=0.9. This would embed the insight into the intelligent data graph structure itself.

In some embodiments, the intelligent data graph engine 724 automatically writes back predictions (e.g., ephemeral predictions) as permanent relationships in the enriched profile. In other embodiments, the intelligent data graph engine 724 does not automatically write back predictions as permanent relationships without instruction. For example, the context-based data stewardship and prediction 708 can analyze a profile (including their interactions and relationships) and return the top product suggestions with probability scores. These recommendations are delivered to the user or application dynamically and are kept read-only by default-they do not modify the customer or product nodes unless explicitly saved. This design ensures that predictive suggestions can be reviewed or used in context (e.g., shown to a salesperson) without polluting the master data with transient links. If the enterprise chooses, they can promote a recommendation into a real data point (for instance, creating a “InterestedIn” relationship if a customer indeed shows interest in a recommended product). But generally, predictive scores and flags are persisted as profile attributes, while recommendation lists or next-best-action outputs are often handled as calculated views or annotations rather than permanent edges.

Accordingly, in some embodiments, an enriched profile (and the corresponding intelligent data graph) is a multi-entity, multi-relational knowledge graph spanning an enterprise's data. Each profile is a node in this larger graph, enriched with attribute data (e.g., including analytic scores) and linked via relationships to other entities (e.g., accounts, other people, locations, products, and/or the like). The profile is a subgraph of the whole graph (e.g., the 360-degree expression of an entity through all its connections). Relationships can be first-class citizens connecting nodes, and they can carry their own attributes to represent real-world context. Identity resolution can be handled by the context-based data stewardship and prediction 708 by merging duplicates into one node (e.g., using crosswalk identifiers and survivorship rules) so that each node is an authoritative, composite view of one real-world entity. Finally, the intelligent data graph engine 724 can enrich profiles with predictive insights. For example, predictive analytics results (e.g., as generated by the context-based data stewardship and prediction 708) can be fed back by the intelligent data graph engine 724 into the graph as new attributes on profiles and/or as annotated links, which can help ensure that AI-driven insights become part of the intelligent data graph for real-time operational use. Accordingly, the intelligent data graph/enriched profile provides a combination of mastered core data, graph relationships, and embedded analytics within a unified graph structure.

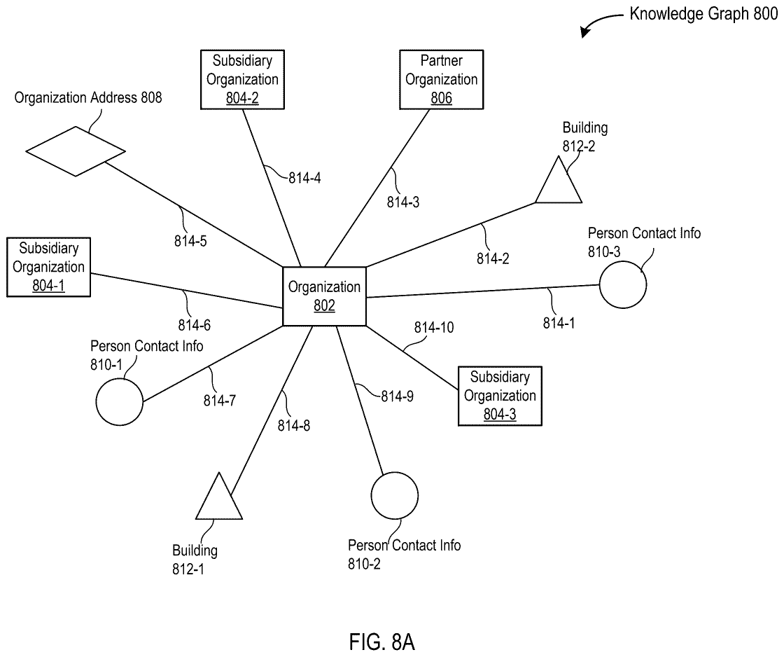

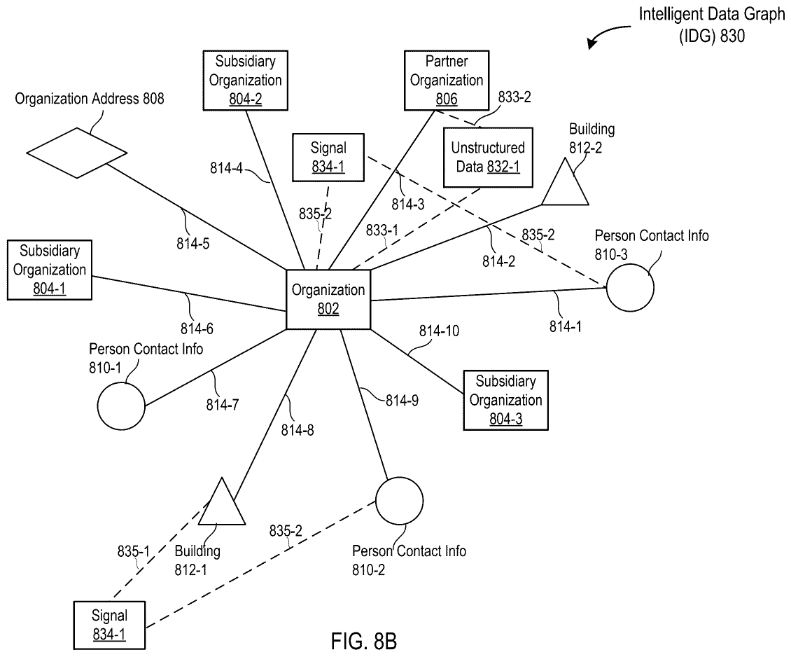

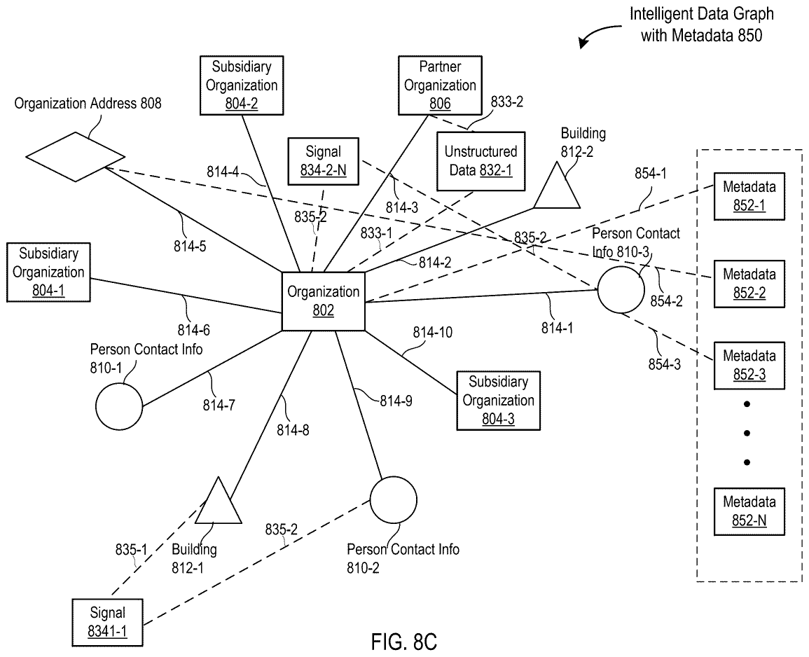

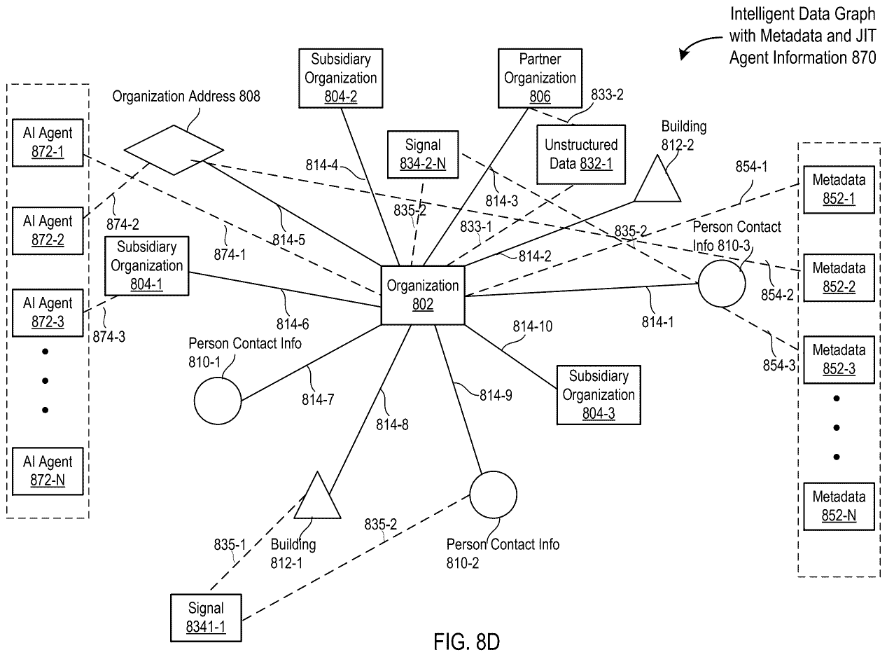

FIG. 8A depicts a diagram of an example knowledge graph 800. This knowledge graph 800 may be an example of the knowledge graph 601 and/or the same as the knowledge graph 601. In the example of FIG. 8A, the knowledge graph includes a hub-and-spoke knowledge graph in which a central organization node 802 is connected to people 810, facilities 812, an address 808, and related organizations 804 and 806. The edges 814 denote base knowledge-graph relationships.

FIG. 8B depicts a diagram of an example intelligent data graph 830. This intelligent data graph 830 may be an example of the intelligent data graph 609 and/or the same as the intelligent data graph 609. In the example of FIG. 8B, the intelligent data graph 830 is constructed from the knowledge graph 800 and additionally includes unstructured content 832, unstructured content links 833, operational signals/events 834, and operational signals/events links 835.

FIG. 8C depicts a diagram of an example intelligent data graph 850 with a metadata dimension. This intelligent data graph 850 may be an example of the intelligent data graph 609 and/or the same as the intelligent data graph 609. In the example of FIG. 8D, the intelligent data graph 850 is constructed from the knowledge graph 800 and further enriches the intelligent data graph 830 to include additional metadata dimension 852 (e.g., governance, lineage, reference data, quality) and metadata links 854. For example, governance metadata bindings/links can include an RBAC policies, PII masking applies to various contacts, match/survivorship rules, and/or the like. Metadata bindings854 can be machine-interpretable and enforced by the system 608, thereby enabling policy-aware queries and explainable AI agent actions.

FIG. 8D depicts a diagram of an example intelligent data graph 870 with a metadata dimension and just-in-time agent information. This intelligent data graph 830 may be an example of the intelligent data graph 609 and/or the same as the intelligent data graph 609. This intelligent data graph 850 may be an example of the intelligent data graph 609 and/or the same as the intelligent data graph 609. In the example of FIG. 8D, the intelligent data graph 870 is constructed from the knowledge graph 800 and further enriches the intelligent data graphs 830, 850 to include just-in-time AI agents 872 whose outputs 874 are computed at runtime. The AI agents can include, for example, a resolver agent, an address enricher, and a work assigner. The just-in-time outputs 874 can include duplicate risk scores, address normalization, escalations recommendations, and/or the like.

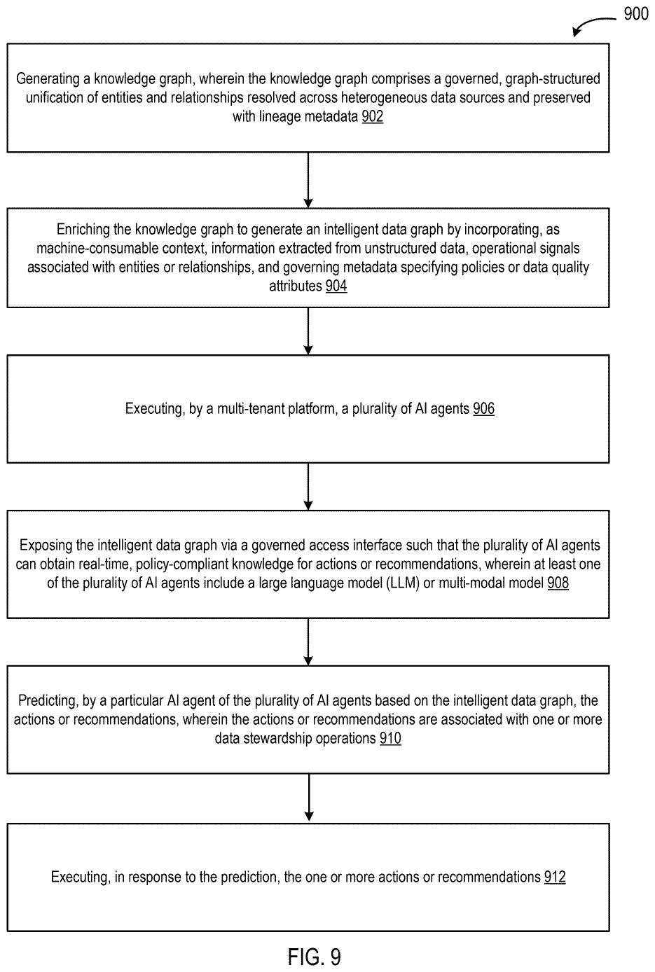

FIG. 9 depicts a flowchart 900 of an example method of agentic AI orchestration using an intelligent data graph. In this and other flowcharts, flow diagrams, and/or sequence diagrams, the flowchart illustrates by way of example a sequence of modules (or, steps). It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 902, a computing system (e.g., multi-tenant platform 102 102 and/or agentic AI orchestration system 608 of the multi-tenant platform 102) generates a knowledge graph (e.g., knowledge graph 601, 800). The knowledge graph can be a governed, graph-structured unification of entities and relationships resolved across heterogeneous data sources and preserved with lineage metadata. In some embodiments, lineage metadata can refer to machine-readable provenance information that traces a datum (e.g., an attribute value, node, or edge) to one or more sources and/or transformations, such as source system name, record identifier, collection time, transformation steps, and approval/audit identifiers, and/or the like. In one example, a company's phone number on a golden profile carries lineage indicating it was taken from CRM.Contact #12345 on 2025 Jan. 14, normalized by the phone-parser v3.2, and steward-approved by user: jsmith at 2025-01-15T09:23Z.

In some embodiments, a knowledge graph engine (e.g., knowledge graph engine 722) generates (e.g., constructs) the knowledge graph.

In module 904, the computing system enriches, augments, and/or transforms the knowledge graph to generate (e.g., construct) an intelligent data graph (e.g., intelligent data graph 609, 803, 850, 870) by incorporating, as machine-consumable context, information extracted from unstructured data, operational signals associated with entities or relationships, and governing metadata specifying policies or data quality attributes. In some embodiments, operational signals are time-stamped events or measurements that can be linked to a graph entity or relationship and reflect behavior or system activity relevant to that element. For example, a web-visit event at 2025-10-01T12:00Z can be associated with Contact A and Company X; and an IoT temperature reading from a building sensor at 2025-10-01T12:05Z can be linked to Building A.

In some embodiments, governing metadata is metadata that controls or conditions access and use of data, such as RBAC roles, attribute-level masking, purpose limitations, retention, allowed uses, and quality descriptors (e.g., completeness, validity, freshness). For example, a masking rule that hides the local part of all email addresses for users without the “Steward” role and/or a data quality (DQ) rule that postal codes must match a particular value or condition.

In some embodiments, an intelligent data graph engine (e.g., intelligent data graph engine 724) enriches, augments, and/or transforms the knowledge graph.

In module 906, the computing system executes a plurality of AI agents (e.g., AI agents 612-614). In some embodiments, an AI agent engine (e.g., AI agent engine 706) executes the AI agents.

In module 908, the computing system exposes the intelligent data graph via a governed access interface such that the plurality of AI agents can obtain real-time, policy-compliant knowledge for actions or recommendations. At least one of the plurality of AI agents includes one or more large language models (LLMs) and/or one or more multi-modal models. In some embodiments, the computing system provides some or all of the intelligent data graph as context of a machine learning model prompt (e.g., LLM prompt) to the one or more of the AI agents. In some embodiments, an interface engine (e.g., interface engine 720) and/or the intelligent data graph engine exposes the intelligent data graph and/or provides the context to the AI agents.

In module 910, the computing system predicts, by a particular AI agent of the plurality of AI agents based on the intelligent data graph, the actions or recommendations. For example, the context provided by the intelligent data graph may enable and/or improve predictive performance of the computing system. The actions or recommendations may be one or more data stewardship operations and/or associated with one or more data stewardship operations. In some embodiments, a context-based data stewardship and prediction (e.g., context-based data stewardship and prediction 708) uses (e.g., traverses) the intelligent data graph to perform the prediction.

In module 912, the computing system executes, in response to the prediction, the one or more actions or recommendations. In some embodiments, the context-based data stewardship and prediction executes the one or more actions or recommendations.

In some embodiments, the governed access interface comprises APIs that enforce policy-aware filtering and audit logging such that AI agent requests and responses comply with RBAC, masking, and lineage constraints. Lineage constraints can include policy conditions that restrict mutation or acceptance of values based on provenance (e.g., allowed sources, mandatory crosswalks, approval requirements). For example, only values originating from “Steward” or “Trusted-Provider” may overwrite operational attributes; all persisted changes must retain at least one crosswalk to an authoritative source.

In some embodiments, the computing system provides real-time, zero-copy access that serves the intelligent data graph without replication by streaming changes from operational sources and applying enrichment updates incrementally. As used herein, real-time, zero-copy access can indicate a data-access pattern in which the system retrieves and/or computes results directly from the intelligent data graph, and within operational latency bounds, while avoiding material replication (e.g., bulk ETL or staging copies) solely to satisfy a read or agent request. “Real-time” can indicate that results incorporate the current committed state with end-to-end latency suitable for interactive or transactional use. “Zero-copy” allows ephemeral artifacts (e.g., short-lived caches, query plans, indexes, or streamed projections) that are transient, governed, and expirable, but excludes persistent duplication of the underlying datasets for query serving. All accesses can occur through the governed access interface that authenticates, authorizes, masks, filters, and audits requests and enforces governing metadata (e.g., consent, purpose-of-use, lineage constraints).

In some embodiments, the computing system exposes tool or function schemas describing permitted graph operations and required inputs/outputs, wherein AI agents plan actions using the schemas as constraints. In some embodiments, the tool or function schemas constrain AI agent operations to idempotent reads or pre-authorized write actions and specify field-level masking obligations. Idempotent reads can include read operations that produce the same result when repeated and cause no side effects on the graph or policies.

In some embodiments, the computing system performs just in time (JIT) inference in which the at least one AI agent of the plurality of AI agents computes ephemeral scores or recommendations over the intelligent data graph that are not persisted by default and are committed only upon satisfaction of policy checks or human approval. Just-in-time can include computation of a score, prediction, or recommendation at request time, using the current graph context, without persisting the result unless later approved. For example, a duplicate risk score can be computed when a record is viewed, and is not stored.

In some embodiments, ephemeral scores or recommendations can include JIT outputs that are temporary artifacts presented to a client or workflow and persisted (e.g., as attributes/edges or tasks) only if (i) policy gates are satisfied (e.g., role/purpose/threshold), and/or (ii) a steward approves the change. For example, an address-normalization suggestion is shown to a steward; upon approval, the normalized address replaces the prior value, with lineage referencing the AI agent and approval event.

In some embodiments, the committing creates proposed graph mutations as reviewable tasks for a data steward, and upon approval, the system updates the intelligent data graph and back propagates updates to the knowledge graph and lineage.

In some embodiments, audit logging records the identity of the requesting agent, the policy decisions applied, and the graph elements accessed or modified, to provide explainability of autonomous actions.

In some embodiments, the computing system provides incremental updates that propagate via a message bus and are applied as graph deltas that atomically update entities, relationships, and attached metadata.

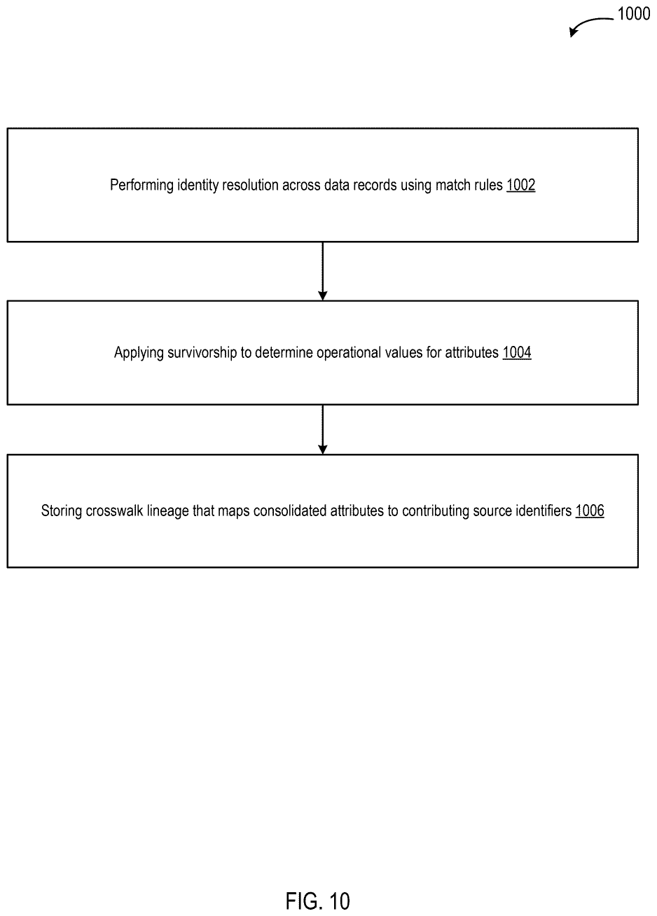

FIG. 10 depicts a flowchart 1000 of an example method of knowledge graph generation. In this and other flowcharts, flow diagrams, and/or sequence diagrams, the flowchart illustrates by way of example a sequence of modules (or, steps). It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1002, a computing system (e.g., multi-tenant platform 102 102 and/or agentic AI orchestration system 608 of the multi-tenant platform 102) performs identity resolution across data records using match rules. In some embodiments, a knowledge graph engine (e.g., knowledge graph engine 722) performs the identity resolution.

In module 1004, the computing system applies survivorship (e.g., survivorship rules) to determine operational values for attributes. The operational value (e.g., the survivor or golden value) is the current authoritative value selected for an attribute after applying match/survivorship rules/logic/ML over multiple candidate values. For example, for email, the system can prefer CRM over ERP, and the chosen operational value can be contact.a@example.com. In some embodiments, the knowledge graph engine applies survivorship to determine operational values for attributes.

In module 1006, the computing system stores crosswalk lineage that maps consolidated attributes to contributing source identifiers. Crosswalk lineage can indicate the mapping objects that link a consolidated entity or attribute to each contributing source record (e.g., source system plus record ID), optionally including value-level references. Consolidated attributes can be attributes on a unified (e.g., golden) entity that have been computed or selected from multiple source values and/or enriched values. For example, a consolidated address composed of the street from “Lease_2025.pdf,” the postal code from ERP, and the country code from reference data. Contributing source identifiers can be identifiers (e.g., system name plus record key, and optionally field path) of each source that supplied a value considered during consolidation.

In some embodiments, the knowledge graph engine and/or a management engine (e.g., management engine 702) stores the crosswalk lineage.

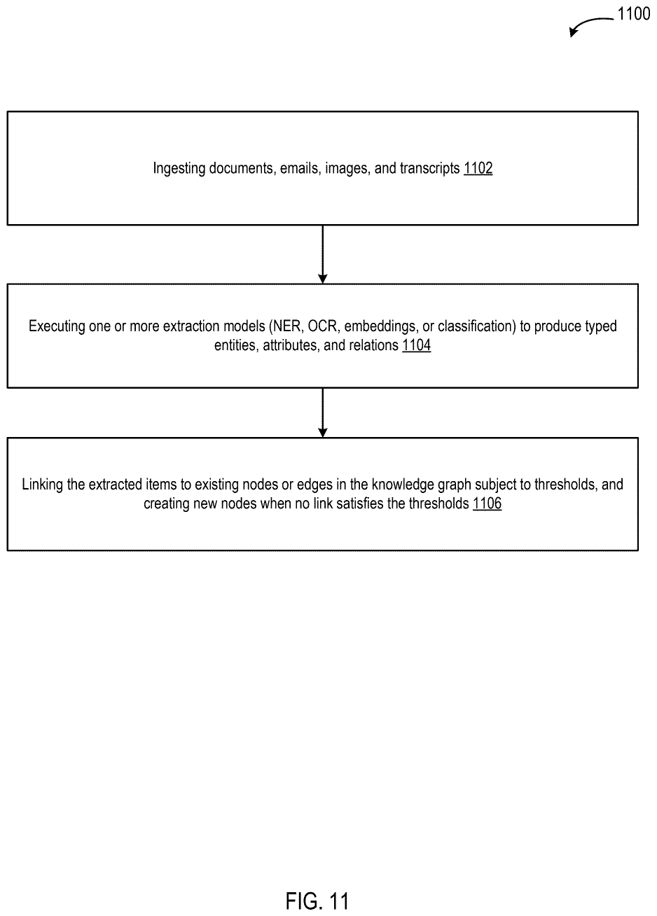

FIG. 11 depicts a flowchart 1100 of an example method of enriching a knowledge graph with unstructured-content promotion to generate an intelligent data graph. In some embodiments, unstructured-content promotion is a process that extracts typed objects (e.g., entities, attributes, relations) from unstructured artifacts (e.g., documents, emails, images, logs) and promotes those objects into the graph as first-class, governed nodes/edges linked back to the artifact.

In this and other flowcharts, flow diagrams, and/or sequence diagrams, the flowchart illustrates by way of example a sequence of modules (or, steps). It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1102, a computing system (e.g., multi-tenant platform 102 102 and/or agentic AI orchestration system 608 of the multi-tenant platform 102) ingests documents, emails, images, and transcripts. In some embodiments, an intelligent data graph engine (e.g., intelligent data graph engine 724) ingests the documents, emails, images, and transcripts.

In module 1104, the computing system executes one or more extraction models (e.g., NER, OCR, embeddings, or classification) to produce typed entities, attributes, and relations. In some embodiments, the intelligent data graph engine executes the one or more extraction models.

In module 1106, the computing system links the extracted items to existing nodes or edges in the knowledge graph subject to thresholds, and creates new nodes when no link satisfies the thresholds. In some embodiments, the intelligent data graph engine performs the linking.

In some embodiments, the linking weights candidate links by a combination of textual similarity, structural consistency with the graph ontology, and source trust, and resolves ties using survivorship priorities. In some embodiments, weighting candidate links is the process of assigning numerical scores to potential links (e.g., document-to-entity and/or entity-to-entity) using features such as text similarity, ontology constraints, geographic proximity, and/or source trust, for later thresholding or ranking.

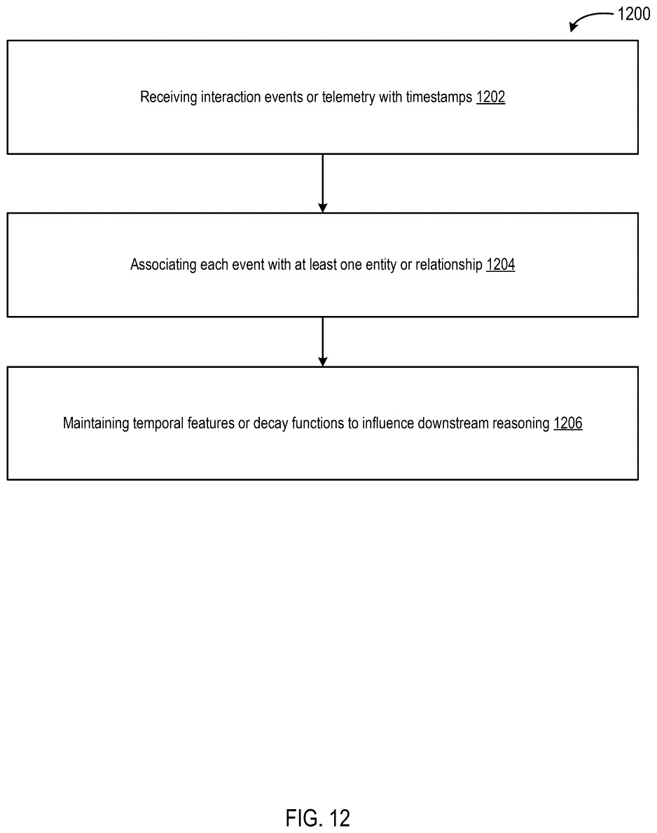

FIG. 12 depicts a flowchart 1200 of an example method of enriching a knowledge graph with signal integration to generate an intelligent data graph. In this and other flowcharts, flow diagrams, and/or sequence diagrams, the flowchart illustrates by way of example a sequence of modules (or, steps). It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1202, a computing system (e.g., multi-tenant platform 102 102 and/or agentic AI orchestration system 608 of the multi-tenant platform 102) receives interaction events or telemetry with timestamps. These can include observable events or measurements that include event time, actor, channel, and/or payload, suitable for linkage to graph elements. In some embodiments, an intelligent data graph engine (e.g., intelligent data graph engine 724) receives the information.

In module 1204, the computing system associates each event with at least one entity or relationship. In some embodiments, the intelligent data graph engine performs the associating.

In module 1206, the computing system maintains temporal features and/or decay functions to influence downstream reasoning. Temporal features can include features computed from a time series of signals to capture recency, frequency, trend, and/or periodicity for use by models (e.g., machine learning models) and/or rules (e.g., match rules). As used herein, downstream reasoning can include any automated or semi-automated decisioning that consumes the intelligent data graph (e.g., rule evaluation, ranking, planning, or agentic action selection). For example, an AI agent (e.g., AI agent 612-614) uses (e.g., traverses) an intelligent data graph (e.g., intelligent data graph 609, 830, 850, 870) to recommend a data stewardship operation (e.g., escalation, merge) when duplicate risk >0.8 and DQ score <85.

In some embodiments, the operational signals include customer web visits, application usage, and support tickets, and the method maintains per-entity timelines queryable for recency, frequency, and/or momentum.

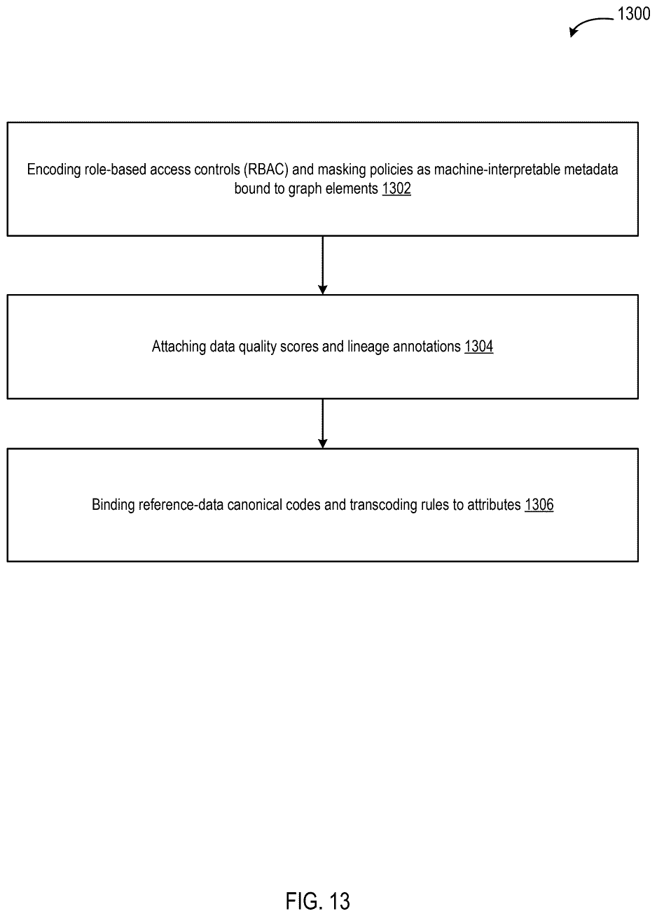

FIG. 13 depicts a flowchart 1300 of an example method of enriching a knowledge graph with governance surfacing to generate an intelligent data graph. As used herein, governance surfacing can be making governance information explicitly visible and machine-consumable at the points where data are accessed or acted upon. Governance surfacing can include (i) exposing governing metadata (e.g., RBAC entitlements, masking obligations, retention rules, lineage requirements, survivorship policies, and/or quality thresholds) together with the returned data (e.g., as annotations, headers, or sidecar payloads); (ii) enforcing those policies in band (e.g., masking or filtering before delivery); and/or (iii) publishing policy decisions/explanations so user interfaces and AI agents can render why a field is hidden or an action is disallowed.

In this and other flowcharts, flow diagrams, and/or sequence diagrams, the flowchart illustrates by way of example a sequence of modules (or, steps). It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1302, a computing system (e.g., multi-tenant platform 102 102 and/or agentic AI orchestration system 608 of the multi-tenant platform 102) encodes role-based access controls (RBAC) and masking policies as machine-interpretable metadata bound to graph elements. In some embodiments, an intelligent data graph engine (e.g., intelligent data graph engine 724) performs the encoding (e.g., on graph elements of a knowledge during transformation to an intelligent data graph).

In module 1304, the computing system attaches data quality scores and lineage annotations. Data quality scores can be quantitative measures (e.g., 0-1 or 0-100) computed over one or more DQ dimensions (e.g., completeness, validity, consistency, uniqueness, freshness) for an attribute or entity. For example, Company X has DQ-92 based on 100% completeness of core fields and no conflicting addresses in the last 90 days. Lineage annotations can include attached records on nodes/edges/attributes that document provenance events (e.g., source, transform, steward approval, timestamps) for audit/explainability. For example, the address attribute can include an annotation “Derived from Lease_2025.pdf via extraction model v1.4 on 2025 Apr. 21; steward approval user:mbrown.” In some embodiments, the intelligent data graph engine determines and/or attaches the data quality scores and lineage annotations.

For example, the computing system can attach data quality scores and/or lineage annotations to graph element(s) (e.g., of a knowledge graph and/or intelligent data graph) whose trustworthiness and provenance the system governs. The graph elements can include, for example, Entity (node) level (e.g., an Organization, Person, Building, or Address), Relationship (edge) level (e.g., associated_site, contact_of, address_of, or any document- or signal-derived link), Attribute/attribute-value level—e.g., the operational value of email, taxId, or Address.postalCode, or the individual candidate values considered during survivorship, promoted artifacts (e.g., nodes or links introduced by the intelligent data graph such as unstructured document nodes and their extracted-object links, and/or signal/event nodes).

In module 1306, the computing system binds reference-data canonical codes and transcoding rules to attributes. These can be a controlled vocabulary of canonical codes plus mapping rules that normalize heterogeneous source values into standard representations used by attributes. For example, country values “United States”, “USA”, “US” map to ISO-3166 code US; state “California” maps to CA; attributes can persist the canonical code and/or the display label. In some embodiments, the intelligent data graph engine performs the binding.

In some embodiments, data quality includes completeness, validity, consistency, and/or deduplication metrics and the governed interface uses the metrics to filter, rank, and/or explain AI agent results.

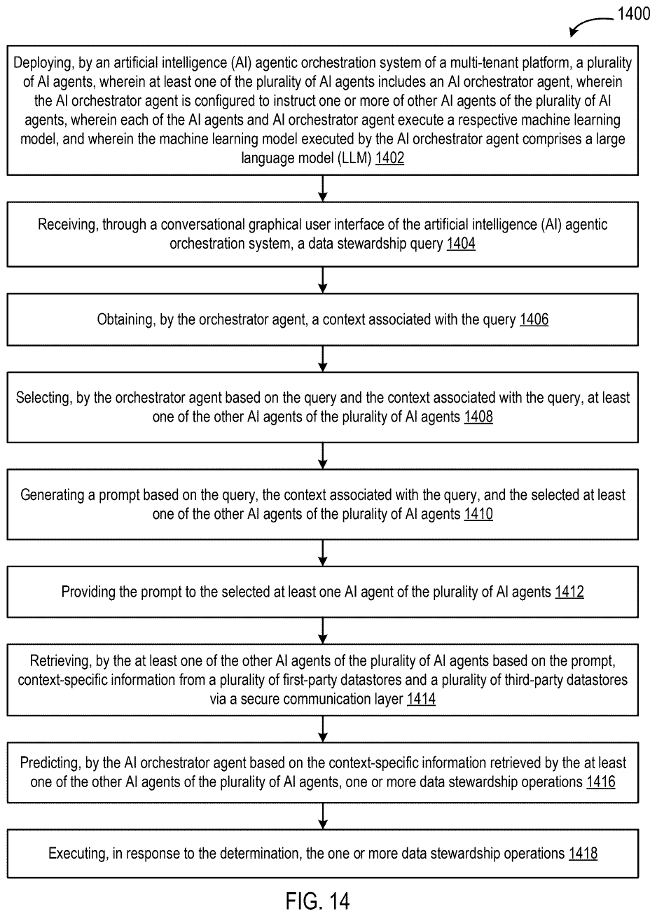

FIG. 14 depicts a flowchart 1400 of an example method of agentic AI orchestration. In this and other flowcharts, flow diagrams, and/or sequence diagrams, the flowchart illustrates by way of example a sequence of modules (or, steps). It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1402, a computing system (e.g., agentic AI orchestration system 608 of a multi-tenant platform 102) deploys a plurality of AI agents (e.g., agent orchestration agents 610, AI agents 612, AI sub-agents 613). At least one of the plurality of AI agents can include an AI orchestrator agent (e.g., agent orchestration agent 610) configured to instruct (or, manage) one or more of other AI agents of the plurality of AI agents (e.g., AI agents 612-1 to 612-N). Each of the AI agents and the AI orchestrator agent execute a respective machine learning model (e.g., respective LLM). The machine learning model executed by the AI orchestrator agent can include a large language model (LLM). In some embodiments, an AI agent engine (e.g., AI agent engine 706) deploys and/or executes the AI agents.

In module 1404, the computing system receives, through a conversational graphical user interface of the artificial intelligence (AI) agentic orchestration system, a data stewardship query (e.g., entity resolution request, merge request, etc.). In some embodiments, an interface engine (e.g., interface engine 720) generates the conversational graphical user interface. The conversational graphical user interface can be configured to receive and output natural language inputs, queries, outputs, etc. The data stewardship query can be a natural language query (e.g., created by a user and/or system).

In module 1406, the computing system obtains, by the orchestrator agent, a context associated with the data stewardship query. The context can include a conversation history received through the conversational graphical user interface over one session (e.g., a current sessions) and/or more sessions (e.g., one or more previous sessions).

In module 1408, the computing system selects, by the orchestrator agent based on the data stewardship query and the context associated with the data stewardship query, at least one of the other AI agents of the plurality of AI agents.

In module 1410, the computing system generates a prompt (e.g., LLM prompt) based on the data stewardship query, the context associated with the data stewardship query, and the selected at least one of the other AI agents of the plurality of AI agents. In some embodiments, machine learning model input engine (e.g., machine learning model input engine 714) generates the prompt. For example, the AI agent orchestration engine may cooperate (e.g., call) the machine learning model input engine to generate the prompt and return it to the agent orchestration agent.

In module 1412, the computing system provides the prompt to the selected at least one AI agent of the plurality of AI agents. In some embodiments, the agent orchestration agent provides the prompt.

In module 1414, the computing system retrieves, by the at least one of the other AI agents of the plurality of AI agents based on the prompt, context-specific information from a plurality of first-party datastores (e.g., datastore of one or more tenants of the multi-tenant platform 102, agentic AI orchestration system datastore 730) and a plurality of third-party datastores (third-party systems 606) via a secure communication layer (e.g., secure communication layer 614). The secure communication layer 614 may be generated and/or managed by a secure communication engine (e.g., secure communication engine 716).

In module 1416, the computing system predicts, by the AI orchestrator agent based on the context-specific information retrieved by the at least one of the other AI agents of the plurality of AI agents, one or more data stewardship operations. In some embodiments, a context-based data stewardship and prediction (e.g., context-based data stewardship and prediction 708) performs the prediction. For example, the AI agent orchestration engine can cooperate (e.g., call) the context-based data stewardship and prediction to perform the prediction and obtain the result therefrom.

In module 1418, the computing system executes, in response to the determination, the one or more data stewardship operations. In some embodiments, the multi-tenant platform 102 may perform the execution. In a specific implementation, the AI agent orchestration engine and/or context-based data stewardship and prediction perform the execution. For example, the context-based data stewardship and prediction may hook into the native capabilities of the multi-tenant platform to execute the one or more data stewardship operations.

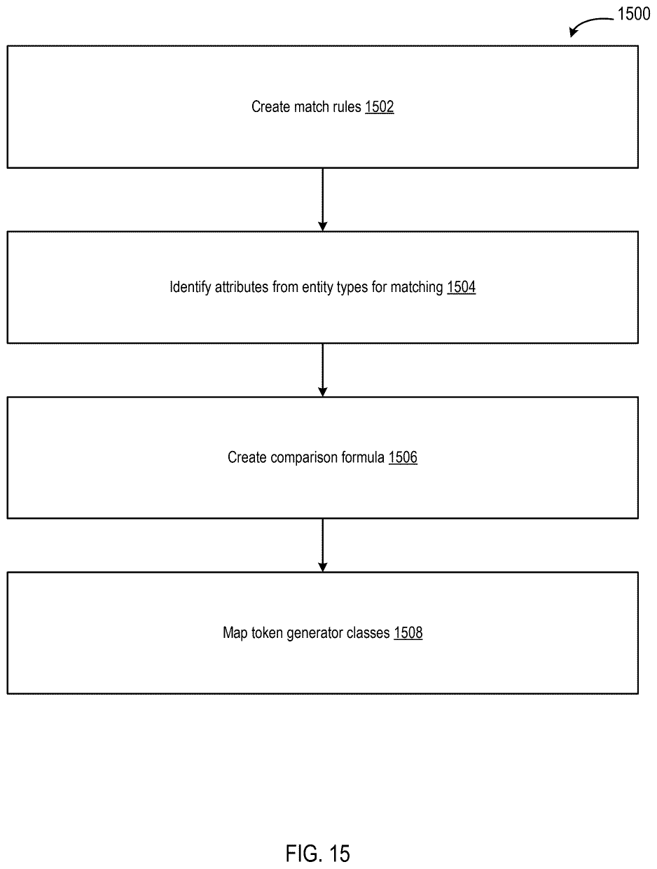

FIG. 15 depicts a dynamic matching facilitation flowchart 1500. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

The match architecture is responsible for identifying profiles within the tenant that are considered to be semantically the same or similar. A user may establish a match scheme using the match configuration framework. In some embodiments, the user may utilize machine learning techniques to match profiles. In step 1502, the user may create match rules. In step 1504, the user may identify the attributes from entity types they wish to use for matching. In step 1506, the user may write a comparison formula within each match rule which is responsible for doing the actual work of comparing one profile to another. In step 1508, the user may map token generator classes that will be responsible for creating match candidates.

Unlike other systems, in various embodiments, the architecture is designed to operate in real-time. Prior to the match process and merge processes occurring, every profile created or updated is may be cleansed on-the-fly by the profile-level cleansers. Thus, the 3-step sequence of cleanse, match, merge may be designed to all occur in real-time anytime a profile is created or updated. This behavior makes the platform 102 ideal for real-time operational use within a customer's ecosystem.

Lastly, the survivorship architecture is responsible for creating the classic “golden record”, but in a specific implementation, it is a view, materialized on-the-fly. It is returned to any API call fetching the profile and contains a set of “Operational Values” from the profile, which are selected in real-time based on survivorship rules defined for the entity type.

In various embodiments, matching may operate continuously and in real-time. For example, when a user creates or updates a record in the tenant, the platform cleanses and processes the record to find matches within the existing set of records.

Each entity type (e.g., contact, organization, product) may have its own set of match groups. In some embodiments, each match group holds a single rule along with other properties that dictate the behavior of the rule within that group. Comparison Operators (e.g., Exact, ExactOrNull, and Fuzzy) and attributes may comprise a single rule.

Match tokens may be utilized to help the match engine quickly find candidate match values. A comparison formula within a match rule may be used to adjudicate a candidate match pair and will evaluate to true or false (or a score if matching is based on relevance).

In some embodiments, the matching function may do one of three things with a pair of records: Nothing (if the comparison formula determines that there is no match); Issue a directive to merge the pair; Issue a directive to queue the pair for review by a data steward. In some embodiments, the architecture may include the following:
1) Entities and relationships each have configurable attribution capability.
2) Values found in an attribute are associated with a crosswalk held within an entity or relationship object. Each profile can have multiple crosswalks, each contributing one or more values. Data may come from multiple sources. Each source may be registered, and all data loaded into a tenant will be associated with a data source. Each supplied attribute may be associated with data provider crosswalks. Crosswalks are analogous to the Primary Key or Unique Identifier in relational database management system (RDBMS). A crosswalk can represent a data provider or a non-data provider.
3) Data providers supply attribute values for an object and the attributes are associated with the crosswalk.
4) Non-data providers are associated with an overall entity (or relationship). In this case it is simply used to link a Reltio object with an object in another system. Supplied attributes may NOT be associated with this crosswalk.
5) Profiles can be matched and merged, but relationships are also matched and merged. While the user may develop match rules to govern the matching and merging of profiles, merging of relationships is automatic and intrinsic to the platform. Any two relationships of the same type, that each have entity A at one endpoint and entity B at their other endpoint, will merge automatically.
6) An attribute is intrinsically multi-valued, meaning it can hold multiple values. This means any attribute can collect and store multiple values from contributing sources or through merging of additional crosswalks. Thus, if a match rule utilizes the first name attribute, then the match engine will by default, compare all values held within the first name attribute of record A to all values held within the first name attribute of record B, looking for matches among the values. The user may elect to only match on operational values if desired.
7) When two profiles merge, the resulting profile contains the aggregate of all the crosswalks of the two contributing profiles and thus the associated attributes and values from those crosswalks. The arrays behind the attributes naturally merge as well, producing for each attribute an array that holds the aggregation of all the values from the contributing attributes. Relationships benefit from the same architecture and behave in the same manner as described for merged entities. The surviving entity ID (or relationship ID) for the merged profile (or relationship) is that of the oldest of the two contributors.
8) When two profiles merge the resulting profile contains references to all the interactions that were previously associated with the contributing profiles. (Note that Interactions do not reference relationships.)
9) If profile B is unmerged from the previous merge of A and B, then B will be reinstated with its original entity ID. All of the attributes (and associated values), relationships, and interactions profile B brought into the merged profile will be removed from the merged profile and returned to profile B.

The matchGroups construct is a collection of match groups with rules and operators that are needed for proper matching. If the user needs to enable matching for a specific entity type in a tenant, then the user may include the matchGroups section within the definition of the entity type in the metadata configuration of the tenant. The matchGroups section will contain one or more match groups, each containing a single rule and other elements that support the rule.

Looking at a match group in a JSON editor, the user can easily see the high-level, classic elements within it. The rule may define a Boolean formula (see the AND operator that anchors the Boolean formula in this example) for evaluating the similarity of a pair of profiles given to the match group for evaluation. It is also within the rule element that four other very common elements may be held: ignoreInToken (optional), Cleanse (optional), matchTokenClasses (required), and comparatorClasses (required). The remaining elements that are visible (URI, label, and so on), and some not shown in the snapshot, surround the rule and provide additional declarations that affect the behavior of the group and in essence, the rule.

Each match group may be designated to be one of four types: automatic, suspect, <custom>, and relevance_based described below. The type the user selects may govern whether the user develops a Boolean expression for the comparison rule or an arithmetic expression. The types are described below.

Behavior of the automatic type: With this setting for type, the comparison formula is purely Boolean and if it evaluates to TRUE, the match group will issue a directive of merge which, unless overridden through precedence, will cause the candidate pair to merge.

Behavior of the suspect type: With this setting for type, the comparison formula is purely Boolean and if it evaluates to TRUE, the match group will issue a directive of queue for review which, unless overridden through precedence, will cause the candidate pair to appear in the “Potential Matches View” of the MDM UI.

Behavior of the relevance_based type: Unlike the preceding rules, all of which are based on a Boolean construction of the rule formula, the relevance-based type expects the user to define an arithmetic scoring algorithm. The range of the match score determines whether to merge records automatically or create potential matches.

If a negativeRule exists in the matchGroups and it evaluates to true, any merge directives from the other rules are demoted to queue for review. Thus, in that circumstance, no automatic merges will occur. The Scope parameter of a match group defines whether the rule should be used for Internal Matching or External Matching or both. External matching occurs in a non-invasive manner and the results of the match job are written to an output file for the user to review. Values for Scope are: ALL-Match group is enabled for internal and external matching (Default setting). NONE-Matching is disabled for the match group. INTERNAL-Match group is enabled for matching records within the tenant only. EXTERNAL-Match group is enabled only for matching of records from an external file to records within the tenant; in a specific implementation, external matching is supported programmatically via an External Match API and available through an External Match Application found within a console, such as a RELTIO™ Console.

If set to true, then only the OV of each attribute will be used for tokenization and for comparisons. For example, if the First Name attribute contains “Bill”, “William”, “Billy”, but “William” is the OV, then only “William” will be considered by the cleanse, token, and comparator classes.

The rule is the primary component within the match group. It contains the following key elements each described in n detail: IgnoreInToken, Cleanse, match TokenClasses, comparatorClasses, Comparison formula.

A negative rule allows a user to prevent any other rule from merging records. A match group can have a rule or a negative rule. The negative rule has the same architecture as a rule but has the special behavior that if it evaluates to true, it will demote any directive of merge coming from another match group to queue for review. To be sure, most match groups across most customers' configurations use a rule for most matching goals. But in some situations, it can be advantageous to additionally dedicate one or more match groups to supporting a negative rule for the purpose of stopping a merge based on usually a single condition. And when the condition is met, the negative rule prevents any other rule from merging the records. So in practice, the user might have seven match groups each of which use a rule, while the eighth group uses a negative rule.

The platform 102 may include a mechanism to proactively monitor match rules in tenants across all environments. In some embodiments, after data is loaded into the tenant, the proactive monitoring system inspects every rule in the tenant over a period of time and the findings are recorded. Based on the percentage of entities failing the inspections, the proactive monitoring system detects and bypasses match rules that might cause performance issues and the client may be will be notified. The bypassed match rules will not participate in the matching process.

In various embodiments, the user receives a notification when the proactive monitoring system detects a match rule that needs review. ScoreStandalone and scoreIncremental elements may be used to calculate a Match Score for a profile that is designated as a potential match and can assist a data steward when reviewing potential matches.

Relevance-based matching is designed primarily as a replacement of the strategy that uses automatic and suspect rule types. With Relevance-based matching, the client may create a scoring algorithm of the user's own design. The advantage is that in most cases, a strategy based on Relevance-based matching can reduce the complexity and overall number of rules. The reason for this is that the two directives of merge and queue for review which normally require separate rules (automatic and suspect respectively) can often be represented by a single Relevance-Based rule.

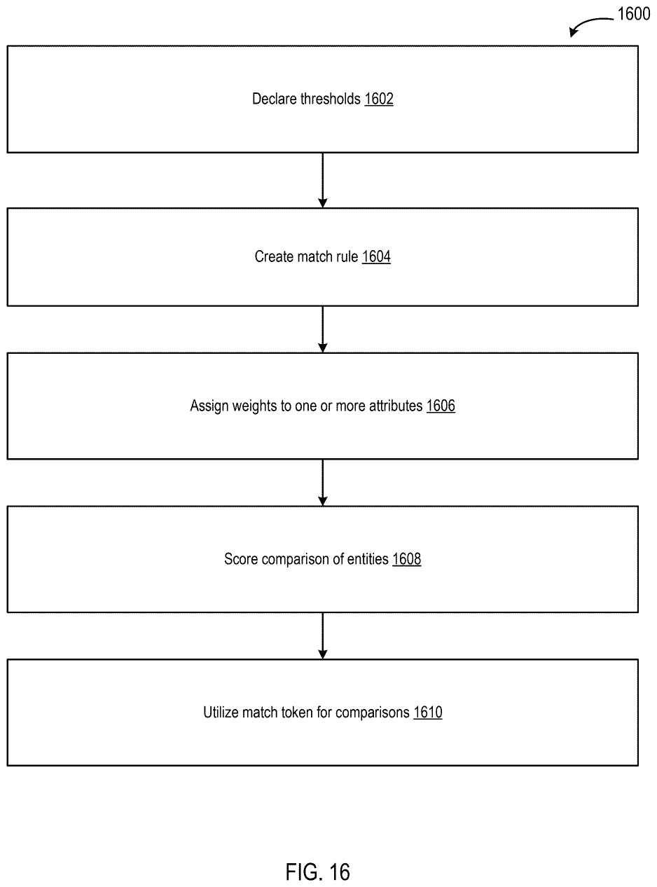

FIG. 16 depicts a dynamic matching flowchart 1600. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 1602, thresholds may be defined. For example, when declaring the ranges for queue_for_review and auto_merge, the combination should span the entire available range of 0.0 to 1.0 with no gap and no overlap except that the upper endpoint for queue_for_review should equal the lower endpoint for auto_merge thus have a common touchpoint between them (for example, 0.0 to 0.6 for queue_for_review, and 0.6 to 1.0 for auto_merge). If the actionThresholds leave a gap, then any score falling within the gap will produce no action. Conversely, if the actionThresholds overlap (for example, 0.4 to 0.6 for queue_for_review, and 0.5 to 0.7 for auto_merge) and a score lands within the intersection (0.55 in our example) or on the touchpoint, the directive of queue_for_review takes precedence.

In step 1604, match rules are created. Using Relevance-based matching, the client could create a match rule that contains a collection of attributes to test as a group.

In step 1606, weights may be assigned to attributes to govern their relative importance in the rule. Weights can be set from 0.0 to 1.0. If the client does not explicitly set a weight for an attribute, it may receive a default weight of 1.0 during execution of the rule. For example, starting with all weights equal to 1.0 and perhaps start with actionThresholds of 0.0-0.5 for queue_for_review and 0.5-1.0 for auto_merge. Do some trial runs and examine the results. If too many obvious matches are being set to queue_for_review, then weights may be adjusted and the action Thresholds modified (e.g., to perhaps 0.0-0.7, and 0.7-1.0). The user may iterate and experiment until able to get optimized results with the data set.

In step 1608, score comparison of entities is performed. In step 1610, the relevance_based match rules use the match token classes in the same way as they are used in suspect and automatic match rules. However, the comparison of the two entities works differently. Every comparator class provides relevance value while comparing values. The relevance is in the range of 0 to 1. For example, BasicStringComparator returns 0 if two values are different. It returns 1 if two values are the identical. Fractional values can be a result of DistinctWordsComparator or other comparators. Every attribute has assigned weights according to the importance of the attribute. If the weight is not assigned explicitly then it is equal to 1 for the simple attributes or Maximum of the weights of sub-nested attributes for nested or reference attributes. If an attribute has multiple values, then the maximum value of relevance is selected.

In various embodiments, the following information describes participants of the formulae: RelevanceScoreAND—the relevance score of AND operand, the relevance score of the match rule; Nsimple—number of simple attributes (e.g., FirstName, LastName) participating in the AND operator directly; weighti—configured weight of i-th simple attribute; relevancei—calculated relevance of i-th simple attribute; Nnest-number of nested and reference attributes (e.g., Phone-no, Email-ID, Address) participating in the AND operator directly; weightj-configured weight of j-th nested or reference attribute; relevancej-calculated relevance of j-th nested/reference attribute; Nlogical—number of logical operands (For example, AND or OR) participating in the AND operator directly; relevancek—calculated relevance of k-th logical operand (the weight of a logical operand is fixed to 1; RelevanceScoreOR=max (relevance1, . . . , relevancei, . . . , relevanceN) relevancei—relevance of simple attribute, nested attribute, logical operand participating in the OR operand directly; RelevanceScoreNOT=1-RelevanceScoreAND, OR, exact, . . . (The relevance score of the NOT operand is equal to 1 minus the relevance score of the operand having this negation.)

In various embodiments, the following information describes participants of the formulae:

$${RelevanceScore}_{AND} = \frac{\begin{matrix}{\sum }_{\text{?}}^{\text{?}} {weight}_{\text{?}} \cdot {relevance}_{\text{?}} + \\ {\sum }_{\text{?}}^{\text{?}} {weight}_{\text{?}} \cdot {relevance}_{\text{?}} + {\sum }_{\text{?}}^{\text{?}} {relevance}_{\text{?}}\end{matrix}}{{\sum }_{\text{?}}^{\text{?}} {weight}_{\text{?}} + {\sum }_{\text{?}}^{\text{?}} {weight}_{\text{?}} + {N}_{\text{?}}}$$

$$\text{?} \text{indicates text missing or illegible when filed}$$

BasicStringComparator provides the relevance values and the score is calculated as follows: true for First Name; true for LastName; false for Suffix. The score is calculated as (1*1+1*1+0*1)/(1+1+1)=?=66. With a score of 0.66 the directive for this pair will be set to queue_for_review.

The example below shows the use of the verifyMatches API when using Relevance-based matching. Noteworthy items are relevance values appear for every attribute comparison and relevance for the entire rule; Match action name is shown if the relevance is within the corresponding threshold range, and null if it is not within any actionThreshold range; Matched field will be true if the relevance is within any action Threshold range.

In the match group configuration, the user may define Weights and actionThresholds. The weight property allows the client to assign a relative weight (strength) for each attribute. For example, the user may decide that Middle Name is less reliable and thus less important than First Name.

The action Threshold allows the client to define a range of scores to drive a directive. For example, the user might decide that the match group should merge the profile pair if the score is between 0.9 to 1.0, but should queue the pair for review if the score falls into a lower range of 0.6 to 0.9.

The user can configure a relevance-based match rule with multiple action thresholds having the same action type but with a different relevance score range.

In the above example, the type is potential_match for two different action thresholds. The user can differentiate such thresholds by assigning appropriate labels. The user can generate potential matches with different labels based on the range of the relevance score that allows the user to differentiate between higher and lower relevance score matches. The user can resolve matches quickly based on the label. In the example above, based on the relevance score, some potential matches can be considered for merging directly while others must be reviewed before any action is taken. The results of the API to get potential matches and the external match API will contain a relevance value and a matchActionLabel corresponding to each of the action type configured under the action Threshold parameter. For more information, see Potential Matches API and External Match API.

Using operators like equals and notEquals prevents tokenization from generating tokens. These operators should not have an impact on tokenization, if we want to compare and conclude that even though address and/or email and/or phone are different, the remaining attributes match enough to take the score above the threshold.

In some embodiments, the following options equal, notEquals and in constraints: 1) strict (Boolean value with default=true): Allows the constraint to be skipped before the match tokens and relevance score are computed; 2) weight (decimal with default=0.0): Allows the constraint to participate in the relevance score calculation. (The two options and their default values ensure backward compatibility.)

An example of a formula to calculate relevance score is:

$$R = \frac{{\sum }_{i}^{N} {R}_{i}^{operand} \cdot {w}_{i}^{operand} + {\sum }_{i}^{N} {R}_{i}^{constraint} \cdot {w}_{i}^{constraint}}{{\sum }_{i}^{N} {w}_{i}^{operand} + {\sum }_{i}^{N} {w}_{i}^{constraint}}$$

The formulae have the following variables: Roperand—the relevance score of an operand (for example: exact, exactOrNull, exactOrAllNull, fuzzy, etc.); Rconstraint—the relevance score calculated for a constraint (for example: equals, notEquals, in); Woperand—configured weight for an operand; Wconstraint—configured weight for a constraint.

In at least some organizations, profiles are maintained across systems and there are instances where multiple records of the same profile exist. There may be inconsistencies in each record. In such cases, it would be beneficial to merge these records and maintain one record with the complete information. There are also instances where two profiles are related to each other.

There are certain match pairs that the user can configure such that the system can automatically take action on those. Other match pairs that require manual review are resolved using the Potential Match screen. Match rules and Match IQ (discussed herein) may be utilized to determine if two records are a match, not a match, or a potential match.

Match rules and Match IQ may be used to determine if two records are a match, not a match, or a potential match. The user can also use the Match Score to decide if a profile is a potential match. Based on predefined match rules, each potential match is given a Match Score and the higher the score, higher is the probability of it to be a potential match for the profile. In some embodiments, the Match Score of a potential match will have a value of more than 0 only if the standalone and incremental scores are configured for the match rules.

There may be instances when certain profiles, in spite of being a potential match, are excluded from the profile view due to these match rules. In such cases, the user can manually search by entering the search criteria in the “Search” field and include these profiles as potential matches.

The user may have the option of viewing the Potential Matches perspective in the classic mode or the new mode.

In various embodiments, Match IQ uses machine learning (ML) to simplify and accelerate the data matching process. With Match IQ, business users can easily create a model for matching the records, by simply selecting the entity type and related attributes, without or minimum IT help. They can then train the ML model with the active learning process by reviewing pairs of records and indicating which are a match and which are not. As users confirm the matches, machine learning adjusts the matching model and presents additional record pairs to further refine the model.

After a sufficient number of representative record pairs have been matched or not matched, the user can download and review the match results. A downloaded file may show a sample set of match results and a relevance score for each record pair. The higher the relevance score, the more likely the records match. If needed, the user can retrain the model by answering more questions or even creating an alternate model to compare the matching results.

After the results are satisfactory, the data steward or other user with approval authority can review, approve and publish the model to use with internal and/or external data. The user also provides publishing settings based upon the relevance score range—for example, to define that match pairs with a relevance score of 8 to 1 should be matched and merged.

The end-to-end process, driven and performed by business users, typically takes only a day or two to complete and produces the quality matches customers require. In some embodiments, Match IQ uses machine learning technology to help ensure unified and reliable data across virtually unlimited data sources. The ML matching model, created with active learning using resolutions of suspected matched pairs, can be effectively applied to future match pairs. This provides a consistent way for business users and data stewards to match and merge data for increased quality, reliability, and business value.

Once a matching model is trained, no user interaction is required but the model can be retrained if needed. Because match and merge operations are performed using these models and calculated relevance scores, the process is rapid, consistent, and reliable. As the business grows or changes, the models can easily be adjusted to accommodate additional data sources. This enables matching and merging at the scale and speed of business.

The streamlined matching process, which does not require IT specialists or coding, enables customers to get up and running faster and with less effort. Typically, they can progress from initial subscription to completing their match-and-merge operations in a matter of days. Compare this to the weeks or months required by more traditional approaches. This same process is used to perform matching for new data sources as they are added, providing additional time savings and increased productivity.

No definition of matching requirements is needed; instead, users select matched pairs and machine learning creates the models. This greatly reduces the possibility of matching requirements not being correctly identified that might generate incorrect matches or miss valid matches. In addition, because machine learning creates and adjusts the matching model without configuration by IT specialists, coding errors are a thing of the past. This not only reduces errors in the match-and-merge process, but it also saves significant time as it creates a repeatable process. Customers have an option to use both Match IQ and traditional rule-based matching together if needed.

With all the time saved by using Match IQ, those involved—data owners, data stewards, IT and other business users—will find they have more time available for work that adds value to the business. They can use their time to focus on creating better user experiences, data improvement initiatives or streamlining other processes.

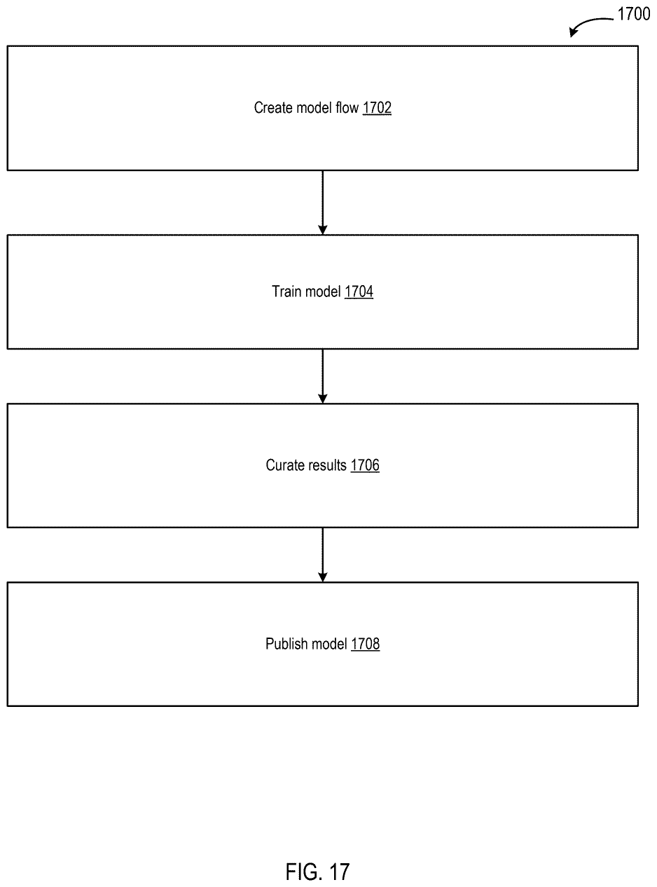

FIG. 17 depicts a high level flowchart 1700 for MatchIQ in some embodiments. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 1702, the first step is to create a model flow by selecting entity types and attributes. In various embodiments, a graphical user interface may enable a user to select attributes to train the model (e.g., with a check system).

In step 1704, the model is trained. When the user trains a model, the user identifies records as matches or non-matches (e.g., by answering a series of questions). After the completion of the Preparing Data stage, the model moves under the Training lane. At this stage, the model is ready for training. There can be variations where records are neither close to matches nor non-matches. Such records then become the input to the training process where the user may be prompted with questions seeking confirmation on whether a particular pair is a match or not.

A machine learning methodology may be utilized. For example, a neural network may be utilized for training. Alternately, as other examples, gradient boosted decision trees or random forests may be utilized.

In step 1706, results are curated. In various embodiments, the graphical user interface may display details related to the model and results may be displayed (e.g., downloaded). Matches may be run and reviewed by the user to curate the results for further training and model improvement.

In step 1708, the user may publish the model. The user may choose to publish the model for internal and external matching. In some embodiments, the user may select external or internal.

For example, if the user selects external, the model may be used to match data from an external file with the data in the tenant. If the user selects internal, the model may be used to match the data within your tenant along with the match rules configured for the tenant.

In various embodiments, the user may define a custom action and a corresponding relevance score range. This allows the user to execute custom actions for relevance scores that are received for relevance-based rules. If a match pair falls within the defined range, then the custom action is executed. In a specific implementation, the relevance score range the user specifies for one action cannot overlap with the relevance score of another custom action.

In various embodiments, survivorship and merging are separate concepts and processes. Again, think of an entity as a container of crosswalks and their associated attributes and values. A merged entity may be an aggregation of crosswalks from two or more entities. The additional crosswalks continue to bring their own attributes and values with them. If the acquiring (winning) entity already has the same attribute URI that the incoming entity is bringing, then the values from the attributes will accumulate within the attribute, yet the integrity of which crosswalk each value within the attribute came from is maintained for several purposes including the need to return the attribute and its values to the original entity it came from if an unmerge is requested. If the acquiring entity does not already have the same attribute URI that the incoming entity is bringing, then the new attribute URI becomes established within the entity.

In some embodiments, unlike other MDM systems, survivorship is a separate process that does not occur during the merge. It is a process that can execute in real-time when the entity is being retrieved during an API call. Survivorship may not depend on how the crosswalks and attributes came into the consolidated profile nor the order that they arrived. Survivorship processes each attribute according to the attribute's defined survivorship rule, and produces an Operational Value (OV) for the attribute on-the-fly. Depending on the type of survivorship rule selected, there could be one or more OVs for an attribute. For example, the user might choose the aggregation rule for the address attribute for the purpose of returning all addresses a person is related to. Conversely the user might choose the frequency rule for “first name” to return the one name that occurs most frequently in the “first name” attribute. Note also that the role of the username making the API call also factors into the survivorship rule used. This feature allows one survivorship rule for an attribute to be stored with one username role, while another survivorship rule for the same attribute is stored with another username role. A fetch of the entity by each username role might return different OVs.

When configuring the survivorship rules for the attributes of an entity type, the user can do this largely from the UI, but there are some advanced survivorship strategies that may be defined through metadata configuration.

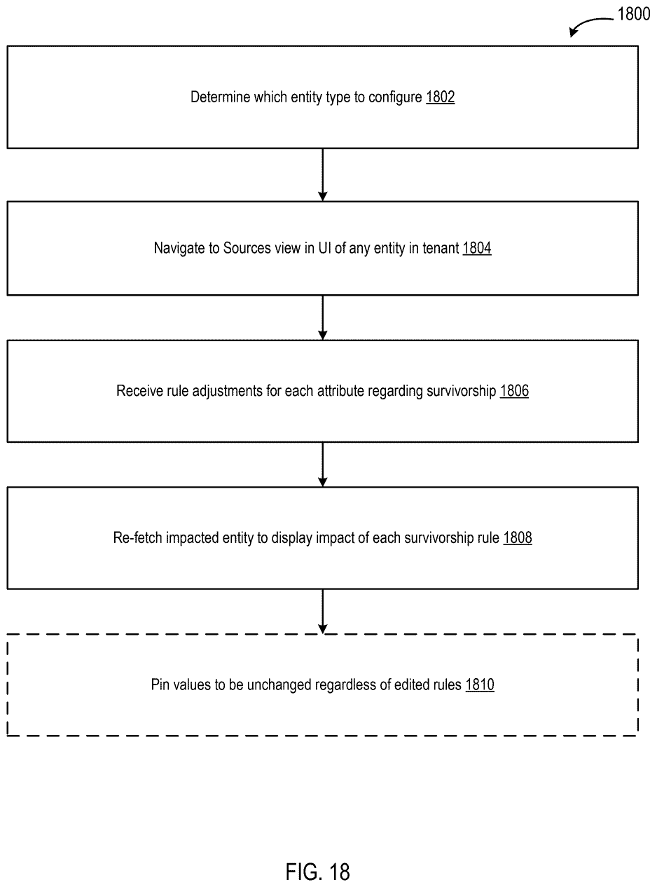

FIG. 18 depicts a flowchart 1800 for configuring survivorship within an example UI in some embodiments. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

When configuring survivorship via the UI, the user may not use the UI Modeler or Data Modeler. To configure attribute value survivorship via the UI, in step 1802, the user may determine which entity type to configure, then they may navigate to the Sources view of any actual entity in the tenant in step 1804. It may not matter which entity that is selected but it is recommended that the user pick one that has been sufficiently merged and thus has enough crosswalks (and thus raw values in its attributes) so that the user may witness material effects on-the-fly as they modify the survivorship rules.

In step 1806, in the Sources view while editing the survivorship for each attribute, the user can instantly see the effect on the screen in step 1808, which may guide the user. After you make a rule adjustment, the entity is fetched again using your new version of the rule and so you see the effect instantaneously.

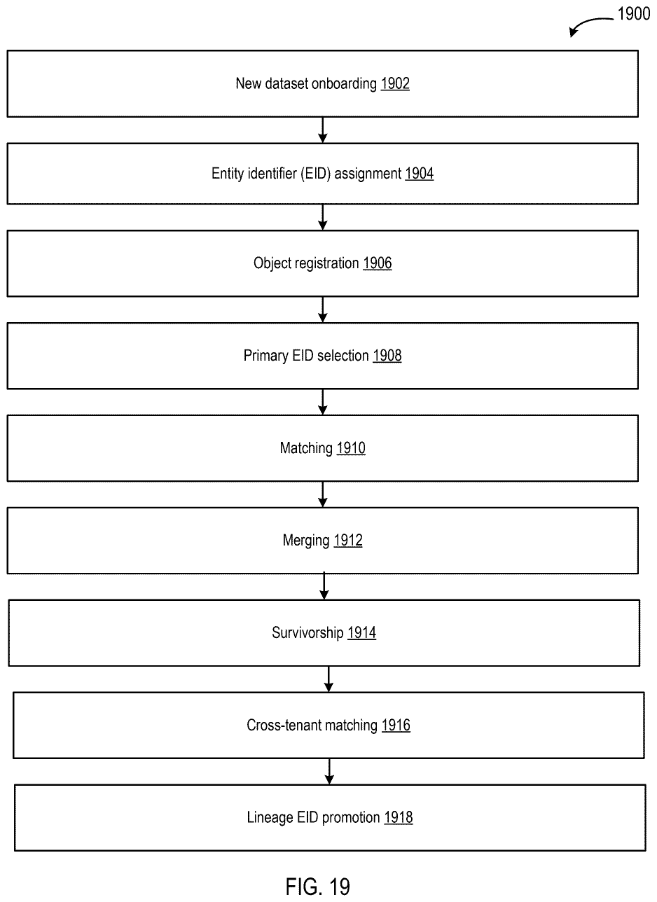

FIG. 19 depicts a flowchart 1900 of an example of a method of cross-tenant matching and lineage EID promotion. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

The flowchart 1900 starts at module 1902 with new dataset onboarding. New dataset onboarding is described above with reference to a dataset onboarding engine, which can carry out the process. Like the other engines described herein, the dataset onboarding engine may be a component of one or more regional platform instances.

The flowchart 1900 continues to module 1904 with EID assignment. EID assignment can be performed using an EID assignment engine. Like the other engines described herein, the EID assignment engine may be a component of one or more regional platform instances.

The flowchart 1900 continues to module 1906 with object registration. Object registration can be performed by an object registration engine. Like the other engines described herein, the object registration engine may be a component of one or more regional platform instances.

The flowchart 1900 continues to module 1908 with primary EID selection. Primary EID selection would occur naturally for a new object that has only one EID, but for objects that are merged, a primary EID is selected. A primary EID selection engine can carry out the process. Like the other engines described herein, the primary EID selection engine may be a component of one or more regional platform instances.

The flowchart 1900 continues to module 1910 with matching. Matching refers to the matching of objects in a datastore, such tenant datastores and/other datastores or systems. Because of a continuous process of integrating objects into the datastore(s), at some point an attempt at matching is likely to be made for every object that is onboarded, which may or may not result in a match. A matching engine can carry out the process. Like the other engines described herein, the matching engine may be a component of one or more regional platform instances.

The flowchart 1900 continues to module 1912 with merging. Merging refers to finding two objects that represent a common real world entity. A merging engine can carry out the process. Not all objects that are onboarded will necessarily be merged with other objects. Accordingly, the module 1912 could be skipped. Like the other engines described herein, the merging engine may be a component of one or more regional platform instances.

The flowchart 1900 continues to module 1914 with survivorship. Survivorship refers to, among other things, the technique of persisting EIDs. A survivorship engine can carry out the process. Not all objects that are onboarded will necessarily be merged, thereby triggering the survivorship, so the module 1914 could be skipped. Like the other engines described herein, the survivorship engine may be a component of one or more regional platform instances.

The flowchart 1900 continues to module 1916 with cross-tenant matching. Cross-tenant matching refers to the ability of a first tenant to use a first EID (or agent of the cross-tenant durable EID lineage-persistent RDBMS or other party that is given access) to match an object with a second EID at a second tenant. A cross-tenant matching engine, which can carry out the process, in part, by recognizing objects in two different tenants are associated with the same real world entity. It is not necessary for there to be actual cross-tenant matching for the flowchart 1900 to continue to module 1918. Like the other engines described herein, the cross-tenant matching engine may be a component of one or more regional platform instances.

The flowchart 1900 ends at module 1918 with lineage EID promotion. For example, a lineage EID promotion engine, which can carry out the process, in part, by persisting lineage EIDs and enables unmerging of objects in real time, without taking a datastore of the cross-tenant durable EID lineage-persistent RDBMS offline, at which point the flowchart 1900 can resume at one of several of the modules 1902-1918. Like the other engines described herein, the lineage EID promotion engine may be a component of one or more regional platform instances.

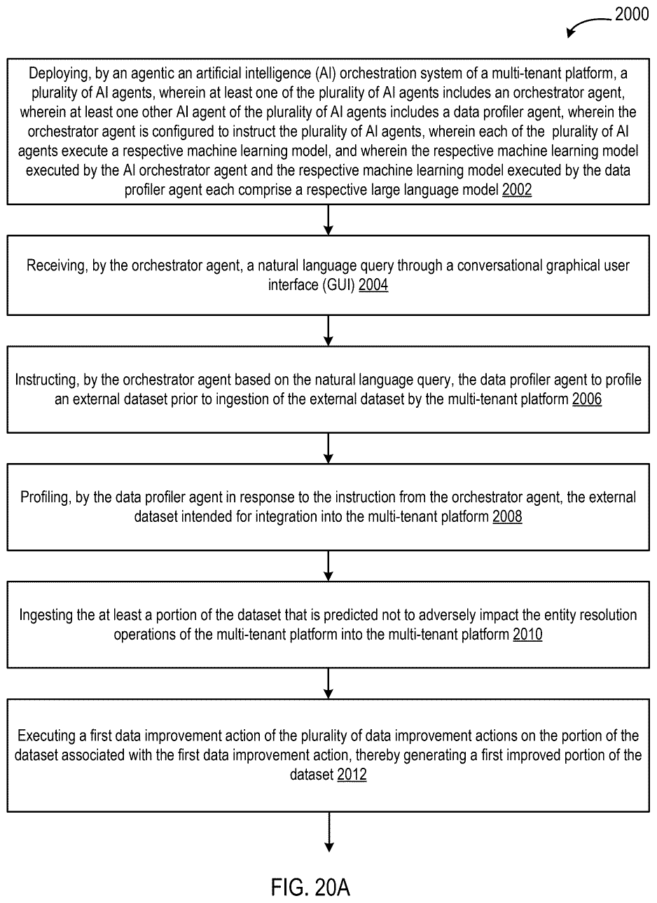

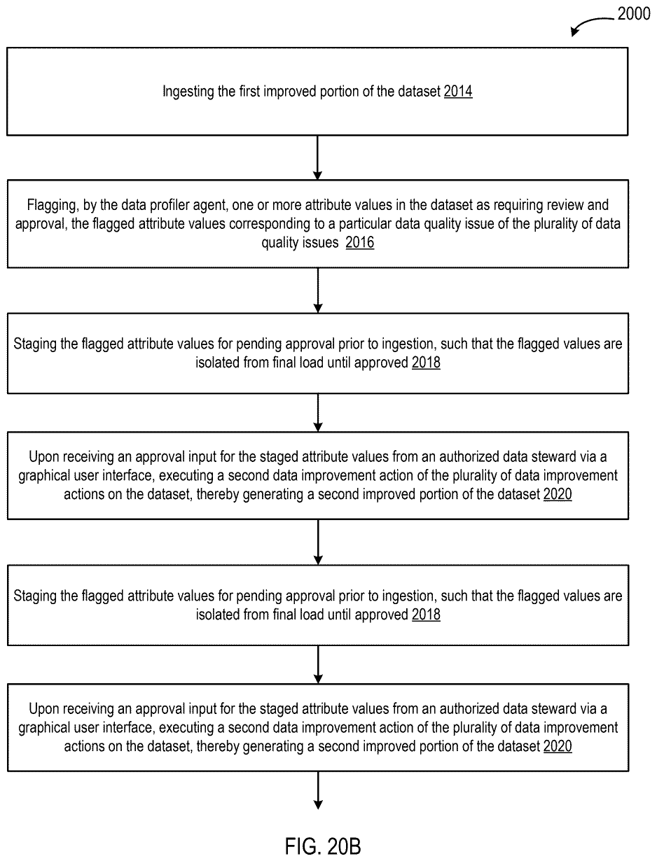

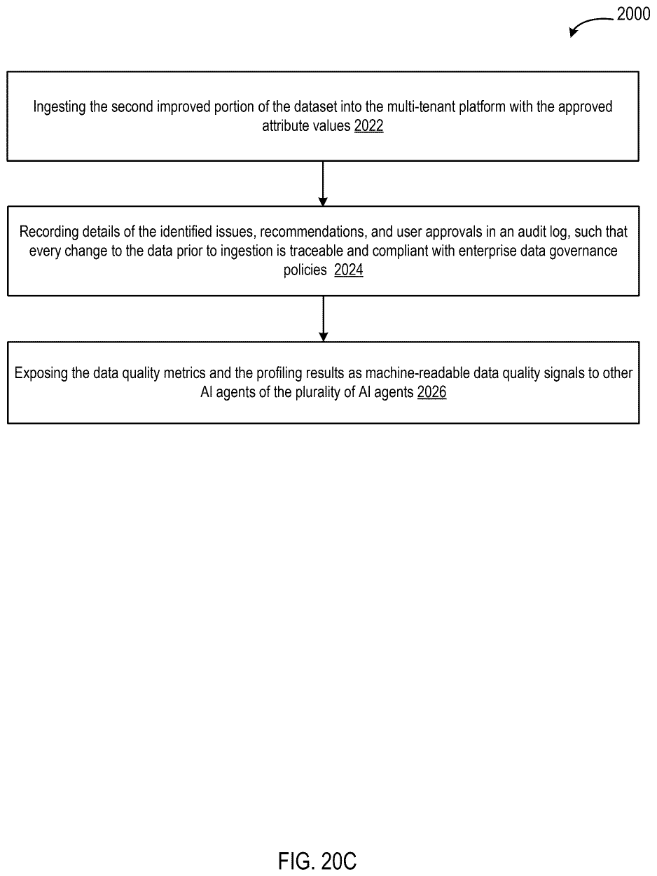

FIGS. 20A-20C depict a flowchart 2000 of an example method of agentic data profiling. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 2002, a multi-tenant platform (e.g., multi-tenant platform 102) deploys, by an agentic artificial intelligence (AI) orchestration system (e.g., agentic AI orchestration system 608) of the multi-tenant platform, a plurality of AI agents (e.g., AI agents 610-613 and 620-622). At least one of the plurality of AI agents includes an orchestrator agent (e.g., orchestrator agent 610), and at least one other AI agent of the plurality of AI agents includes a data profiler agent (e.g., data profiler agent 620). The orchestrator agent can be configured to instruct the plurality of AI agents, and each of the plurality of AI agents can execute a respective machine learning model. The respective machine learning model executed by the AI orchestrator agent and the respective machine learning model executed by the data profiler agent can each comprise a respective large language model (LLM). In some embodiments, an AI agent engine (e.g., AI agent engine 706) and/or machine learning model deployment engine (e.g., machine learning model deployment engine 712) deploys the AI agents.

In module 2004, the orchestrator agent receives a natural language query through a conversational graphical user interface (GUI). The conversational GUI could include a chat-bot interface. In some embodiments, an interface engine (e.g., interface engine 720) cooperates with the orchestrator agent to receive the natural language input.

In module 2006, the orchestrator agent instructs, based on the natural language query, the data profiler agent to profile an external dataset prior to ingestion of the external dataset by the multi-tenant platform.

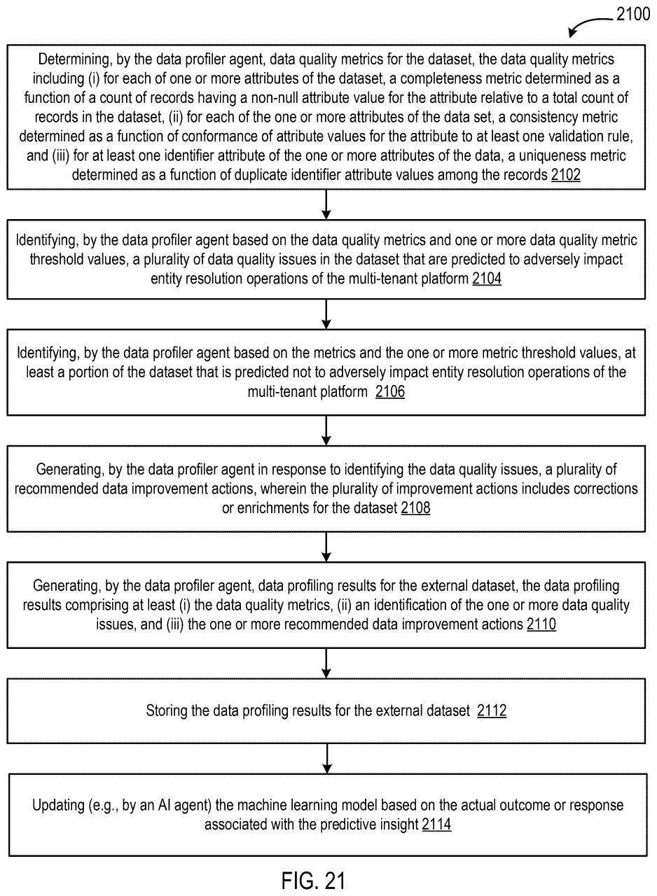

In module 2008, the data profile agent profiles, in response to the instruction from the orchestrator agent, the external dataset intended for integration into the multi-tenant platform. An example method of profiling is shown in FIG. 21, which includes modules that may be repeated (e.g., iteratively and/or in parallel) any number of times.

In module 2010, the multi-tenant platform (e.g., at the instruction of the data profiler agent and/or orchestration agent) ingests the at least a portion of the dataset that is predicted not to adversely impact the entity resolution operations of the multi-tenant platform into the multi-tenant platform. In some embodiments, the multi-tenant platform performs the ingestion via a secure communication layer (e.g., secure communication layer 614) managed by a secure communication engine (e.g., secure communication engine 716).

In module 2012, the data profiler agent executes (e.g., in response to generating one or more recommended data improvement actions) a first data improvement action of the plurality of data improvement actions on the portion of the dataset associated with the first data improvement action, thereby generating a first improved portion of the dataset. In some embodiments, the data profiler agent cooperates with a predictive intelligence engine (e.g., predictive intelligence engine 708) to execute the first data improvement action.

In some embodiments, data improvement actions are concrete actions (e.g., performed automatically and/or recommended for human approval) that increase match readiness, reduce load failures, improve schema alignment, and/or improve data quality of an incoming dataset before it is ingested. Data improvement actions can include, for example, (i) correcting, normalizing, or standardizing attribute values; (ii) proposing or applying a schema mapping adjustment; (iii) generating or applying validation logic; (iv) staging and applying user-approved modifications; (v) enriching missing values; (vi) routing identified issues to responsible users; and/or (vii) triggering or gating a data-load workflow based on quality signals.

In module 2014, the multi-tenant platform (e.g., at the instruction of the data profiler agent and/or orchestration agent) ingests the first improved portion of the dataset. In some embodiments, the multi-tenant platform performs the ingestion via the secure communication layer managed by the secure communication engine.

In module 2016, the data profiler agent flags one or more attribute values in the dataset as requiring review and approval. The flagged attribute values can correspond to a particular data quality issue of the plurality of data quality issues (e.g., including values causing match-impact issues).

In module 2018, the data profiler agent stages the flagged attribute values for pending approval prior to ingestion, such that the flagged values are isolated from final load/ingestion until approved.

In module 2020, the data profiler agent, upon receiving an approval input for the staged attribute values from an authorized data steward via a graphical user interface, executes a second data improvement action of the plurality of data improvement actions on the dataset, thereby generating a second improved portion of the dataset.

In module 2022, the multi-tenant platform (e.g., at the instruction of the data profiler agent and/or orchestration agent) ingests the second improved portion of the dataset into the multi-tenant platform with the approved attribute values, thereby loading clean, high-quality data (e.g., over 90% quality threshold) into the multi-tenant platform without requiring post-load reloads or rework.

In module 2024, the agentic AI orchestration system (e.g., by the data profiler agent and/or logging and audit engine 718) records details of the identified issues, recommendations, and user approvals in an audit log, such that every change to the data prior to ingestion is traceable and compliant with enterprise data governance policies.

In module 2026, the data profiler agent exposes the data quality metrics and the profiling results as machine-readable data quality signals to other AI agents of the plurality of AI agents. In some embodiments, these signals (e.g., data completeness scores, anomaly flags, and/or the like) can be consumed by downstream analytics or AI models (e.g., other AI agents 610-615) to inform their processing. For example, another AI agent (e.g., a match resolve agent 622, and/or another data profiler agent 620) can factor in data quality confidence, and/or decide to trigger additional cleansing steps, thereby leveraging the insights of the data profiler agent to improve overall AI and operational outcomes.

In some embodiments, determining the data quality metrics comprises determining a completeness score for each attribute (e.g., based on the presence of non-null values), evaluating consistency against expected formats or reference data to detect out-of-range or incorrectly formatted values, and calculating uniqueness by identifying duplicate entries or values across the dataset.

In some embodiments, identifying data quality issues that are predicted to adversely impact entity resolution operations comprises detecting that certain records have missing or inconsistent identifying information (and/or other “match-impact” issues) that would prevent accurate entity resolution, and marking those records or fields for corrective action before they are used in any match or merge operation.

In some embodiments, determining the plurality of data quality issues further includes cross-referencing attribute values against existing master records and reference datasets in an intelligent data graph of an agentic AI orchestration system of the multi-tenant platform to detect context-specific anomalies, wherein the context-specific anomalies include potential duplicate records, conflicts with reference data standards, and outlier values, thereby using enterprise context to enrich the data profiling results.

In some embodiments, generating recommended data improvement actions includes proposing standardized or corrected values for flagged attributes (e.g., recommending valid formats for incorrectly formatted entries), supplying missing values by referencing other data sources, and recommending merges for duplicates (and/or associating these recommendations with the flagged attributes for the authorized data steward's review).

In some embodiments, staging the flagged attribute values for approval comprises presenting those values and the data profiler agent's data improvement actions in the graphical user interface to the authorized data steward, and enabling the authorized data steward to review, edit, and approve the data improvement actions before the dataset is ingested.

In some embodiments, the data profiler agent operates as a pre-ingestion stage in a data integration pipeline of the multi-tenant platform, wherein the data integration pipeline includes intercepting incoming data batches or streams and performing the data quality determinations and staging before committing the data to the multi-tenant platform. This pre-ingest profiling stage can block or delay final ingestion until any critical data quality issues are resolved, thereby ensuring that only vetted, high-quality data is written into the multi-tenant platform.

In some embodiments, the data improvement actions recommended by the data profiler agent are logged and auditable by the agentic AI orchestration system, and the method further comprises recording details of the identified issues, recommendations, and user approvals in an audit log, such that every change to the data prior to ingestion is traceable and compliant with enterprise data governance policies.

In some embodiments, the data profiler agent inherits role-based access permissions of the multi-tenant platform and agentic AI orchestration system, thereby operating under the same role-based access permissions as human users, and wherein the data profiler agent is restricted to read or modify only portions of the dataset permitted by a corresponding role, and the data improvement actions generated by the data profiler agent are subject to the role-based access permissions of the multi-tenant platform and the agentic AI orchestration system, thereby maintaining compliance and data privacy while the data profiler agent performs autonomous data quality tasks.

FIG. 21 depicts a flowchart 2100 of an example of data profiling (or, simply, “profiling”) by a data profiler agent. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 2102, a data profiler agent (e.g., data profiler agent 620) determines data quality metrics for a dataset (e.g., dataset that is external to multi-tenant platform 102). The data quality metrics can include (i) for each of one or more attributes of the dataset, a completeness metric determined as a function of a count of records having a non-null attribute value for the attribute relative to a total count of records in the dataset, (ii) for each of the one or more attributes of the data set, a consistency metric determined as a function of conformance of attribute values for the attribute to at least one validation rule, and/or (iii) for at least one identifier attribute of the one or more attributes of the data, a uniqueness metric determined as a function of duplicate identifier attribute values among the records.

In module 2104, the data profiler agent identifies, based on the data quality metrics and one or more data quality metric threshold values, a plurality of data quality issues in the dataset that are predicted to adversely impact entity resolution operations of the multi-tenant platform. For example, the data profiler agent can compare the data quality metrics with a threshold value, and if it does not satisfy the threshold value (e.g., is below the threshold value), the data profiler agent can identify the data quality issues. In some embodiments, the data quality metrics and the threshold values are fed (e.g., as an input vector) to the respective large language model of the data profiler agent, which outputs an indication of the predicted data quality issues.

In module 2106, the data profiler agent identifies, based on the metrics and the one or more metric threshold values, at least a portion of the dataset that is predicted not to adversely impact entity resolution operations of the multi-tenant platform. For example, the data profiler agent can compare the data quality metrics with a threshold value, and if it satisfies the threshold value (e.g., exceeds or meets the threshold value), the data profiler agent can predict that there are not any data quality issues. In some embodiments, the data quality metrics and the threshold values are fed (e.g., as an input vector) to the respective large language model of the data profiler agent, which outputs an indication of the predicted data quality issues.

In module 2108, the data profiler agent generates, in response to identifying the data quality issues, a plurality of recommended data improvement actions, wherein the plurality of improvement actions includes corrections or enrichments for the dataset.

In module 2110, the data profiler agent generates data profiling results for the external dataset. The data profiling results can include at least (i) the data quality metrics, (ii) an identification of the one or more data quality issues, and/or (iii) the one or more recommended data improvement actions.

In module 2112, the data profiler agent stores the data profiling results for the external dataset (e.g., in datastore 730).

In some embodiments, the profiling can include executing, by the data profiler agent, a large language model (LLM) in accordance with at least one system prompt that constrains the LLM to generate one or more tool invocation requests for one or more governed tools (e.g., of the secure communication layer 614 and/or MCP server); providing, as input to the LLM, (i) at least a portion of the incoming dataset or a statistical sample thereof and (ii) a representation of a tenant schema of the master data management platform; receiving, as output from the LLM, one or more tool invocation requests that identify at least one governed tool and one or more parameters; and executing the one or more tool invocation requests to compute at least a portion of the data quality metrics included in the data profiling results.

As used herein, a “tool invocation request” refers to a machine-readable request, message, and/or call data structure that (i) identifies a particular tool to be executed and (ii) provides one or more input arguments for execution of that tool. In some embodiments, a tool invocation request further includes execution context information such as a tenant identifier, a session identifier, a correlation identifier, an identity or role context, and/or an authorization credential (e.g., an access token) used to authorize the requested tool execution. In some embodiments, the tool invocation request is generated by an AI agent at runtime based on an output from a large language model (LLM); however, the tool invocation request is a structured request that causes execution of a specified tool and is not merely free-form natural language text.

In some embodiments, a tool invocation request conforms to a tool-invocation protocol in which tools are discoverable and executable functions exposed by a server, and wherein a tool invocation request specifies at least (a) a tool identifier (e.g., name) and (b) a parameter object formatted in accordance with a defined input schema for the tool.

As used herein, “governed tools” (or, simply, “tools”) refer to a curated set of executable capabilities exposed to an AI agent 610-615 through a tool gateway (e.g., provided by an MCP server, the secure communication layer 614, agentic AI orchestration system 608, and/or multi-tenant platform 102), where each governed tool encapsulates one or more underlying data operations (e.g., reading, searching, comparing, validating, updating, merging, or otherwise acting on data) and is subject to one or more governance controls.

In some embodiments, governance controls for a governed tool include one or more of: role-based access control, attribute-level masking, access-policy enforcement, input validation, rate limiting, allowlisting of tools permitted for a given agent, audit logging of tool calls (including user attribution), and/or a requirement for human approval prior to performing an irreversible or high-risk action. In some embodiments, an AI agent is prevented from directly accessing underlying datastores and instead performs actions only by invoking governed tools through the tool gateway.

As used herein, “executing” a tool invocation request comprises receiving the tool invocation request at a tool gateway (e.g., MCP server), validating authorization for execution of the identified tool in accordance with applicable governance controls, and performing the requested tool operation by dispatching the request to an underlying service, application programming interface (API), or other executable logic that carries out the operation and returns a result.

In some embodiments, the tool gateway executes the tool invocation request by invoking a corresponding multi-tenant platform 102 API on behalf of an authenticated client or user context, and returning a tool response to the requesting AI agent at runtime. The underlying multi-tenant platform 102 API can perform the data access and/or data modification operation, while the tool gateway enforces governance controls, mediates access to data, and provides auditable execution.

In some embodiments, a tool invocation request includes one or more of: (a) a tool identifier (e.g., name, uniform resource identifier, or other handle), (b) a parameter set and/or argument values, (c) a request identifier (e.g., correlation identifier, idempotency key, or nonce), (d) context information associating the request with a user session, conversation, dataset, or job identifier, (e) authorization and/or policy context (e.g., security token, role, access scope, or masking policy indicator), (f) an execution mode indicator (e.g., synchronous/asynchronous, read-only/read-write), and/or (g) an output specification indicating a desired output schema, output fields, sampling constraints, and/or redaction constraints.

In some embodiments, a tool invocation request is distinct from (i) the tool itself (e.g., the executable capability) and (ii) the tool response (e.g., the returned output data), and can be used to programmatically request execution of the tool (e.g., by an AI agent) with specified inputs.

In some embodiments, some or all of the AI agents 610-615 use governed APIs (“tools”) to perform actions, receive and/or respond to tool invocation requests, and/or the like. Accordingly, tool requests can cause the AI agents 610-615 to execute tool actions. In some embodiments, every tool action can be routed through the secure communication layer 614 (e.g., MCP server) so it can enforce RBAC/masking/audit and prevent raw datastore access.

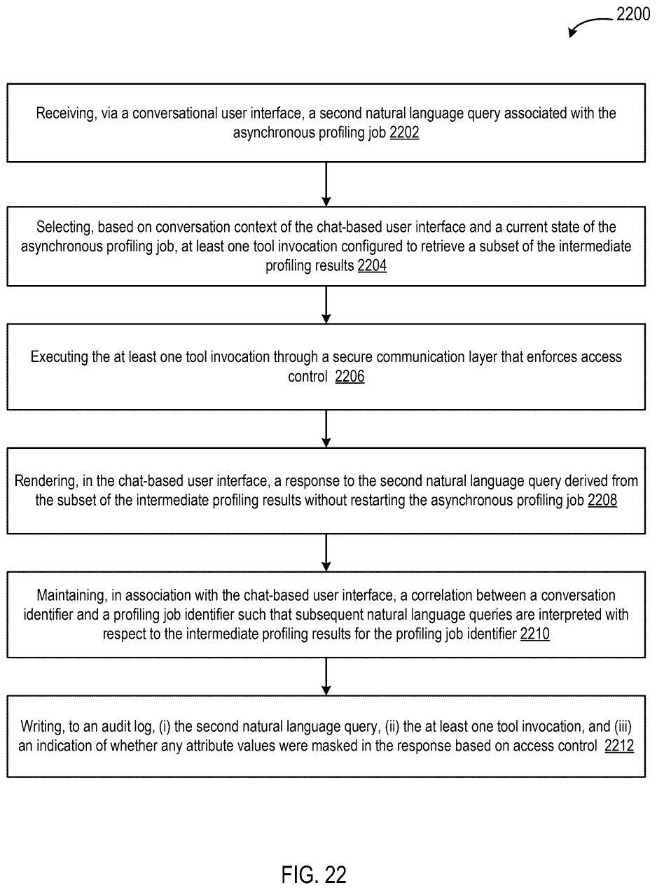

FIG. 22 depicts a flowchart 2200 of an example method of interactive agentic data profiling. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In some embodiments, profiling the dataset comprises initiating an asynchronous profiling job that iteratively computes profiling results over at least a portion of the dataset and stores intermediate profiling results in a profiling state repository (e.g., datastore 730).

In module 2202, a computing system (e.g., agentic AI orchestration system 608) initiates an asynchronous profiling job that iteratively computes profiling results over at least a portion of the dataset and stores intermediate profiling results in a profiling state repository. In some embodiments, an orchestrator agent (e.g., orchestrator agent 610) of the agentic AI orchestration system of a multi-tenant platform (e.g., multi-tenant platform 102) initiates the asynchronous profiling job and a data profiler agent (e.g., data profiler agent 620) computes the profiling results.

In module 2204, the computing system receives, via a conversational user interface, a second natural language query associated with the asynchronous profiling job.

In module 2206, the computing system selects, based on conversation context of the conversational graphical user interface and a current state of the asynchronous profiling job, at least one tool invocation configured to retrieve a subset of the intermediate profiling results.

In module 2208, the computing system executes the at least one tool invocation through a secure communication layer that enforces access control.

In module 2210, the computing system renders, in the conversational graphical user interface, a response to the second natural language query derived from the subset of the intermediate profiling results without restarting the asynchronous profiling job

Modules 2204-2210 may be performed while the asynchronous profiling job is executing.

In module 2212, the computing system maintains, in association with the chat-based user interface, a correlation between a conversation identifier and a profiling job identifier such that subsequent natural language queries are interpreted with respect to the intermediate profiling results for the profiling job identifier.

In module 2214, the computing system writes, to an audit log, (i) the second natural language query, (ii) the at least one tool invocation, and (iii) an indication of whether any attribute values were masked in the response based on access control. In some embodiments, a logging and audit engine (e.g., logging and audit engine 718) and/or the data profiler agent performs the write operations.

In some embodiments, the secure communication layer comprises a model context protocol (MCP) server that filters, transforms, or routes data returned from the at least one tool invocation based on a user role, a purpose, and/or a policy.

In some embodiments, the second natural language query requests identification of corrupted values for a particular field, and wherein the response comprises (i) at least one representative corrupted value or pattern and (ii) a recommended correction strategy for the corrupted value or pattern.

In some embodiments, the second natural language query requests information about an automatic mapping between a source column and a tenant schema attribute, and wherein the response comprises a mapping confidence score and an explanation based on at least one statistical property computed for the source column.

1. A system comprising:
one or more processors; and
memory storing instructions that, when executed by the one or more processors, cause the system to perform:
deploying, by agentic an artificial intelligence (AI) orchestration system of a multi-tenant platform, a plurality of AI agents, wherein at least one of the plurality of AI agents includes an orchestrator agent, wherein at least one other AI agent of the plurality of AI agents includes a data profiler agent, wherein the orchestrator agent is configured to instruct the plurality of AI agents, wherein each of the plurality of AI agents execute a respective machine learning model, and wherein the respective machine learning model executed by the AI orchestrator agent and the respective machine learning model executed by the data profiler agent each comprise a respective large language model (LLM);
receiving, by the orchestrator agent, a natural language query through a conversational graphical user interface (GUI);
instructing, by the orchestrator agent based on the natural language query, the data profiler agent to profile an external dataset prior to ingestion of the external dataset by the multi-tenant platform;
profiling, by the data profiler agent in response to the instruction from the orchestrator agent, the external dataset intended for integration into the multi-tenant platform, the profiling the external dataset comprising:
determining, by the data profiler agent, data quality metrics for the dataset, the data quality metrics including:
(i) for each of one or more attributes of the dataset, a completeness metric determined as a function of a count of records having a non-null attribute value for the attribute relative to a total count of records in the dataset,
(ii) for each of the one or more attributes of the data set, a consistency metric determined as a function of conformance of attribute values for the attribute to at least one validation rule, and
(iii) for at least one identifier attribute of the one or more attributes of the data, a uniqueness metric determined as a function of duplicate identifier attribute values among the records;
identifying, by the data profiler agent based on the data quality metrics and one or more data quality metric threshold values, a plurality of data quality issues in the dataset that are predicted to adversely impact entity resolution operations of the multi-tenant platform;
identifying, by the data profiler agent based on the metrics and the one or more metric threshold values, at least a portion of the dataset that is predicted not to adversely impact entity resolution operations of the multi-tenant platform;
generating, by the data profiler agent in response to identifying the data quality issues, a plurality of recommended data improvement actions, wherein the plurality of improvement actions includes corrections or enrichments for the dataset;
generating, by the data profiler agent, data profiling results for the external dataset, the data profiling results comprising at least (i) the data quality metrics, (ii) an identification of the one or more data quality issues, and (iii) the one or more recommended data improvement actions; and
storing the data profiling results for the external dataset;
ingesting the at least a portion of the dataset that is predicted not to adversely impact the entity resolution operations of the multi-tenant platform into the multi-tenant platform;
executing a first data improvement action of the plurality of data improvement actions on the portion of the dataset associated with the first data improvement action, thereby generating a first improved portion of the dataset; and
ingesting the first improved portion of the dataset.

2. The system of claim 1, wherein the instructions, when executed by the one or more processors, cause the system to perform:
flagging, by the data profiler agent, one or more attribute values in the dataset as requiring review and approval, the flagged attribute values corresponding to a particular data quality issue of the plurality of data quality issues;
staging the flagged attribute values for pending approval prior to ingestion, such that the flagged values are isolated from final load until approved;
upon receiving an approval input for the staged attribute values from an authorized data steward via a graphical user interface, executing a second data improvement action of the plurality of data improvement actions on the dataset, thereby generating a second improved portion of the dataset; and
ingesting the second improved portion of the dataset into the multi-tenant platform with the approved attribute values.

3. The system of claim 1, wherein determining the data quality metrics comprises determining a completeness score for each attribute, evaluating consistency against expected formats or reference data to detect out-of-range or incorrectly formatted values, and calculating uniqueness by identifying duplicate entries or values across the dataset.

4. The system of claim 1, wherein identifying data quality issues that are predicted to adversely impact entity resolution operations comprises detecting that certain records have missing or inconsistent identifying information that would prevent accurate entity resolution, and marking those records or fields for corrective action before they are used in any match or merge operation.

5. The system of claim 1, wherein determining the plurality of data quality issues further includes cross-referencing attribute values against existing master records and reference datasets in an intelligent data graph of an agentic AI orchestration system of the multi-tenant platform to detect context-specific anomalies, wherein the context-specific anomalies include potential duplicate records, conflicts with reference data standards, and outlier values, thereby using enterprise context to enrich the data profiling results.

6. The system of claim 1, wherein generating recommended data improvement actions includes proposing standardized or corrected values for flagged attributes, supplying missing values by referencing other data sources, and recommending merges for duplicates.

7. The system of claim 1, wherein staging the flagged attribute values for approval comprises presenting those values and the data profiler agent's data improvement actions in the graphical user interface to the authorized data steward, and enabling the authorized data steward to review, edit, and approve the data improvement actions before the dataset is ingested.

8. The system of claim 1, wherein the data profiler agent operates as a pre-ingestion stage in a data integration pipeline of the multi-tenant platform, wherein the data integration pipeline includes intercepting incoming data batches or streams and performing the data quality determinations and staging before committing the data to the multi-tenant platform.

9. The system of claim 1, wherein the data improvement actions recommended by the data profiler agent are logged and auditable by the agentic AI orchestration system, and the method further comprises recording details of the identified issues, recommendations, and user approvals in an audit log, such that every change to the data prior to ingestion is traceable and compliant with enterprise data governance policies.

10. The system of claim 1, wherein the data profiler agent inherits role-based access permissions of the multi-tenant platform and agentic AI orchestration system, thereby operating under the same role-based access permissions as human users, and wherein the data profiler agent is restricted to read or modify only portions of the dataset permitted by a corresponding role, and the data improvement actions generated by the data profiler agent are subject to the role-based access permissions of the multi-tenant platform and the agentic AI orchestration system, thereby maintaining compliance and data privacy while the data profiler agent performs autonomous data quality tasks.

11. The system of claim 1, further comprising exposing the data quality metrics and the profiling results as machine-readable data quality signals to other AI agents of the plurality of AI agents.

12. The system 1, wherein profiling the dataset comprises initiating an asynchronous profiling job that iteratively computes profiling results over at least a portion of the dataset and stores intermediate profiling results in a profiling state repository.

13. The system of claim 12, further comprising, while the asynchronous profiling job is executing:
receiving, via the conversational user interface, a second natural language query associated with the asynchronous profiling job;
selecting, based on conversation context of the conversational graphical user interface and a current state of the asynchronous profiling job, at least one tool invocation configured to retrieve a subset of the intermediate profiling results;
executing the at least one tool invocation through a secure communication layer that enforces access control; and
rendering, in the conversational graphical user interface, a response to the second natural language query derived from the subset of the intermediate profiling results without restarting the asynchronous profiling job.

14. The system of claim 13, wherein secure communication layer comprises a model context protocol (MCP) server that filters, transforms, or routes data returned from the at least one tool invocation based on at least one of: a user role, a purpose, or a policy.

15. The system of claim 13, wherein the second natural language query requests identification of corrupted values for a particular field, and wherein the response comprises (i) at least one representative corrupted value or pattern and (ii) a recommended correction strategy for the corrupted value or pattern.

16. The system of claim 13, wherein the second natural language query requests information about an automatic mapping between a source column and a tenant schema attribute, and wherein the response comprises a mapping confidence score and an explanation based on at least one statistical property computed for the source column.

17. The system of claim 13, further comprising maintaining, in association with the conversational graphical user interface, a correlation between a conversation identifier and a profiling job identifier such that subsequent natural language queries are interpreted with respect to the intermediate profiling results for the profiling job identifier.

18. The system of claim 13, further comprising writing, to an audit log, (i) the second natural language query, (ii) the at least one tool invocation, and (iii) an indication of whether any attribute values were masked in the response based on access control.

19. A method comprising:
deploying, by agentic an artificial intelligence (AI) orchestration system of a multi-tenant platform, a plurality of AI agents, wherein at least one of the plurality of AI agents includes an orchestrator agent, wherein at least one other AI agent of the plurality of AI agents includes a data profiler agent, wherein the orchestrator agent is configured to instruct the plurality of AI agents, wherein each of the plurality of AI agents execute a respective machine learning model, and wherein the respective machine learning model executed by the AI orchestrator agent and the respective machine learning model executed by the data profiler agent each comprise a respective large language model (LLM);
receiving, by the orchestrator agent, a natural language query through a conversational graphical user interface (GUI);
instructing, by the orchestrator agent based on the natural language query, the data profiler agent to profile an external dataset prior to ingestion of the external dataset by the multi-tenant platform;
profiling, by the data profiler agent in response to the instruction from the orchestrator agent, the external dataset intended for integration into the multi-tenant platform, the profiling the external dataset comprising:
determining, by the data profiler agent, data quality metrics for the dataset, the data quality metrics including:
(i) for each of one or more attributes of the dataset, a completeness metric determined as a function of a count of records having a non-null attribute value for the attribute relative to a total count of records in the dataset,
(ii) for each of the one or more attributes of the data set, a consistency metric determined as a function of conformance of attribute values for the attribute to at least one validation rule, and
(iii) for at least one identifier attribute of the one or more attributes of the data, a uniqueness metric determined as a function of duplicate identifier attribute values among the records;
identifying, by the data profiler agent based on the data quality metrics and one or more data quality metric threshold values, a plurality of data quality issues in the dataset that are predicted to adversely impact entity resolution operations of the multi-tenant platform;
identifying, by the data profiler agent based on the metrics and the one or more metric threshold values, at least a portion of the dataset that is predicted not to adversely impact entity resolution operations of the multi-tenant platform;
generating, by the data profiler agent in response to identifying the data quality issues, a plurality of recommended data improvement actions, wherein the plurality of improvement actions includes corrections or enrichments for the dataset;
generating, by the data profiler agent, data profiling results for the external dataset, the data profiling results comprising at least (i) the data quality metrics, (ii) an identification of the one or more data quality issues, and (iii) the one or more recommended data improvement actions; and
storing the data profiling results for the external dataset;
ingesting the at least a portion of the dataset that is predicted not to adversely impact the entity resolution operations of the multi-tenant platform into the multi-tenant platform;
executing a first data improvement action of the plurality of data improvement actions on the portion of the dataset associated with the first data improvement action, thereby generating a first improved portion of the dataset; and
ingesting the first improved portion of the dataset.

20. The method of claim 19, further comprising:
flagging, by the data profiler agent, one or more attribute values in the dataset as requiring review and approval, the flagged attribute values corresponding to a particular data quality issue of the plurality of data quality issues;
staging the flagged attribute values for pending approval prior to ingestion, such that the flagged values are isolated from final load until approved;
upon receiving an approval input for the staged attribute values from an authorized data steward via a graphical user interface, executing a second data improvement action of the plurality of data improvement actions on the dataset, thereby generating a second improved portion of the dataset; and
ingesting the second improved portion of the dataset into the multi-tenant platform with the approved attribute values.
